(19) United States
(12) Patent Application Publication
(10) Pub. No.: US 2006/0130081 A1
(43) Pub. Date: Jun. 15, 2006

(54) Disc loading device

(75) Inventors: Hajime Mizuno, Chiba (JP); Tsuyoshi Minote, Saitama (JP); Renji Tamura, Kanagawa (JP); Shinji Ito, Tokyo (JP); Hideo Okuyama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/513,697

(22) PCT Filed: May 20, 2003
(86) PCT No.: PCT/JP03/06281

§ 371 Date: Oct. 13, 2005

(30) Foreign Application Priority Data
May 20, 2002 (JP) 2002-144117
May 20, 2002 (JP) 2002-144458
Jan. 29, 2003 (JP) 2003-20343

(51) Int. Cl. G11B 17/04

(52) U.S. Cl. 720/621

(57) ABSTRACT

A device has excellent usability and makes it possible to, for example, prevent damage to a disc-shaped recording medium and reliably transport the disc-shaped recording medium. The device includes first transporting means (6) and second transporting means (7) disposed on opposite sides of a disc-shaped recording medium (200) that is being transported for transporting the disc-shaped recording medium by being pushed against the outer peripheral surface of the disc-shaped recording medium from the opposite sides. The first transporting means includes a plurality of feed rollers (9) which are disposed apart from each other along a transportation path of the disc-shaped recording medium and which transport the disc-shaped recording medium while transferring it by independently and successively rolling on the outer peripheral surface of the disc-shaped recording medium.

### TECHNICAL FIELD

The present invention relates to a disc loading device. More particularly, the present invention relates to the technical field of a disc loading device for transporting and loading a disc-shaped recording medium inserted from a disc insertion slot.

### BACKGROUND ART

A disc loading device for transporting and loading a disc-shaped recording medium, such as an optical disc, inserted from a disc insertion slot is provided. In such a disc loading device, an information signal is recorded onto or reproduced from the loaded disc-shaped recording medium.

Examples of methods for loading a disc-shaped recording medium by a disc loading device are what are called a tray method and a slot-in method. In the tray method, the disc-shaped recording medium is disposed on a disc tray and loaded. In the slot-in method, the disc-shaped recording medium is directly inserted from a disc insertion slot and loaded without using the disc tray.

A disc loading device using the tray method loads a disc-shaped recording medium by disposing the disc-shaped recording medium on a disc tray drawn out from a housing and by drawing the disc tray into the housing.

A disc loading device using the slot-in method loads a disc-shaped recording medium by nipping the disc-shaped recording medium from the thickness direction thereof by, for example, a pair of rollers that are separated from each other in the thickness direction of the disc-shaped recording medium, rotating the pair of rollers, and drawing the disc-shaped recording medium into the housing. An example of a method for loading by a disc loading device is what is called the slot-in method for loading a disc-shaped recording medium by directly inserting the disc-shaped recording medium from a disc insertion slot. In one type of such a disc loading device using the slot-in method, in a transportation mode, a disc-shaped recording medium inserted from a disc insertion slot is nipped by, for example, a pair of feed rollers, disposed on opposite sides of the disc-shaped recording medium that is being transported, from a plane direction thereof and by transporting the disc-shaped recording medium so that the pair of feed rollers roll on the outer peripheral surface of the disc-shaped recording medium.

In such disc loading devices, in a transportation mode, a transporting mechanism transports the disc-shaped recording medium inserted from the disc insertion slot to, for example, a recording/reproducing unit in order to record an information signal onto or reproduce the information signal from the disc-shaped recording medium.

In the disc loading device using the tray method, however, since it is necessary to draw out the disc tray from the housing, dispose the disc-shaped recording medium on the disc tray, and draw the disc tray into the housing again, operations of a plurality of stages need to be carried out. Therefore, the disc-shaped recording medium is loaded after many operations have been carried out, thereby giving rise to the problems that the disc loading device is not easy to use and that time is required to achieve the loading.

In contrast, in the disc loading device using the slot-in method, since the disc-shaped recording medium is directly drawn into the housing and loaded, it is possible to increase the usability and reduce the time required to achieve the loading.

However, since the pair of rollers nip the disc-shaped recording medium from the thickness direction thereof and draws it into the housing, a recording surface of the disc-shaped recording medium may become damaged by contact between the roller and the recording surface. Therefore, a recording error or a reproducing error of an information signal may occur.

Consequently, there is a demand for a disc loading device using the slot-in method, which makes it possible to prevent damage to the recording surface of the disc-shaped recording medium.

A disc loading device may be used as, for example, what is called a disc changer which can accommodate a plurality of disc-shaped recording media and which can be used to record an information signal onto and reproduce it from a predetermined one of the accommodated disc-shaped recording media. Such a disc changer comprises a stocker which can separately accommodate the plurality of disc-shaped recording media, in addition to a recording/reproducing unit for recording information signals onto or reproducing them from the disc-shaped recording media.

In the disc changer, it is necessary to transport a disc-shaped recording medium between the disc insertion slot or the recording/reproducing unit and the stocker in addition to transporting the disc-shaped recording medium inserted from the disc insertion slot to the recording-and-reproducing unit. Therefore, it is necessary to increase the length of a transportation stroke of the disc-shaped recording medium.

Consequently, as mentioned above, in providing a disc loading device using the slot-in method and making it possible to prevent damage to the recording surface of the disc-shaped recording medium, it is necessary to provide a long transportation stroke and to reliably transport the disc-shaped recording medium.

Accordingly, it is an object of the present invention to provide a disc loading device which can overcome the aforementioned problems in order to provide excellent usability, to prevent damage to a disc-shaped recording medium, and to allow a disc-shaped recording medium to be reliably transported, etc.

When a different disc-shaped recording medium is inadvertently inserted from the disc insertion slot during, for example, transportation of a disc-shaped recording medium by the transporting mechanism or recording or reproducing of an information signal, malfunctioning of the transporting mechanism or interference of the different disc-shaped recording medium with the disc-shaped recording medium at the recording/reproducing unit may occur.

According, it is another object of the present invention to provide a disc loading device which can overcome this problem in order to prevent inadvertent insertion of a disc-shaped recording medium.

### DISCLOSURE OF INVENTION

In order to overcome the aforementioned problems, the present invention provides a disc loading device comprising first and second transporting means disposed on opposite sides of a disc-shaped recording medium that is being transported for transporting the disc-shaped recording medium by being pushed against the outer peripheral surface of the disc-shaped recording medium from the opposite sides. The first transporting means comprises a plurality of feed rollers which are spaced apart from each other along a transportation path of the disc-shaped recording medium and which transport the disc-shaped recording medium while transferring it by independently and successively rolling on the outer peripheral surface of the disc-shaped recording medium.

Therefore, in the disc loading device in accordance with the present invention, the disc-shaped recording medium is transported by being transferred successively between the rotating feed rollers.

In order to overcome the aforementioned problems, the present invention also provides a disc loading device comprising first and second transporting means disposed on opposite sides of a disc-shaped recording medium that is being transported for transporting the disc-shaped recording medium by being pushed against the outer peripheral surface of the disc-shaped recording medium from the opposite sides, and a supporting chassis that is separated in the thickness direction of the disc-shaped recording medium that is transported. The first transporting means comprises a plurality of feed rollers which are spaced apart from each other along a transportation path of the disc-shaped recording medium and which transport the disc-shaped recording medium while transferring it by independently and successively rolling on the outer peripheral surface of the disc-shaped recording medium. A plurality of sliders and restricting means are provided. The sliders support the plurality of feed rollers, are movably supported by the supporting chassis, and move the rollers away from the outer peripheral surface of the disc-shaped recording medium that is being transported. The restricting means restricts the movement of the slider which supports the feed roller that is disposed closest to the disc insertion slot in an operation mode or modes other than a transportation mode in which the disc-shaped recording medium is inserted.

### BRIEF DESCRIPTION OF THE DRAWINGS

FIG. 1, together with FIGS. 2 to 6, conceptually shows an embodiment of the present invention, and is a plan view of a device for transporting a disc-shaped recording medium through a straight path with feed rollers used in first transporting means and a feed wall used in second transporting means.

FIG. 2 is a plan view of a device for transporting a disc-shaped recording medium through a straight path with feed rollers used in first transporting means and feed members used in second transporting means.

FIG. 3 is a plan view of a device for transporting a disc-shaped recording medium through a straight path with feed rollers used in first and second transporting means.

FIG. 4, together with FIGS. 5 and 6, shows a device for transporting a disc-shaped recording medium through a curved path, and is a plan view of the device having a central angle including an approximately 90 degree transportation path.

FIG. 5 is a plan view of a device having a central angle including an approximately 180 degree transportation path.

FIG. 6 is a plan view of a device having a central angle including an approximately 180 degree transportation path and having a disc insertion slot and a disc ejection slot separately disposed.

FIG. 7, together with FIGS. 8 to 99, shows the embodiments of the present invention in detail, and is a perspective view of the entire device.

FIG. 8 is a perspective view of the entire device with a supporting chassis being separated from a base chassis.

FIG. 9 is a plan view of the supporting chassis.

FIG. 10 is an enlarged perspective view of a disc guide disposed at the supporting chassis.

FIG. 11 is a perspective view of the supporting chassis supporting each part.

FIG. 12 is a plan view of the supporting chassis supporting each part.

FIG. 13 is a sectional view taken along line XIII-XIII of FIG. 7.

FIG. 14 is an enlarged perspective view of the rear end of the supporting chassis supporting each part.

FIG. 15 is an enlarged perspective view conceptually showing the feed members.

FIG. 16 is an enlarged partly exploded perspective view of third sliding means and each part supported by the third sliding means.

FIG. 17 is an enlarged perspective view showing the relationship between the position of a chucking pulley and that of a detaching member.

FIG. 18 is a plan view of the base chassis.

FIG. 19 is an enlarged plan view of a mode producing drive mechanism.

FIG. 20 is an enlarged exploded perspective view of a cam, a Geneva driven gear, and a coupling gear.

FIG. 21 is an enlarged partly exploded perspective view showing the relationship between the positions of a base unit, the cam, and a mode slider.

FIG. 22 is an exploded perspective view of insertion restricting means and each part for operating the insertion restricting means.

FIG. 23 is an enlarged perspective view of the insertion restricting means.

FIG. 24 is an enlarged exploded perspective view of a subchassis and each part supported in a recess of the base chassis.

FIG. 25 is a plan view of the mode slider.

FIG. 26 is a partly exploded perspective view showing the relationship between the positions of the base unit, the base chassis, and the supporting chassis.

FIG. 27 is a plan view of a transportation drive unit and a stocker ascending/descending mechanism.

FIG. 28 is an enlarged exploded perspective view of the subchassis and an operating lever.

FIG. 29 is an enlarged perspective view of the subchassis and each rotary mechanism.

FIG. 30 is an enlarged plan view of the subchassis and each rotary mechanism.

FIG. 31 is an enlarged exploded perspective view of the subchassis and each part of each rotary mechanism.

FIG. 32 is a plan view showing the relationship between the positions of the subchassis, the mode slider, and each rotary mechanism.

FIG. 33 is an enlarged partly exploded perspective view of a stocker and the stocker ascending/descending mechanism.

FIG. 34 is an enlarged perspective view of a rotary cam.

FIG. 35 is an enlarged development view of the rotary cam.

FIG. 36 is a front view of the entire device.

FIG. 37 is a conceptual view showing the relationship of force generated between the disc-shaped recording medium and feed rollers and the feed members.

FIG. 38, together with FIGS. 39 to 95, illustrates an operation, and is a plan view of a state of a transporting mechanism, etc., in a transportation mode.

FIG. 39 is an enlarged plan view of a state of the mode producing drive mechanism, etc., in the transportation mode.

FIG. 40 is a perspective view of a state of the insertion restricting means in the transportation mode.

FIG. 41 is an enlarged partly sectional front view of a state of the base unit, etc., in the transportation mode.

FIG. 42 is an enlarged plan view of a state of the mode producing drive mechanism, etc., in an ascending/descending mode.

FIG. 43 is a perspective view of a state of the insertion restricting means in the ascending/descending mode.

FIG. 44 is a conceptual view of a state in which the insertion of the disc-shaped recording medium is restricted by a restricting pin of the insertion restricting means.

FIG. 45 is an enlarged sectional view of a state in which the stocker is positioned at a lower movement end.

FIG. 46 is an enlarged sectional view of a state in which the stocker is positioned at an upper movement end.

FIG. 47 is a plan view of a state in which the disc-shaped recording medium is transported and first sliding means is moved.

FIG. 48 is a plan view of a state in which the disc-shaped recording medium is further transported from the state shown in FIG. 47, and second sliding means is moved by the movement of the first sliding means.

FIG. 49 is a plan view of a state in which the disc-shaped recording medium is further transported from the state shown in FIG. 48, and is brought into contact with a first feed roller, a first feed member, a second feed roller, and a second feed member.

FIG. 50 is a plan view of a state in which the disc-shaped recording medium is further transported from the state shown in FIG. 49, and a drive slider and a driven slider of the first sliding means are moved towards each other.

FIG. 51 is a plan view showing a state in which the disc-shaped recording medium is further transported from the state shown in FIG. 50, and the third sliding means is moved.

FIG. 52 is a plan view of a state in which the disc-shaped recording medium is transported from the state shown in FIG. 51, and is transferred from the second feed roller and the second feed member to a third feed roller and a third feed member.

FIG. 53 is a plan view of a state in which the disc-shaped recording medium is transported from the state shown in FIG. 52 to a reproducing unit.

FIG. 54 is an enlarged plan view of a state of the mode producing drive mechanism, etc., when the mode is being changed from the ascending/descending mode to an accommodation/take-out mode.

FIG. 55 is a plan view of a state in which the accommodation/take-out mode is set following the state shown in FIG. 53.

FIG. 56 is an enlarged plan view of a state of the mode producing drive mechanism, etc., when the accommodation/take-out mode is set.

FIG. 57 is a plan view of a state immediately after the disc-shaped recording medium has been transported towards the stocker from the reproducing unit from the state shown in FIG. 55.

FIG. 58 is a plan view of a state in which the disc-shaped recording medium is transported towards the stocker from the state shown in FIG. 57.

FIG. 59 is a plan view of a state in which the disc-shaped recording medium is transported towards the stocker following the state shown in FIG. 58.

FIG. 60 is a plan view of a state in which the disc-shaped recording medium is transported from the state shown in FIG. 59, and movable levers are rotated away from each other.

FIG. 61 is a plan view of a state in which the disc-shaped recording medium is transported from the state shown in FIG. 60, and is transferred from a fifth feed roller and a fifth feed member to a sixth feed roller and a sixth feed member.

FIG. 62 is a perspective view of a state in which the disc-shaped recording medium is transported while being supported by the disc guide.

FIG. 63 is an enlarged sectional view of a state in which the disc-shaped recording medium is accommodated in a disc accommodating portion of the stocker.

FIG. 64 is a plan view of a state in which the disc-shaped recording medium is accommodated in the disc accommodating portion of the stocker and is in contact with the sixth feed roller and the sixth feed member.

FIG. 65, together with FIGS. 66 to 71, is a conceptual view illustrating an increase in the efficiency of the transporting operation, and a case in which a feed roller which transfers the disc-shaped recording medium has a small diameter.

FIG. 66 is a conceptual view showing a case in which a feed member which receives the disc-shaped recording medium has a small diameter.

FIG. 67 is a conceptual view showing a case in which a feed member which transfers the disc-shaped recording medium has a large diameter.

FIG. 68 is a conceptual view showing a case in which a feed roller which receives the disc-shaped recording medium has a large diameter.

FIG. 69 is a conceptual view showing a case in which the feed rollers are linked by linking means.

FIG. 70, together with FIG. 71, is a conceptual view showing a case in which operating members are used, and is a conceptual view of the disc-shaped recording medium, and the feed member and the feed roller where the respective operating members are disposed.

FIG. 71 is a conceptual view of the transporting operation when the operating members are used.

FIG. 72 is an enlarged partly sectional front view of a state in which the base unit is being rotated.

FIG. 73 is an enlarged partly sectional front view of a state in which the disc-shaped recording medium is chucked.

FIG. 74, together with FIGS. 75 and 76, shows a state of each rotary mechanism when the mode slider has been moved, and is an enlarged plan view of a state immediately after the mode slider has been moved.

FIG. 75 is an enlarged plan view of a state in which the mode slider is being moved from the state shown in FIG. 74.

FIG. 76 is an enlarged plan view of a state in which the mode slider is being moved from the state shown in FIG. 75.

FIG. 77 is an enlarged plan view of a state of the mode producing drive mechanism, etc., when the mode slider has been moved to a forward movement end.

FIG. 78 is a plan view of a state in which the feed rollers and the feed members are separated from the chucked disc-shaped recording medium.

FIG. 79 is an enlarged partly sectional front view of a state in which the feed rollers and the feed members are separated from the chucked disc-shaped recording medium.

FIG. 80 is an enlarged partly sectional front view of a state in which the chucking pulley is forcefully separated from a disc table by the detaching member when the base unit is rotated.

FIG. 81 is an enlarged sectional view of a state in which the disc-shaped recording medium is accommodated in a disc accommodating portion at an accommodation/take-out position.

FIG. 82, together with FIG. 83, shows a state in which disc-shaped recording media accommodated in disc accommodating portions of the stocker are prevented from falling out of the disc accommodating portion, and is an enlarged sectional view of a state in which the stocker is positioned at the upward movement end.

FIG. 83 is an enlarged sectional view of a state in which the stocker is positioned at the lower movement end.

FIG. 84, together with FIG. 85, shows the aligning of the disc-shaped recording media accommodated in the disc accommodating portions when the stocker is raised and lowered, and is an enlarged side view illustrating the aligning operation when the stocker is raised.

FIG. 85 is an enlarged side view of the aligning operation when the stocker is lowered.

FIG. 86, together with FIGS. 87 to 95, shows an operation for transporting a disc-shaped recording medium having a small diameter, and is a plan view of a state in which the disc-shaped recording medium is being transported towards the reproducing unit.

FIG. 87 is a plan view of a state in which the disc-shaped recording medium has been transported to the reproducing unit from the state shown in FIG. 86.

FIG. 88 is an enlarged plan view of a state in which the mode slider is being moved.

FIG. 89 is a plan view showing a state in which the feed rollers and the feed members are separated from the chucked disc-shaped recording medium.

FIG. 90 is an enlarged partly sectional front view of a state in which the feed rollers and the feed members are separated from the chucked disc-shaped recording medium.

FIG. 91 is an enlarged perspective view of a disc adapter and the disc-shaped recording medium.

FIG. 92 is an enlarged partly sectional front view of a state in which the disc-shaped recording medium mounted to the disc adapter is chucked.

FIG. 93, together with FIGS. 94 and 95, shows an operation carried out when the disc adapter has been dislodged, and is a conceptual view of a state in which the disc adapter is received by a receiving member.

FIG. 94 is a conceptual view of a state in which the outer peripheral edge of the disc adapter is in sliding contact with an inclined portion of the receiving member.

FIG. 95 is a conceptual view of a state in which the disc adapter is re-held.

FIG. 96, together with FIGS. 97 to 99, illustrates the characteristics of materials of the feed members and the feed rollers, and is a table of the resilience of various butyl rubbers.

FIG. 97 shows a graph and a table of the dependency of the hardness of each type of material on temperature.

FIG. 98 shows a graph of the dependency of the hardness of each type of butyl rubber on temperature.

FIG. 99 is a graph of the dependency of the hardness of various other types of butyl rubbers on temperature.

### BEST MODE FOR CARRYING OUT THE INVENTION

Hereunder, embodiments of the present invention will be described with reference to the attached drawings.

In the embodiments described below, the present invention is applied to a disc loading device which can transport a disc-shaped recording medium, such as an optical disc, inserted from a disc insertion slot and load the disc-shaped recording medium in order to reproduce an information signal from the disc-shaped recording medium.

Although, in the embodiments described below, the present invention is applied to a device for reproducing an information signal recorded on a disc-shaped recording medium, the present invention may be applied to a device for recording an information signal onto a disc-shaped recording medium or to a device for recording an information signal onto and reproducing the information signal from a disc-shaped recording medium.

The disc loading device described below comprises a stocker which can accommodate a plurality of disc-shaped recording media, and functions as a disc changer which allows any disc-shaped recording medium accommodated in the stocker to be taken out and which can accommodate any disc-shaped medium in the stocker.

The following items of the embodiments of the invention will be described in the following order:

(1) General Description of a Disc Loading Device

(2) Transportation Path of Disc-shaped Recording Medium

(3) Specific Structure of the Disc Loading Device
(a) General Description of the Entire Structure
(b) Supporting Chassis
(c) First Sliding Means
(d) Second Sliding Means
(e) Third Sliding Means
(f) Fourth Sliding Means
(g) Fifth Sliding Means
(h) Movable Lever
(i) Chucking Pulley
(j) Detaching Member
(k) Base Chassis
(l) Mode Producing Drive Mechanism
(m) Insertion Restricting Means
(n) Mode Slider
(o) Base Unit
(p) Disc Sensor
(q) Transportation Drive Unit
(r) Sub-chassis
(s) Rotary mechanisms
(t) Stocker Ascending/Descending Mechanism
(u) Stocker
(v) Structure of Housing

(4) Operation of the Disc Loading Device
(a) Transportation Conditions
(b) Five Operation Modes
(c) Transportation Mode
(d) Transporting Operation Between Disc Insertion Slot and Stocker
(e) Reproducing Operation (Large-diameter Disc-shaped Recording Medium)
(f) Exchanging Operation
(g) Reproducing Operation (Small-diameter Disc-shaped Recording Medium)
(h) Transporting Operation When Using Disc Adapter

Hereunder, these items will be described.

(1) General Description of the Disc Loading Device

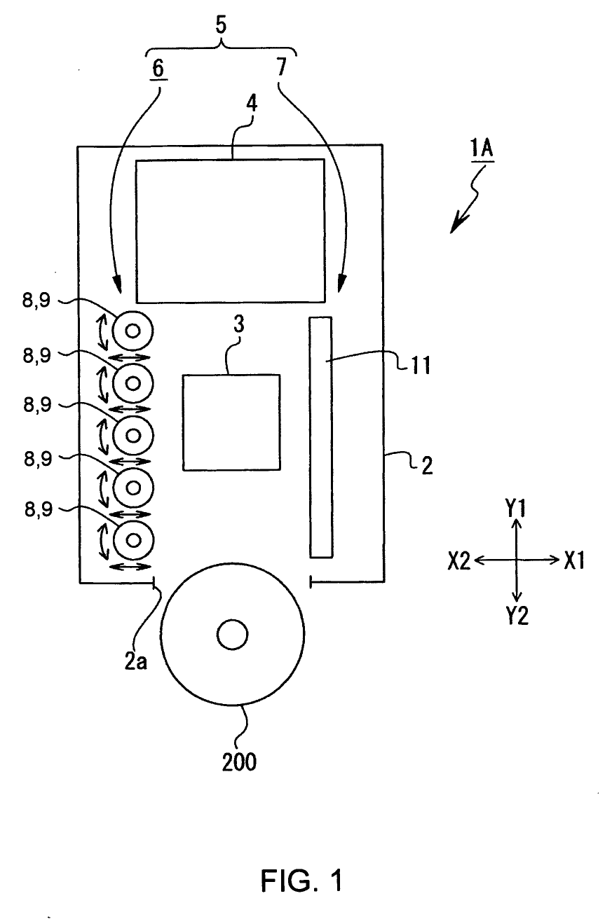

Hereunder, the general description of the disc loading device will be given (see FIGS. 1 to 3).

A disc loading device 1 (disc loading devices 1A, 1B, and 1C) has predetermined members and mechanisms disposed in a housing 2. The housing 2 has, for example, a shape that is substantially rectangular and that is longer than is wide in plan view (see FIGS. 1 to 3). A disc insertion slot 2a for inserting a disc-shaped recording medium 200 is formed in the front surface of the housing 2.

In the disc loading device 1, it is possible to reproduce an information signal from a large-diameter disc-shaped recording medium 200a having a diameter of, for example, approximately 12 cm, and from a small-diameter disc-shaped recording medium 200b having a diameter of, for example, approximately 8 cm; and to accommodate only a plurality of the large-diameter disc-shaped recording media 200a in a stocker (described later).

A reproducing unit 3 for reproducing an information signal from any disc-shaped recording medium 200, a stocker 4 for accommodating a plurality of the disc-shaped recording media 200, and a transporting mechanism 5 for transporting the disc-shaped recording media 200 are disposed in the housing 2 so that the stocker 4 is separated from the reproducing unit 3 and the transporting mechanism 5 in the forward/backward direction. In a device for recording an information signal onto any disc-shaped recording medium 200, a recording unit is disposed instead of the reproducing unit 3. In a device for recording an information signal onto and reproducing it from any disc-shaped recording medium 200, a recording-and-reproducing unit is disposed instead of the reproducing unit 3.

The transporting mechanism 5 comprises first transporting means 6 at the left end of the housing 2 and second transporting means 7 at the right end of the housing 2. At least one of the first transporting means 6 and the second transporting means 7 comprises a plurality of feeding means 8 which are substantially cylindrical or columnar and which are spaced from each other in transportation directions Y1 and Y2 of the disc-shaped recording medium 200.

Rotatable feed rollers 9 or unrotatable feed members 10 are used as the feeding means 8. At least one of the first transporting means 6 and the second transporting means 7 comprise the feed rollers 9. As described later, the feed rollers 9 and the feed members 10 are pushed against the outer peripheral surface of a disc-shaped recording medium 200. When they are pushed against the outer peripheral surface of the disc-shaped recording medium 200, a predetermined friction force is generated between the outer peripheral surface of the disc-shaped recording medium 200 and the feed rollers 9 and the feed members 10, so that the feed rollers 9 and the feed members 10 do not slide with respect to the outer peripheral surface of the disc-shaped recording medium 200.

FIG. 1 shows the disc loading device 1A comprising the feed rollers 9 used in the first transporting means 6 and a feed wall 11 used in the second transporting means 7.

The feed rollers 9 are each movable in movement directions X1 and X2 that are perpendicular to the transportation directions Y1 and Y2 with respect to the housing 2. The feed wall 11 is long in the directions Y1 and Y2 and is fixed to the housing 2. As with the feed rollers 9 and the feed members 10, a predetermined friction force is generated between the feed wall 11 and the outer peripheral surface of a disc-shaped recording medium 200, so that sliding does not occur between the feed wall 11 and the outer peripheral surface of the disc-shaped recording medium 200.

In the disc loading device 1A shown in FIG. 1, when the disc-shaped recording medium 200 is inserted from the disc insertion slot 2a, the rotating feed rollers 9 move in the direction X1 and successively push the outer peripheral surface of the disc-shaped recording medium 200 in order for the outer peripheral surface of the disc-shaped recording medium 200 against which the feed rollers 9 are pushed to be pushed against the feed wall 11.

Therefore, while the disc-shaped recording medium 200 is nipped between the feed rollers 9 and the feed wall 11, the disc-shaped recording medium 200 is transported in the direction Y1 by being successively transferred to each feed roller 9 by the rotation of each feed roller 9. The disc-shaped recording medium 200 is transported up to the reproducing unit 3 or the stocker 4 in order to either reproduce an information signal or accommodate the disc-shaped recording medium 200 in a disc accommodating portion.

While the disc-shaped recording medium 200 is being transported, the feed rollers 9 move in the directions Xi and X2 so as to be pushed against the outer peripheral surface of the disc-shaped recording medium 200 in accordance with a transportation position of the disc-shaped recording medium 200.

The transportation of the disc-shaped recording medium 200 towards the disc insertion slot 2a from the reproducing unit 3 or the stocker 4, that is, the transportation in the direction Y2 is achieved by rotating the feed rollers 9 in a direction opposite to that of the aforementioned rotation while the disc-shaped recording medium 200 is nipped by the feed rollers 9 and the feed wall 11.

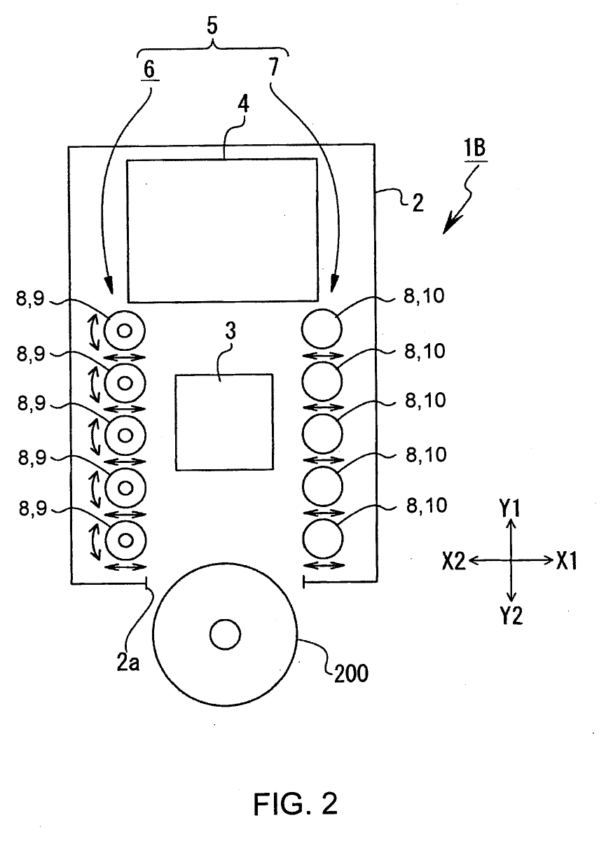

FIG. 2 shows the disc loading device 1B comprising the feed rollers 9 used in the first transporting means 6 and the feed members 10 used in the second transporting means 7.

The feed rollers 9 and the feed members 10 are movable in synchronism so as to move away from each other in the directions X1 and X2 with respect to the housing 2.

In the disc loading device 1B shown in FIG. 2, when the disc-shaped recording medium 200 is inserted from the disc insertion slot 2a, the rotating feed rollers 9 move in the direction X1 and the feed members 10 move in the direction X2 in synchronism therewith in order to successively push the outer peripheral surface of the disc-shaped recording medium 200 from opposite sides.

Therefore, while the disc-shaped recording medium 200 is nipped between the feed rollers 9 and the feed members 10, the disc-shaped recording medium 200 is transported in the direction Y1 by being successively transferred to each feed roller 9 by the rotation of each feed roller 9.

While the disc-shaped recording medium 200 is being transported, the feed rollers 9 and the feed members 10 move in synchronism in the directions X1 and X2 so as to be pushed against the outer peripheral surface of the disc-shaped recording medium 200 in accordance with a transportation position of the disc-shaped recording medium 200.

The transportation of the disc-shaped recording medium 200 in the direction Y2 is achieved by rotating the feed rollers 9 in a direction opposite to that of the aforementioned rotation while the disc-shaped recording medium 200 is nipped by the feed rollers 9 and the feed members 10.

In the disc loading device 1B, although the feed rollers 9 and the feed members 10 are movable in the directions X1 and X2, only the feed rollers 9 or the feed members 10 may be movable in the directions X1 and X2.

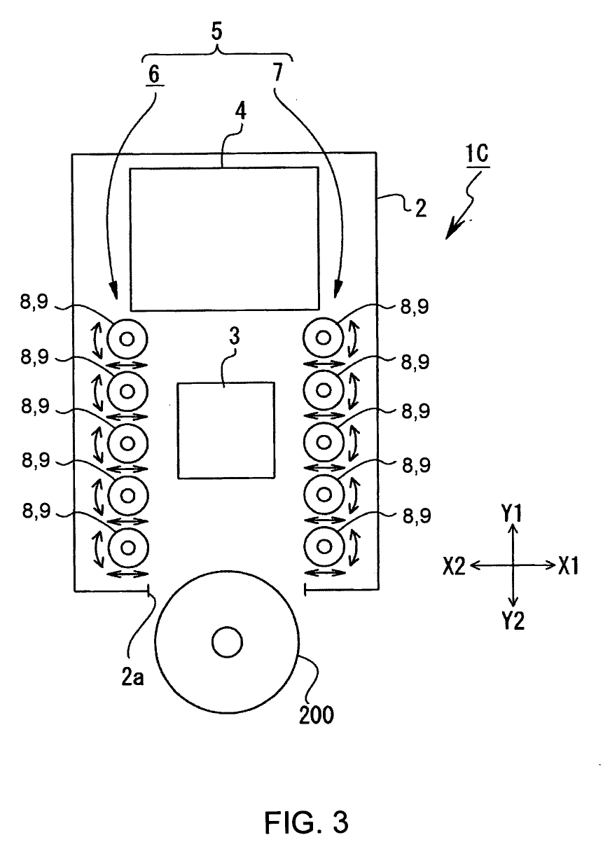

FIG. 3 shows the disc loading device 1C comprising the feed rollers 9 used in the first transporting means 6 and the second transporting means 7.

The feed rollers 9 used in the first transporting means 6 and the feed rollers 9 used in the second transporting means 7 are movable in synchronism so as to move away from each other in the directions X1 and X2 with respect to the housing 2.

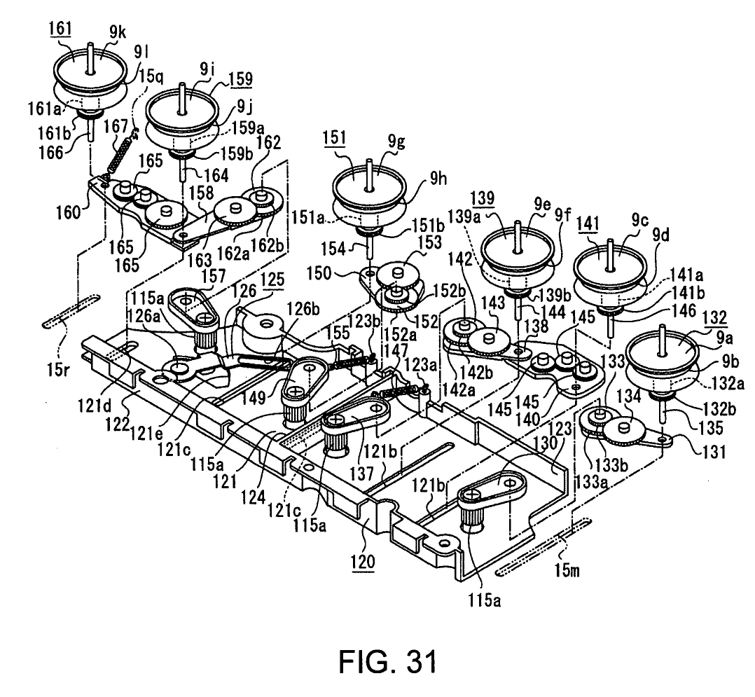

In the disc loading device 1C shown in FIG. 31 when the disc-shaped recording medium 200 is inserted from the disc insertion slot 2a, the rotating feed rollers 9 used in the first transporting means 6 move in the direction X1 and the rotating feed rollers 9 used in the second transporting means 7 move in the direction X2 in order to be successively pushed against the outer peripheral surface of the disc-shaped recording medium 200.

Therefore, while the disc-shaped recording medium 200 is nipped between the feed rollers 9 used in the first transporting means 6 and the feed rollers 9 used in the second transporting means 7, the disc-shaped recording medium 200 is transported in the direction Y1 by being successively transferred to each feed roller 9 by the rotation of each feed roller 9.

While the disc-shaped recording medium 200 is being transported, the feed rollers 9 used in the first transporting means 6 and the feed rollers 9 used in the second transporting means 7 move in synchronism in the directions X1 and X2 so as to be pushed against the outer peripheral surface of the disc-shaped recording medium 200 in accordance with a transportation position of the disc-shaped recording medium 200.

The transportation of the disc-shaped recording medium 200 in the direction Y2 is achieved by rotating the feed rollers 9 in a direction opposite to that of the aforementioned rotation while the disc-shaped recording medium 200 is nipped by the feed rollers 9 used in the first transporting means 6 and the feed rollers 9 used in the second transporting means 7.

In the disc loading device 1C, although the feed rollers 9 used in the first transporting means 6 and the feed rollers 9 used in the second transporting means 7 are movable in the directions X1 and X2, only the feed rollers 9 used in the first transporting means 6 or the feed rollers 9 used in the second transporting means 7 may be movable in the directions X1 and X2.

As described above, in the disc loading device 1 (disc loading devices 1A, 1B, and 1C), since the disc-shaped recording medium 200 is transported by being successively transferred between the rotating feed rollers 9, it is possible to transport the disc-shaped recording medium 200 without using means, such as a disc tray, for disposing and transporting the disc-shaped recording medium 200, so that the usability can be increased.

By disposing the necessary number of feed rollers 9, it is possible to freely set a transportation stroke, so that design freedom can be increased. In particular, in the disc loading device which functions as a disc changer having a stocker in addition to a reproducing unit, it is necessary to transport a disc-shaped recording medium between the reproducing unit and the stocker and to have a long transportation stroke. Therefore, the use of the feed rollers 9 is very effective in increasing the design freedom.

Since the disc-shaped recording medium 200 is transported by pushing the feed rollers 9 and the feed members 10 or the feed wall 11 against the outer peripheral surface of the disc-shaped recording medium 200, it is possible to prevent damage to a recording surface of the disc-shaped recording medium 200.

In the disc loading devices 1B and 1C, the feed rollers 9 and the feed members 10 or the feed rollers 9 used in the first transporting means 6 and the feed rollers 9 used in the second transporting means 7 are movable in synchronism -away from the outer peripheral surface of the disc-shaped recording medium 200 being transported. Therefore, it is possible to stabilize a load applied to the disc-shaped recording medium 200 being transported by the feed rollers 9 and the feed members 10 and to facilitate controlling of the feed operation.

In the disc loading device 1C, since only the rotatable feed rollers 9 are used as the feeding means 8, it is possible to stably and reliably transport the disc-shaped recording medium 200.

(2) Transportation Path of Disc-shaped Recording Medium

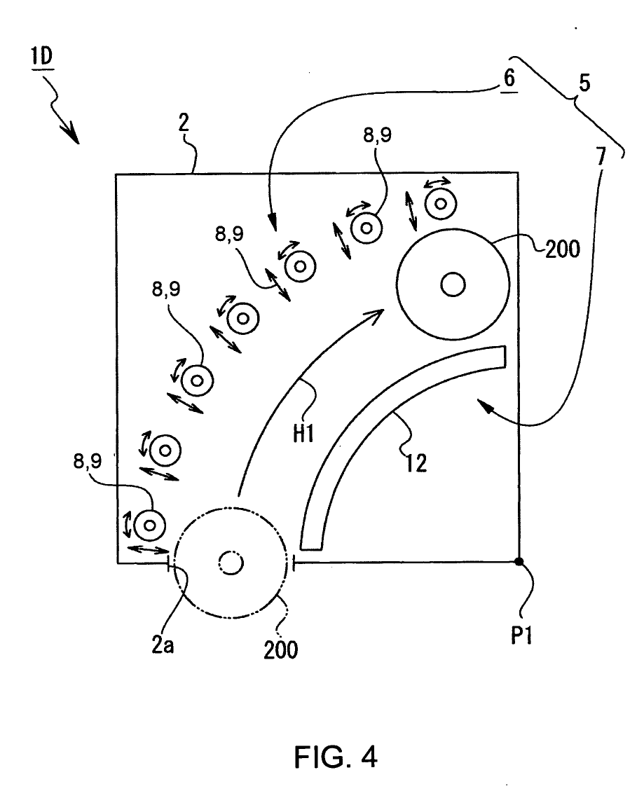

Hereunder, a transportation path of the disc-shaped recording medium 200 will be described (see FIGS. 4 to 6).

As mentioned above, the transportation path of the disc loading device 1 (disc loading devices 1A, 1B, and 1C) is a linear transportation path extending in the directions Y1 and Y2 (see FIGS. 1 to 3). It is possible to curve at least a portion of the transportation path by changing the disposition and forms of the feeding means 8.

FIGS. 4 to 6 are conceptual views of disc loading devices having curved transportation paths.

In a disc loading device 1D shown in FIG. 4, feed rollers 9 used in first transporting means 6 are disposed apart from each other in a circumferential direction, and a feed wall 12 used in second transporting means 7 is formed with an arc shape and is disposed along the direction of arrangement of the feed rollers 9. The feed rollers 9 are disposed apart from each other in a range of a central angle of 90 degrees with one corner P1 of a housing 2 serving as a center. Therefore, a transportation path H1 of the disc loading device 1D is an arc-shaped path having a central angle of 90 degrees.

In the disc loading device 1D, when a disc-shaped recording medium 200 is inserted from a disc insertion slot 2a, the rotating feed rollers 9 move closer to the disc-shaped recording medium 200 and successively push the outer peripheral surface of the disc-shaped recording medium 200 in order to successively push the outer peripheral surface of the disc-shaped recording medium 200 against which the feed rollers 9 are pushed against the feed wall 12.

Therefore, while the disc-shaped recording medium 200 is nipped between the feed rollers 9 and the feed wall 12, the disc-shaped recording medium 200 is transported through the arc-shaped transportation path H1 by being successively transferred to each feed roller 9 by the rotation of each feed roller 9.

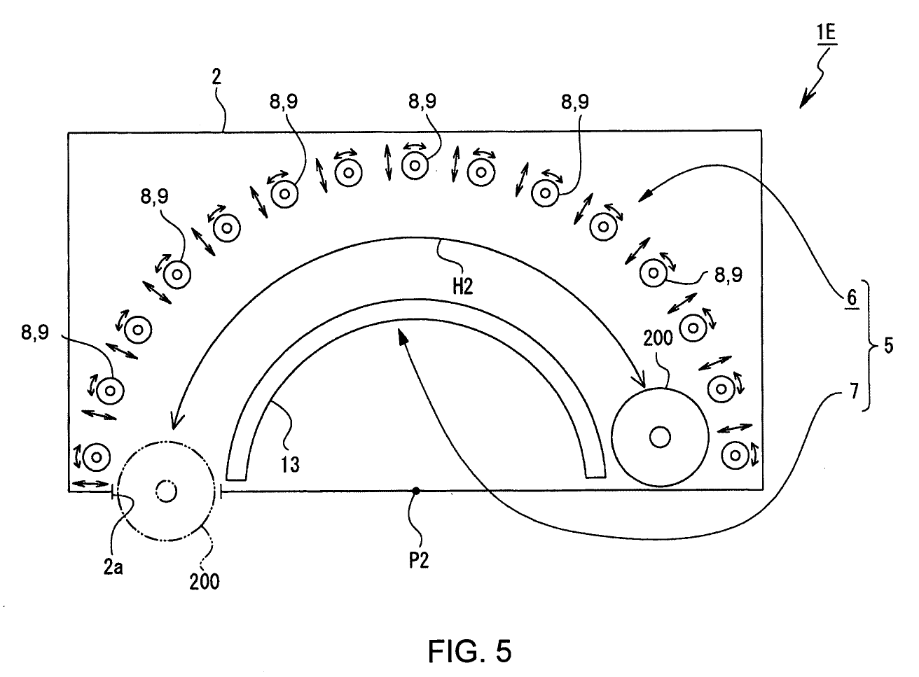

In a disc loading device 1E shown in FIG. 5, feed rollers 9 used in first transporting means 6 are disposed apart from each other in a circumferential direction, and a feed wall 13 used in second transporting means 7 is formed with an arc shape and is disposed along the direction of arrangement of the feed rollers 9. The feed rollers 9 are disposed apart from each other in a range of a central angle of 180 degrees with a substantially center point P2 of a housing 2 in the longitudinal direction serving as a center. Therefore, a transportation path H2 of the disc loading device 1E is an arc-shaped path having a central angle of 180 degrees.

In the disc loading device 1E, when a disc-shaped recording medium 200 is inserted from a disc insertion slot 2a, the rotating feed rollers 9 move closer to the disc-shaped recording medium 200 and successively push the outer peripheral surface of the disc-shaped recording medium 200 in order to push the outer peripheral surface of the disc-shaped recording medium 200 against which the feed rollers 9 are pushed against the feed wall 13.

Therefore, while the disc-shaped recording medium 200 is nipped between the feed rollers 9 and the feed wall 13, the disc-shaped recording medium 200 is transported through the arc-shaped transportation path H2 by being successively transferred to each feed roller 9 by the rotation of each feed roller 9.

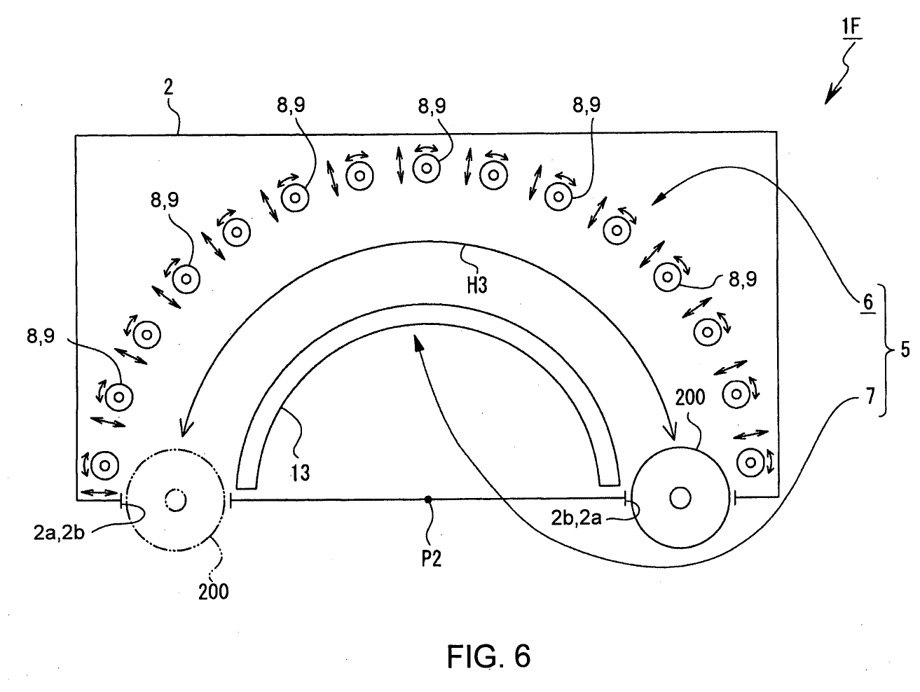

The structure and the operation of a disc loading device 1F shown in FIG. 6 are the same as those of the disc loading device 1E except that, for example, a disc insertion slot 2a and a disc take-out slot 2b are formed apart from each other in a housing 2 in the leftward/rightward direction.

In the disc loading device 1F, a transportation path H3 is an arc-shaped path having a central angle of 180 degrees with a substantially center point P2 in the longitudinal direction of the housing 2 serving as a center. The disc-shaped recording medium 200 transported by being inserted from the disc insertion slot 2a is transported through the transportation path H3 and removed from the disc take-out slot 2b. The positions of the disc insertion slot 2a and the disc take-out slot 2b may be reversed.

As described above, the curved transportation paths H1, H2, and H3 are formed in the respective disc loading devices 1D, 1E, and 1F, so that it is possible to increase the design freedom.

The feed rollers 9 do not need to be disposed apart from each other in the aforementioned circumferential direction, so that they may be disposed in any way. The feed walls 12 and 13 are formed with shapes that extend along the direction of arrangement of the feed rollers 9.

Therefore, when the positions of the other mechanisms in the housing 2 are set, it is possible to set the direction of arrangement of the feed rollers 9 to any direction, so that it is possible to prevent the feed rollers 9 from easily interfering with the other mechanisms that are disposed in the disc loading devices 1D, 1E, and 1F.

Although the feed walls 12 and 13 are used in the second transporting means 7, feed members 10 or feed rollers 9 may be used in the second transporting means 7.

(3) Specific Structure of Disc Loading Device

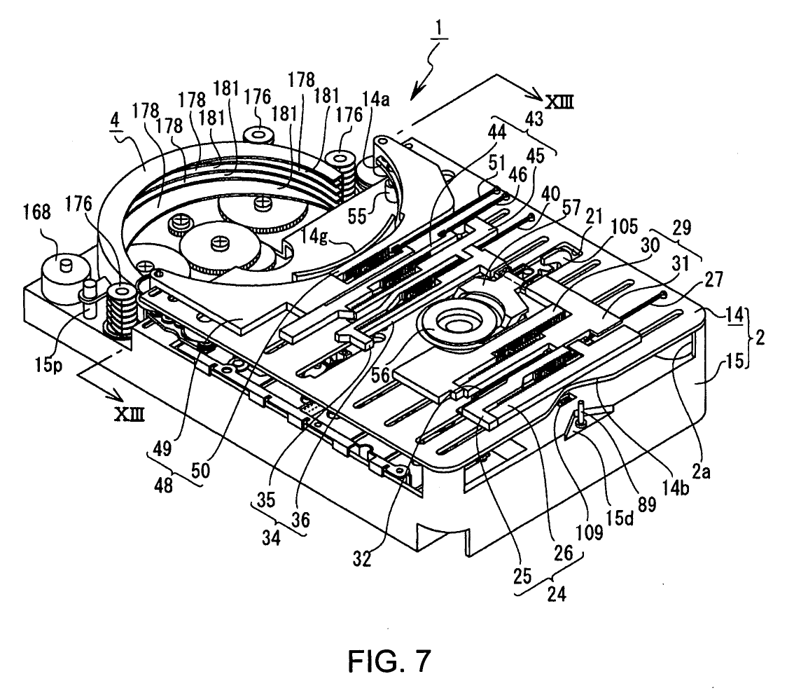

Hereunder, the specific structure of the disc loading device 1 will be described (see FIGS. 7 to 36).

(a) General Description of the Entire Structure

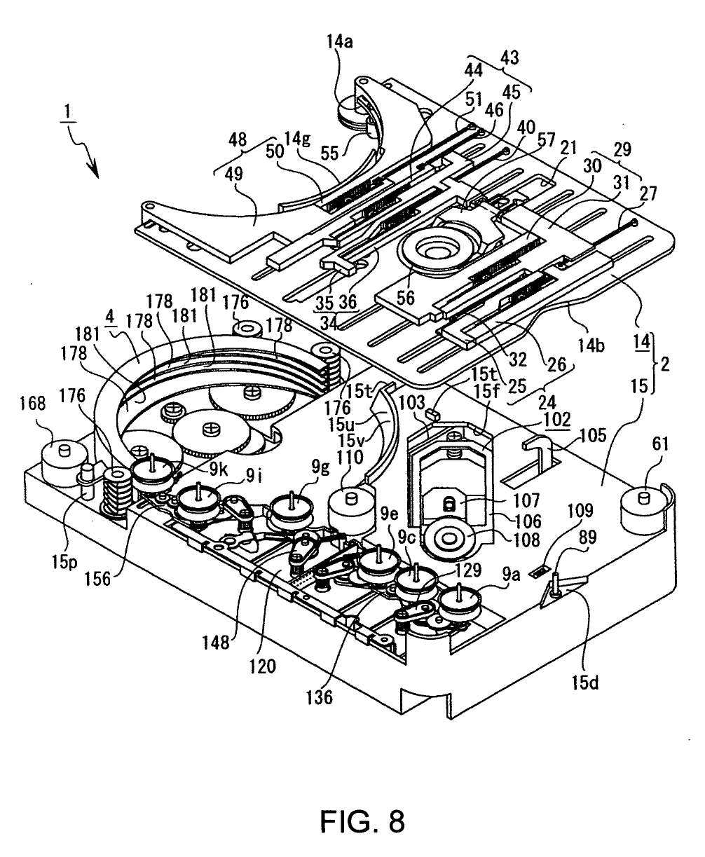

The disc loading device 1 has the predetermined parts and mechanisms disposed in the housing 2. The housing 2 comprises a supporting chassis 14 and a base chassis 15 joined in a vertical direction (see FIGS. 7 and 8).

(b) Supporting Chassis

The supporting chassis 14 has a substantially flat shape, and a large substantially semicircular cut portion 14a in the back end (see FIGS. 7 to 9). A cut portion 14b which opens forwardly is formed in the central portion of the front edge of the supporting chassis 14 in a horizontal direction.

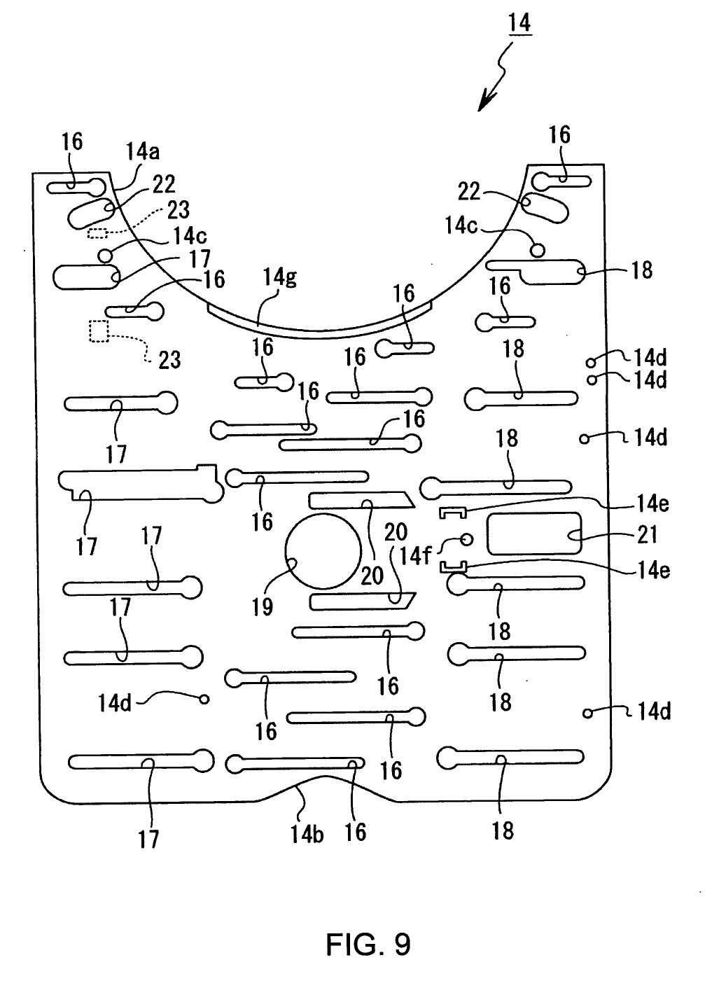

A plurality of guide holes 16 are spaced apart in a forward/backward direction in the central portion of the supporting chassis 14 in the horizontal direction, and are long in the horizontal direction (see FIG. 9). Guide holes 16 are also formed in the back ends of the left and right end portions of the supporting chassis 14.

Left insertion holes 17 are spaced apart in the forward/backward direction in the left end side of the supporting chassis 14, and are long in the horizontal direction. Right insertion holes 18 are spaced apart in the forward/backward direction in the right end side of the supporting chassis 14, and are long in the horizontal direction.

A circular pulley supporting hole 19 is formed in substantially the central portion of the supporting chassis 14. Member disposing holes 20 and 20, which are long in the horizontal direction, are formed in the supporting chassis 14 so as to be disposed in front of and behind the pulley supporting hole 19. An insertion hole 21, which is long sideways, is formed to the right of the pulley supporting hole 19 in the supporting chassis 14.

Lever disposing holes 22 and 22 are formed in the left end portion and the right end portion of the back ends of the supporting chassis 14, and have a gentle short arc shape. Upwardly protruding lever supporting protrusions 14c and 14c are disposed immediately in front of the lever disposing holes 22 and 22 in the supporting chassis 14.

Upwardly protruding spring holding protrusions 14d are spaced apart in the forward/backward direction at the right end locations of the upper surface of the supporting chassis 14. One spring holding protrusion 14d is also formed at the left front end side of the chassis 14.

Member supporting protrusions 14e and 14e are spaced apart in the forward/backward direction in the upper surface of the supporting chassis 14 so as to be disposed between the pulley supporting hole 19 and the insertion hole 21. The member supporting protrusions 14e and 14e are formed with U shapes so that the open ends oppose each other. An upwardly protruding insertion shaft 14f is disposed immediately to the left of the insertion hole 21 in the supporting chassis 14.

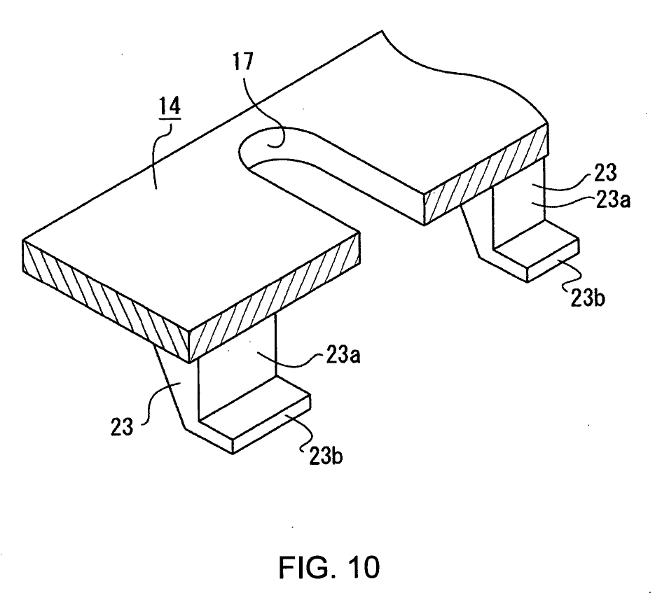

Disc guides 23 and 23 are spaced apart from each other in the forward/backward direction in the lower surface of the supporting chassis 14 (see FIGS. 9 and 10). The disc guides 23 and 23 protrude downward from the rear end side of the supporting chassis 14. At the disc guides 23 and 23, vertical portions 23a and 23a protruding downward from the lower surface of the supporting chassis 14 and receivers 23b and 23b protruding rightwards from the lower ends of the vertical portions 23a and 23a are integrally formed (see FIG. 10).

Arc-shaped dislodging preventing portions 14g and 14h are disposed at an edge defining the cut portion 14a of the supporting chassis 14 (see FIGS. 7, 8, 9, and 13). The dislodging preventing portion 14g is an arc-shaped wall protruding upward from the edge defining the cut portion 14a, and is disposed at the central portion of the edge in the horizontal direction thereof. The dislodging preventing portion 14h is an arc-shaped wall protruding downward from the edge defining the cut portion 14a, and extends substantially over the entire edge.

(c) First Sliding Means

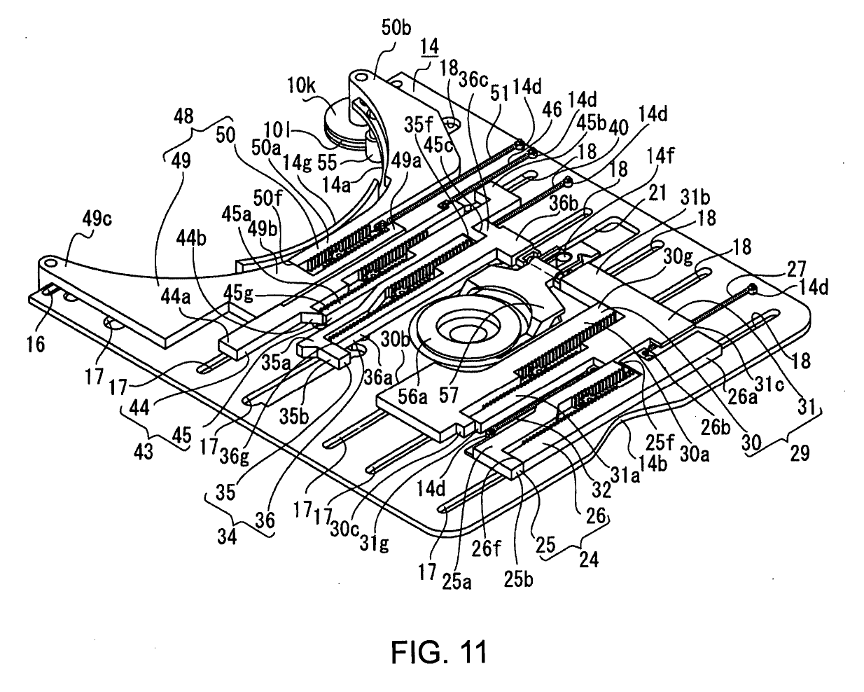

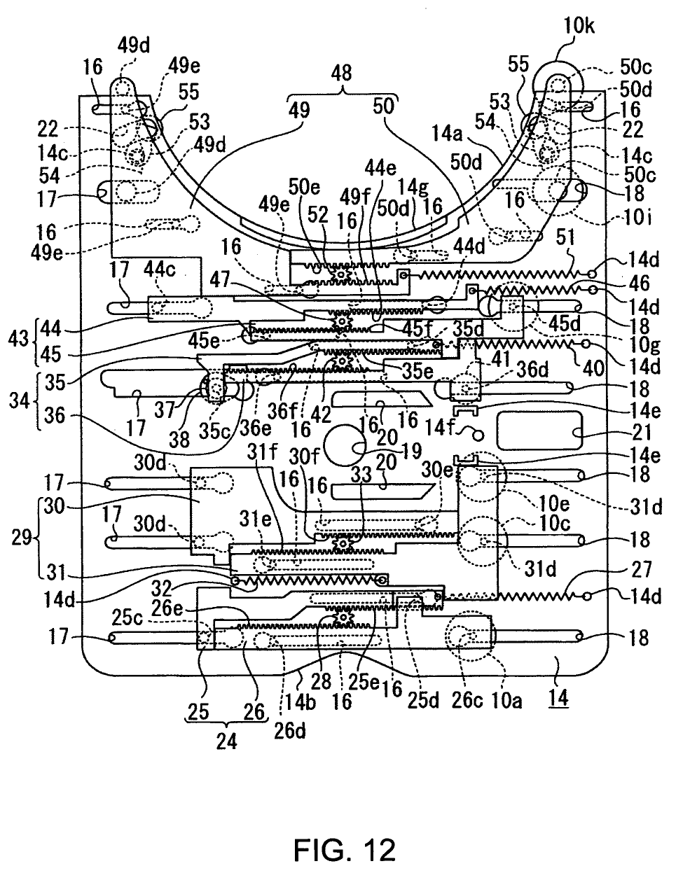

First sliding means 24 is supported at the front end of the supporting chassis 14 so as to be slidable towards the left and right, and comprises a drive slider 25 and a driven slider 26 (see FIGS. 11 and 12).

The drive slider 25 comprises a main portion 25a which is long in the substantially leftward/rightward direction and a restricting protrusion 25b which protrudes towards the front from the left end of the main portion 25a. A downwardly protruding supporting cylindrical portion 25c is disposed at the lower surface of the restricting protrusion 25b, and a downwardly protruding guide pin 25d is disposed towards the right end of the lower surface of the main portion 25a. A rack 25e is formed at the front surface of the main portion 25a. A step 25f is formed at the right end of the upper surface of the main portion 25a. Therefore, the right portion of the upper surface is lower than the left portion of the upper surface by the step 25f.

The supporting cylindrical portion 25c is inserted in the front left insertion hole 17 from thereabove, the guide pin 25d is inserted in the second guide hole 16 from the front from thereabove, and the supporting cylindrical portion 25c and the guide pin 25d are guided by the associated left insertion hole 17 and the associated guide hole 16, respectively, so that the drive slider 25 is slidable towards the left and right with respect to the supporting chassis 14.

While the drive slider 25 is supported by the supporting chassis 14, a spring (tensile spring) 27 is stretched tightly between the right end portion of the main portion 25a and the spring holding protrusion 14d disposed to the right of the right end. Therefore, the drive slider 25 is biased towards the right by the spring 27.

The driven slider 26 comprises a main portion 26a which is long in the horizontal direction and a pushing protrusion 26b protruding backwards from the right end of the main portion 26a. A downwardly protruding mounting shaft 26c is disposed at the right end of the lower surface of the main portion 26a, and a downwardly protruding guide pin 26d is disposed towards the left end of the lower surface of the main portion 26a. A rack 26e is formed at the back surface of the main portion 26a. The left end of the main portion 26a is formed as a restricting portion 26f.

The mounting shaft 26c is inserted in the front right insertion hole 18 from above, the guide pin 26d is inserted in the front guide hole 16 from above, and the mounting shaft 26c and the guide pin 26d are guided by the associated right insertion hole 18 and guide hole 16, respectively. Accordingly, the driven slider 26 is slidable towards the left and right with respect to the supporting chassis 14.

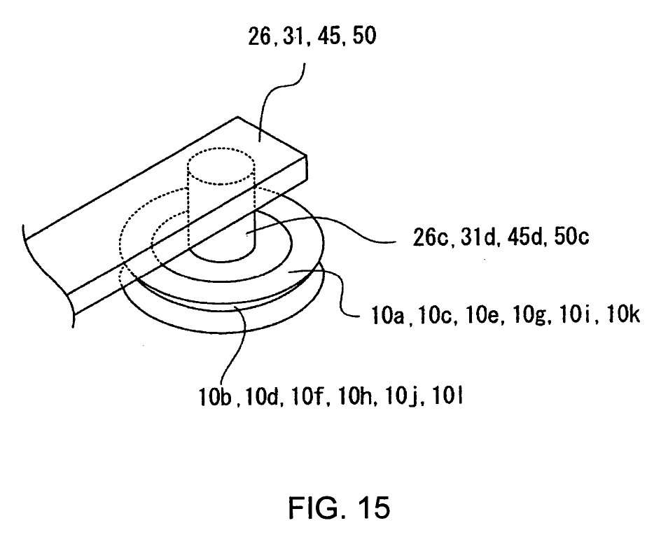

When the driven slider 26 is supported by the supporting chassis 14, a first feed member 10a is mounted to the mounting shaft 26c (see FIG. 15). The first feed member 10a is a flat substantially cylindrical member, and is disposed below the supporting chassis 14. The first feed member 10a has a holding groove 10b along its circumference, and is fixed to the driven slider 26.

When the drive slider 25 and the driven slider 26 are supported by the supporting chassis 14, the pushing protrusion 26b of the driven slider 26 is disposed on the drive slider 25 at the right side of the step 25f of the drive slider 25.

When the drive slider 25 and the driven slider 26 are supported by the supporting chassis 14, a pinion 28 which engages the racks 25e and 26e is rotatably supported between the drive slider 25 and the driven slider 26 at the supporting chassis 14. Therefore, the drive slider 25 and the driven slider 26 slide horizontally in synchronism. A leftward biasing force is applied to the drive slider 26 by the spring 27 through the drive slider 25 and the pinion 28.

As described above, the spring 27 biases the drive slider 25 rightwards and the driven slider 26 leftwards. When an external force is not applied to the drive slider 25 and the driven slider 26, the restricting protrusion 25b of the drive slider 25 and the restricting portion 26f of the driven slider 26 contact each other, thereby restricting the rightward movement of the drive slider 25 and the leftward movement of the driven slider 26.

When the drive slider 25 and the driven slider 26 slide in synchronism away from each other, it is possible for the supporting cylindrical portion 25c and the guide pin 25d of the drive slider 25 to contact the left edge defining the associated left insertion hole 17 and the left edge defining the associated guide hole 16, respectively, thereby restricting the leftward sliding of the drive slider 25; and, at the same time, the mounting shaft 26c and the guide pin 26d of the driven slider 26 to contact the right edge defining the associated right insertion hole 18 and the right edge defining the associated guide hole 16, respectively, thereby restricting the rightward sliding of the driven slider 26.

Although the spring 27 is stretched and compressed when the drive slider 25 and the driven slider 26 slide leftwards and rightwards in synchronism, since the spring 27 is disposed to the right of the drive slider 25, it is stretched and compressed in a space in which the drive slider 25 moves.

(d) Second Sliding Means

Second sliding means 29 is supported behind the first sliding means 24 at the supporting chassis 14 so as to be slidable leftwards and rightwards, and comprises a drive slider 30 and a driven slider 31 (see FIGS. 11 and 12).

The drive slider 30 comprises a main portion 30a which is long in the leftward/rightward direction, a protrusion 30b which protrudes towards the back from substantially the left half of the main portion 30a, and a restricting protrusion 30c which protrudes towards the front from the leftward end of the main portion 30a. Downwardly protruding supporting cylindrical portions 30d and 30d are disposed at the left end portion of the lower surface of the protrusion 30b and at the left end portion of the lower surface of the main portion 30a so as to be spaced apart from each other in the forward/backward direction, and a downwardly protruding guide pin 30e is disposed towards the right end of the lower surface of the main portion 30a. A rack 30f is formed at the front surface of the main portion 30a. The right end portion of the main portion 30a is formed as a restricting portion 30g.

The supporting cylindrical portions 30d and 30d are inserted in the associated left insertion holes 17 and 17 from thereabove, the guide pin 30e is inserted in the associated guide hole 16 from thereabove, and the supporting cylindrical portions 30d and 30d and the guide pin 30e are guided by the associated left insertion holes 17 and 17 and the associated guide hole 16, respectively, so that the drive slider 30 is slidable towards the left and right with respect to the supporting chassis 14.

The driven slider 31 comprises a main portion 31a which is long in the horizontal direction, a restricting protrusion 31b which protrudes towards the back from the right end of the main portion 31a, and a push protrusion 31c protruding forwardly from the upper edge of the right end of the main portion 31a. Downwardly protruding mounting shafts 31d and 31d are disposed at the right end of the lower surface of the main portion 31a and the right end of the lower surface of the restricting protrusion 31b so as to be spaced apart in the forward/backward direction, and a downwardly protruding guide pin 31e is disposed towards the left end of the lower surface of the main portion 31a. A rack 31f is formed at the back surface of the main portion 31a. The left end of the main portion 31a is formed as a restricting portion 31g.

The mounting shafts 31d and 31d are inserted in the associated right insertion holes 18 and 18 from thereabove, the guide pin 31e is inserted in the associated guide hole 16 from thereabove, and the mounting shafts 31d and 31d and the guide pin 31e are guided by the associated right insertion holes 18 and 18 and guide hole 16. Accordingly, the driven slider 31 is slidable horizontally with respect to the supporting chassis 14.

While the driven slider 31 is supported by the supporting chassis 14, a spring (tensile spring) 32 is stretched tightly between a substantially central portion of the main portion 31a in the horizontal direction and a spring holding protrusion 14d disposed to the left of the substantially central portion. Therefore, the driven slider 31 is biased towards the left by a spring 32.

When the driven slider 31 is supported by the supporting chassis 14, a second feed member 10c and a third feed member 10e are mounted to the mounting shafts 31d and 31d (see FIG. 15). The second feed member 10c and the third feed member 10e are substantially cylindrical members, and are disposed below the supporting chassis 14. The second feed member 10c and the third feed member 10e have holding grooves 10d and 10f along their circumferences, and are fixed to the driven slider 31.

When the drive slider 30 and the driven slider 31 are supported by the supporting chassis 14, a pinion 33 which engages the racks 30f and 31f is rotatably supported between the drive slider 30 and the driven slider 31 at the supporting chassis 14. Therefore, the drive slider 30 and the driven slider 31 slide horizontally in synchronism. A rightward biasing force is applied to the drive slider 30 by the spring 32 through the drive slider 31 and the pinion 33.

As described above, the spring 32 biases the drive slider 30 rightwards and the driven slider 31 leftwards. When an external force is not applied to the drive slider 30 and the driven slider 31, the restricting protrusion 30c of the drive slider 30 and the restricting portion 31g of the driven slider 31 contact each other, and the restricting portion 30g of the drive slider 30 and the restricting protrusion 31b of the driven slider 31 contact each other, thereby restricting the rightward movement of the drive slider 30 and the leftward movement of the driven slider 31.

When the drive slider 30 and the driven slider 31 slide in synchronism away from each other, it is possible for the supporting cylindrical portions 30d and 30d and the guide pin 30e of the drive slider 30 to contact the left edges defining the associated left insertion holes 17 and 17 and the left edge defining the associated guide hole 16, respectively, thereby restricting the leftward sliding of the drive slider 30; and, at the same time, the mounting shafts 31d and 31d and the guide pin 31e of the driven slider 31 to contact the right edges defining the associated right insertion holes 18 and 18 and the right edge defining the associated guide hole 16, respectively, thereby restricting the rightward sliding of the driven slider 31.

Although the spring 32 is stretched and compressed when the drive slider 30 and the driven slider 31 slide leftwards and rightwards in synchronism, since the spring 32 is disposed immediately in front of the driven slider 31, it is stretched and compressed in a space in which the driven slider 31 moves.

When the drive slider 25 and the driven slider 26 of the first sliding means 24 slide in synchronism, and the driven slider 26 moves rightwards to a predetermined position, the pushing protrusion 26b of the driven slider 26 pushes the push protrusion 31c of the driven slider 31 of the second sliding means 29 towards the right. Therefore, the movement of the driven slider 26 causes the drive slider 30 and the driven slider 31 to slide in synchronism towards the left and right.

(e) Third Sliding Means

Third sliding means 34 is supported behind the pulley supporting hole 19 of the supporting chassis 14 so as to be slidable towards the left and right, and comprises a first slider 35 and a second slider 36 (see FIGS. 11 and 12).

The first slider 35 comprises a main portion 35a which is long in the substantially leftward/rightward direction and a restricting protrusion 35b which protrudes towards the front from the left end of the main portion 35a. A downwardly protruding supporting shaft 35c is disposed at the lower surface of the restricting protrusion 35b, and a downwardly protruding guide pin 35d is disposed towards the right end of the lower surface of the main portion 35a. A rack 35e is formed at the front surface of the main portion 35a. A step 35f is formed towards the right end of the upper surface of the main portion 35a. Therefore, the right portion of the upper surface is lower than the left portion of the upper surface by the step 35f.

The supporting shaft 35c is inserted in the associated left insertion hole 17 from thereabove, the guide pin 35d is inserted in the associated guide hole 16 from thereabove, and the supporting shaft 35c and the guide pin 35d are guided by the associated left insertion hole 16 and the associated guide hole 16, respectively, so that the first slider 35 is slidable towards the left and right with respect to the supporting chassis 14.

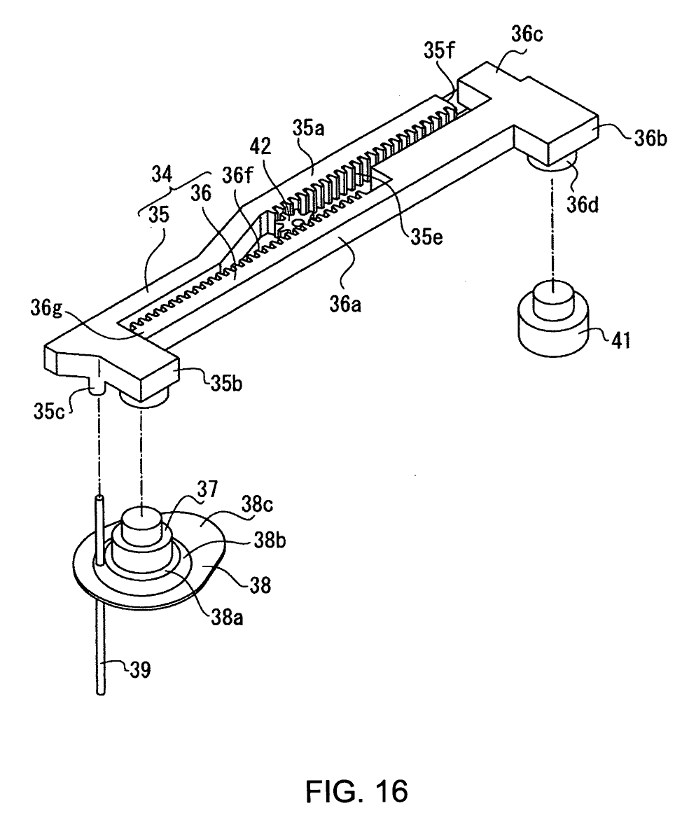

A first restricting roller 37 is rotatably supported at the supporting shaft 35c of the first slider 35 (see FIG. 16).

A receiving member 38 is supported at the supporting shaft 35c so as to be disposed under the first restricting roller 37 (see FIG. 16). The receiving member 38 has a substantially disc-shaped support portion 38a, a substantially annular inclined portion 38b formed continuously with the outer peripheral edge of the support portion 38a and extending downward as it extends outward from the outer peripheral edge, and a receiving portion 38c formed continuously with and extending outward from the outer peripheral edge of the inclined portion 38b. The support portion 38a is supported by the supporting shaft 35c. The right end portion of the receiving portion 38c protrudes considerably rightwards than the other portions thereof. A guide shaft 39 having its upper end mounted to the first slider 35 passes through a portion of the receiving portion 38c. The receiving member 38 is not capable of rotating with respect to the first slider 35.

While the first slider 35 is supported by the supporting chassis 14, a spring (tensile spring) 40 is stretched tightly between the right end of the main portion 35a and a spring holding protrusion 14d disposed to the right of the right end. Therefore, the drive slider 35 is biased towards the right by the spring 40.

The second slider 36 comprises a main portion 36a which is long in the horizontal direction, a protrusion 36b which protrudes forwardly from the right end of the main portion 36a, and a push protrusion 36c protruding backwards from the right end of the main portion 36a. A downwardly protruding supporting shaft 36d is disposed at the right end of the lower surface of the protrusion 36b, and a downwardly protruding guide pin 36e is disposed towards the left end of the lower surface of the main portion 36a. A rack 36f is formed at the back surface of the main portion 36a. The left end of the main portion 36a is formed as a restricting portion 36g.

The supporting shaft 36d is inserted in the associated right insertion hole 18 from thereabove, the guide pin 36e is inserted in the associated guide hole 16 from thereabove, and the supporting shaft 36d and the guide pin 36e are guided by the associated right insertion hole 18 and guide hole 16. Accordingly, the second slider 36 is slidable horizontally with respect to the supporting chassis 14.

A second restricting roller 41 is rotatably supported at the supporting shaft 36d of the second slider 36 (see FIG. 16).

When the first slider 35 and the second slider 36 are supported by the supporting chassis 14, the push protrusion 36c of the second slider 36 is positioned on the upper side of the first slider 35 at the right side of the step 35f of the first slider 35.

When the first slider 35 and the second slider 36 are supported by the supporting chassis 14, a pinion 42 which engages the racks 35e and 36f is rotatably supported between the first slider 35 and the second slider 36 at the supporting chassis 14. Therefore, the first slider 35 and the second slider 36 slide horizontally in synchronism. A leftward biasing force is applied to the second slider 36 by the spring 40 through the first slider 35 and the pinion 42.

As described above, the spring 40 biases the first slider 35 rightwards and the second slider 36 leftwards. When an external force is not applied to the first slider 35 and the second slider 36, the restricting protrusion 35b of the first slider 35 and the restricting portion 36g of the second slider 36 contact each other, thereby restricting the rightward movement of the first slider 35 and the leftward movement of the second slider 36.

When the first slider 35 and the second slider 36 slide in synchronism away from each other, it is possible for the supporting shaft 35c and the guide pin 35d of the first slider 35 to contact the left edge defining the associated left insertion hole 17 and the left edge defining the associated guide hole 16, respectively, thereby restricting the leftward sliding of the first slider 35; and, at the same time, the supporting shaft 36d and the guide pin 36e of the second slider 36 to contact the right edge defining the associated right insertion hole 18 and the right edge defining the associated guide hole 16, respectively, thereby restricting the rightward sliding of the second slider 36.

Although the spring 40 is stretched and compressed when the first slider 35 and the second slider 36 slide leftwards and rightwards in synchronism, since the spring 40 is disposed to the right of the first slider 35, it is stretched and compressed in a space in which the first slider 35 moves.

(f) Fourth Sliding Means

Fourth sliding means 43 is supported behind the third sliding means 34 at the supporting chassis 14 so as to be slidable towards the left and right, and comprises a drive slider 44 and a driven slider 45 (see FIGS. 11 and 12).

The drive slider 44 comprises a main portion 44a which is long in the leftward/rightward direction and a restricting protrusion 44b which protrudes towards the front from a location of the main portion 44a slightly towards the left from the central portion of the main portion 44a in the leftward/rightward direction. A downwardly protruding supporting cylindrical portion 44c is disposed towards the left end of the lower surface of the main portion 44a, and a downwardly protruding guide pin 44d is disposed towards the right end of the lower surface of the main portion 44a. A rack 44e is formed at the front surface of the main portion 44a.

The supporting cylindrical portion 44c is inserted in the associated left insertion hole 17 from thereabove, the guide pin 44d is inserted in the associated guide hole 16 from thereabove, and the supporting cylindrical portion 44c and the guide pin 44d are guided by the associated left insertion hole 17 and the associated guide hole 16, respectively, so that the drive slider 44 is slidable towards the left and right with respect to the supporting chassis 14.

While the drive slider 44 is supported by the supporting chassis 14, a spring (tensile spring) 46 is stretched tightly between the right end of the main portion 44a and a spring holding protrusion 14d disposed to the right of the right end. Therefore, the drive slider 44 is biased towards the right by the spring 46.

The driven slider 45 comprises a main portion 45a which is long in the horizontal direction, a protrusion 45b which protrudes towards the back from the right end of the main portion 45a, and a pushing protrusion 45c which protrudes forwardly from the right end portion of the main portion 45a. A downwardly protruding mounting shaft 45d is disposed at the lower surface of the protrusion 45b, and a downwardly protruding guide pin 45e is disposed at the left end of the lower surface of the main portion 45a. A rack 45f is formed at the back surface of the main portion 45a. The left end of the main portion 45a is formed as a restricting portion 45g.

The mounting shaft 45d is inserted in the associated right insertion hole 18 from thereabove, the guide pin 45e is inserted in the associated guide hole 16 from thereabove, and the mounting shaft 45d and the guide pin 45e are guided by the associated right insertion hole 18 and the associated guide hole 16, respectively, so that the driven slider 45 is slidable towards the left and right with respect to the supporting chassis 14.

While the driven slider 45 is supported by the supporting chassis 14, a fourth feed member 10g is mounted to the mounting shaft 45d (see FIG. 15). The fourth feed member 10g is a substantially cylindrical member, and is disposed below the supporting chassis 14. The fourth feed member 10g has a holding groove 10h along its circumference, and is fixed to the driven slider 45.

When the drive slider 44 and the driven slider 45 are supported by the supporting chassis 14, at the right side of a step 35f of the first slider 35 of the third sliding means 34, the pushing protrusion 45c of the driven slider 45 is positioned on the upper surface of the first slider 35 and contacts the push protrusion 36c of the second slider 36 of the third sliding means 34 from the left.

When the drive slider 44 and the driven slider 45 are supported by the supporting chassis 14, a pinion 47 which engages the racks 44e and 45f is rotatably supported between the drive slider 44 and the driven slider 45 at the supporting chassis 14. Therefore, the drive slider 44 and the driven slider 45 slide horizontally in synchronism. A leftward biasing force is applied to the driven slider 45 by the spring 46 through the drive slider 44 and the pinion 47.

As described above, the spring 46 biases the drive slider 44 rightwards and the driven slider 45 leftwards. When an external force is not applied to the drive slider 44 and the driven slider 45, the restricting protrusion 44b of the drive slider 44 and the restricting portion 45g of the driven slider 45 contact each other, thereby restricting the rightward movement of the drive slider 44 and the leftward movement of the driven slider 45.

When the drive slider 44 and the driven slider 45 slide in synchronism away from each other, it is possible for the supporting cylindrical portion 44c and the guide pin 44d of the drive slider 44 to contact the left edge defining the associated left insertion hole 17 and the left edge defining the associated guide hole 16, respectively, thereby restricting the leftward sliding of the drive slider 44; and, at the same time, the mounting shaft 45d and the guide pin 45e of the driven slider 45 to contact the right edge defining the associated right insertion hole 18 and the right edge defining the associated guide hole 16, respectively, thereby restricting the rightward sliding of the driven slider 45.

The spring 46 is stretched and compressed when the drive slider 44 and the driven slider 45 slide leftwards and rightwards in synchronism. Since the spring 46 is disposed to the right of the drive slider 44, it is stretched and compressed in a space in which the drive slider 44 moves.

When the drive slider 44 and the driven slider 45 slide in synchronism, the pushing protrusion 45c of the driven slider 45 pushes the push protrusion 36c of the second slider 36 of the third sliding means 34 towards the right. Therefore, the movement of the driven slider 45 causes the first slider 35 and the second slider 36 to slide in synchronism towards the left and right.

(g) Fifth Sliding Means

Fifth sliding means 48 is supported behind the fourth sliding means 43 at the supporting chassis 14 so as to be slidable leftwards and rightwards, and comprises a drive slider 49 and a driven slider 50 (see FIGS. 11 and 12).

The drive slider 49 comprises a main portion 49a which is long in the leftward/rightward direction, a restricting protrusion 49b which protrudes towards the back from the left half of the main portion 49a, and a protrusion 49c which protrudes towards the back and obliquely leftwards from the left end of the restricting protrusion 49b. Downwardly protruding supporting cylindrical portions 49d and 49d are disposed at the lower surface of the protrusion 49c so as to be spaced apart from each other in the forward/backward direction. Downwardly protruding guide pins 49e, 49e, and 49e are disposed at the lower surface of the drive slider 49. A rack 49f is formed at the back surface of the main portion 49a.

The supporting cylindrical portions 49d and 49d are inserted in the associated left insertion holes 17 and 17 from thereabove, the guide pins 49e, 49e, and 49e are inserted in the associated guide holes 16, 16, and 16 from thereabove, and the supporting cylindrical portions 49d and 49d and the guide pins 49e, 49e, and 49e are guided by the associated left insertion holes 17 and 17 and the associated guide holes 16, 16, and 16, respectively, so that the drive slider 49 is slidable towards the left and right with respect to the supporting chassis 14.

While the drive slider 49 is supported by the supporting chassis 14, a spring (tensile spring) 51 is stretched tightly between the right end of the main portion 49a and a spring holding protrusion 14d disposed to the right of the right end. Therefore, the drive slider 49 is biased towards the right by the spring 51.

The driven slider 50 comprises a main portion 50a which is long in the horizontal direction, and a protrusion 50b which protrudes towards the back and obliquely rightwards from the right end of the main portion 50a. Downwardly protruding mounting shafts 50c and 50c are disposed at the protrusion 50b so as to be spaced apart in the forward/backward direction. Downwardly protruding guide pins 50d, 50d, and 50d are disposed at the lower surface of the driven slider 50. A rack 50e is formed at the front surface of the main portion 50a. The left end of the main portion 50a is formed as a restricting portion 50f.

The mounting shafts 50c and 50c are inserted in the associated right insertion holes 18 and 18 from thereabove, the guide pins 50d, 50d, and 50d are inserted in the associated guide holes 16, 16, and 16 from thereabove, and the mounting shafts 50c and 50c and the guide pins 50d, 50d, and 50d are guided by the associated right insertion holes 18 and 18 and guide holes 16, 16, and 16. Accordingly, the driven slider 50 is slidable horizontally with respect to the supporting chassis 14.

When the driven slider 50 is supported by the supporting chassis 14, a fifth feed member 10i and a sixth feed member 10k are mounted to the mounting shafts 50c and 50c (see FIG. 15). The fifth feed member 10i and the sixth feed member 10k are substantially cylindrical members, and are disposed below the supporting chassis 14. The fifth feed member 10i and the sixth feed member 10k have holding grooves 10j and 10l along their circumferences, and are fixed to the driven slider 50.

When the drive slider 49 and the driven slider 50 are supported by the supporting chassis 14, a pinion 52 which engages the racks 49f and 50e is rotatably supported between the drive slider 49 and the driven slider 50 at the supporting chassis 14. Therefore, the drive slider 49 and the driven slider 50 slide horizontally in synchronism. A leftward biasing force is applied to the driven slider 50 by the spring 51 through the drive slider 49 and the pinion 52.

As described above, the spring 51 biases the drive slider 49 rightwards and the driven slider 50 leftwards. When an external force is not applied to the drive slider 49 and the driven slider 50, the restricting protrusion 49b of the drive slider 49 and the restricting portion 50f of the driven slider 50 contact each other, thereby restricting the rightward movement of the drive slider 49 and the leftward movement of the driven slider 50.

When the drive slider 49 and the driven slider 50 slide in synchronism away from each other, it is possible for the supporting cylindrical portions 49d and 49d and the guide pins 49e, 49e, and 49e of the drive slider 49 to contact the left edges defining the associated left insertion holes 17 and 17 and the left edges defining the associated guide holes 16, 16, and 16, respectively, thereby restricting the leftward sliding of the drive slider 49; and, at the same time, the mounting shafts 50c and 50c and the guide pins 50d, 50d, and 50d of the driven slider 50 to contact the right edges defining the associated right insertion holes 18 and 18 and the right edges defining the associated guide holes 16, 16, and 16, respectively, thereby restricting the rightward sliding of the driven slider 50.

The spring 51 is stretched and compressed when the drive slider 49 and the driven slider 50 slide leftwards and rightwards in synchronism. Since the spring 51 is disposed to the right of the drive slider 49, it is stretched and compressed in a space in which the drive slider 49 moves.

For example, annular rubber members (not shown) are mounted to the holding grooves 10b, 10d, 10f, 10h, 10j, and 10l of the respective feed members 10a, 10c, 10e, 10g, 10i, and 10k. When they are pushed against the outer peripheral surface of a disc-shaped recording medium 200, a predetermined friction force is generated in order to prevent the feed members from sliding with respect to the outer peripheral surface of the disc-shaped recording medium 200.

The first restricting roller 37 and the second restricting roller 41 are formed of, for example, resinous material having good slidability, and rotate while sliding with respect to the outer peripheral surface of a disc-shaped recording medium 200.

The second transporting means 7 comprises the feed members 10a, 10c, 10e, 10g, 10i, and 10k.

As described above, in the disc loading device 1, since the sliding means 24, 29, 34, 43, and 48 are all supported by the supporting chassis 14, it is possible to dispose the sliding means 24, 29, 34, 43, and 48 with high precision by forming the supporting chassis 14 with high manufacturing precision.

Since the sliding means 24, 29, 34, 43, and 48 are all movably supported by the supporting chassis 14, the sliding means 24, 29, 34, 43, and 48 all move with respect to the supporting chassis 14, so that it is possible to easily control operations between the sliding means 24, 29, 34, 43, and 48.

Since the sliding means 24, 29, 34, 43, and 48 are all mounted to the supporting chassis 14, it is possible to easily manufacture the disc loading device 1 with increased mounting efficiency.

As described above, in the sliding means 24, 29, 34, 43, and 48, the drive slider 25 and the driven slider 26, the drive slider 30 and the driven slider 31, the first slider 35 and the second slider 36, the drive slider 44 and the driven slider 45, and the drive slider 49 and the driven slider 50 are such that their movements towards each other are restricted by contacting at least a portion of one slider with a portion of the other slider. Therefore, it is not necessary to use any stopper designed specifically for restricting the movements. Consequently, it is possible to reduce the number of parts and simplify the mechanisms.

In addition, in the sliding means 24, 29, 34, 43, and 48, the drive slider 25 and the driven slider 26, the drive slider 30 and the driven slider 31, the first slider 35 and the second slider 36, the drive slider 44 and the driven slider 45, and the drive slider 49 and the driven slider 50 are such that their movements away from each other are restricted by contacting the supporting cylindrical portions 25c, 30d, 30d, 44c, 49d, and 49d, the supporting shafts 35c and 36d, and the guide pins 25d, 26d, 30e, 31e, 35d, 36e, 44d, 45e, 49e, 49e, 49e, 50d, 50d, and 50d with the edges defining the associated left insertion holes 17, the edges defining the associated right insertion holes 18, and the edges defining the associated guide holes 16 of the supporting chassis 14. Therefore, it is not necessary to use any stopper designed specifically for restricting the movements, so that the number of parts is reduced and the mechanisms are simplified.

Although the example in which the tensile springs 27, 32, 40, 46, and 51 are used as means for biasing the sliders 25 and 26 of the sliding means 24, the sliders 30 and 31 of the sliding means 29, the sliders 35 and 36 of the sliding means 34, the sliders 44 and 45 of the sliding means 43, and the sliders 49 and 50 of the sliding means 48 in predetermined directions is given, the biasing means are not limited to the springs 27, 32, 40, 46, and 51. Therefore, other members, such as rubber members, having predetermined elasticities may be used.

Although the example in which the pinions 28, 33, 42, 47, and 52 are used to move the sliders 25 and 26, the sliders 30 and 31, the sliders 35 and 36, the sliders 44 and 45, and the sliders 49 and 50 is given, the means for moving the sliders in synchronism are not limited to the pinions 28, 33, 42, 47, and 52. Therefore, predetermined members, such as links or levers, may also be used.

(h) Movable Levers

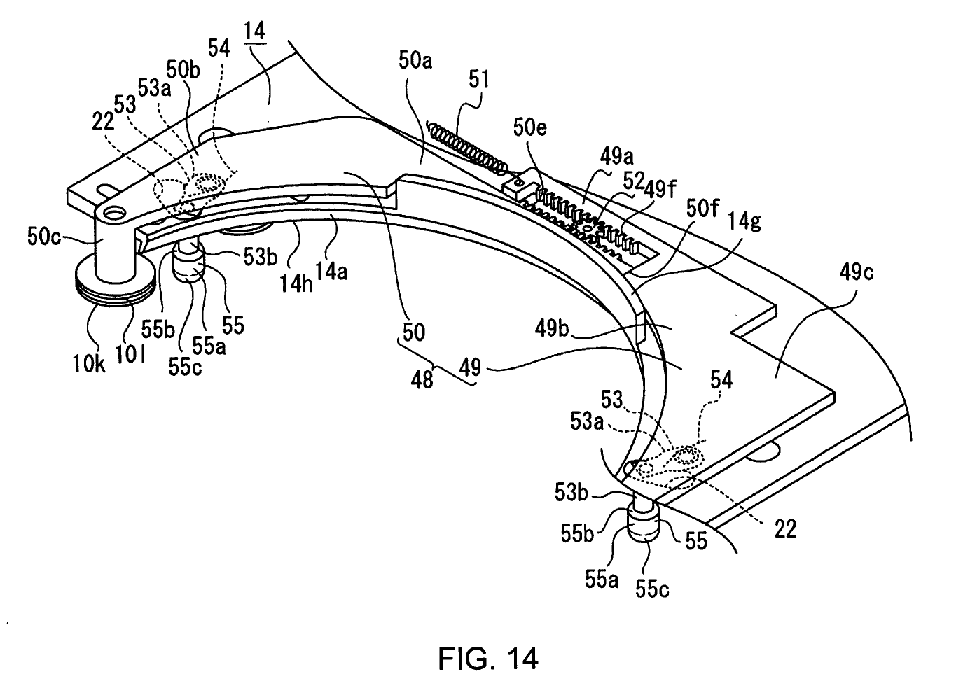

Movable levers 53 and 53 are rotatably disposed at the respective lever supporting protrusions 14c and 14c disposed towards the back end of the supporting chassis 14 (see FIGS. 12 and 14). In the movable levers 53 and 53, support portions 53a and 53a and shafts 53b and 53b protruding downward from ends of the respective support portions 53a and 53a are integrally formed. The other ends of the support portions 53a and 53a of the respective movable levers 53 and 53 are rotatably supported by the respective lever supporting protrusions 14c and 14c, and the shafts 53b and 53b protrude downward from the lever disposing holes 22 and 22 of the supporting shaft 14.

The movable levers 53 and 53 are biased by respective torsional coil springs 54 and 54 so that the shafts 53b and 53b move closer to each other. The rotation of the shafts 53b and 53b closer to each other is restricted by the shafts 53b and 53b coming into contact with edges of the respective lever disposing holes 22 and 22.

Stoppers 55 and 55 are rotatably supported at the shafts 53b and 53b of the respective movable levers 53 and 53 (see FIGS. 12 to 14). The stoppers 55 and 55 are formed of a material having good slidability and have a substantially cylindrical shape. Each of the stoppers 55 and 55 has inclined guides 55b and 55c formed on the upper and lower edges of a peripheral surface 55a so as to incline towards the center as they near the upper and lower portions, respectively.

(i) Chucking Pulley

A chucking pulley 56 is supported by the pulley supporting hole 19 in the supporting chassis 14 so as to be rotatable and movable vertically (see FIG. 11).

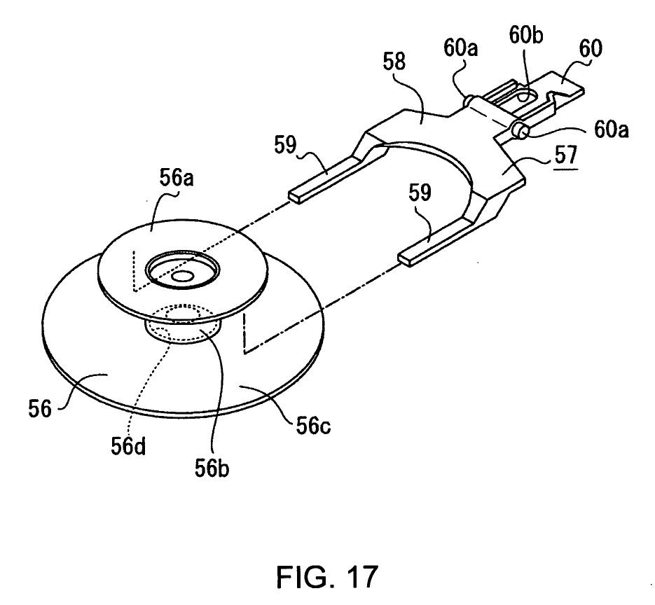

In the chucking pulley 56, a substantially disc-shaped flange 56a and stabilizer 56b are connected vertically by a connecting shaft 56c (see FIG. 17). The diameter of the flange 56a is smaller than the diameter of the stabilizer 56b and is larger than the diameter of the connecting shaft 56c and the diameter of the pulley supporting hole 19 of the supporting chassis 14. The connecting shaft 56c has an insertion recess 56d formed in the lower surface thereof. A magnetic metallic plate (not shown) is mounted to the inner portion of the chucking pulley 56.

The chucking pulley 56 is supported by the supporting chassis 14 by inserting the connecting shaft 56c in the pulley supporting hole 19. The flange 56a is disposed at the upper surface of the supporting chassis 14, and the stabilizer 56b is disposed at the lower surface of the supporting chassis 14.

(j) Detaching Member

A detaching member 57 is rotatably supported by the member supporting protrusions 14e and 14e of the supporting chassis 14 (see FIG. 11). In the detaching member 57, a base 58, lifting portions 59 and 59 protruding leftwards from the front and back ends of the base 58, and an operation portion 60 protruding rightwards from the central portion of the base 58 in the forward/backward direction are integrally formed (see FIG. 17). Support pins 60a and 60a protruding towards the front and back, respectively, are formed at leftward locations of the operation portion 60. An opening 60b is formed in the operation portion 60.

In the detaching member 57, the support pins 60a and 60a are inserted and supported inside the member supporting protrusions 14e and 14e, and the hole 60b receives the insertion shaft 14f of the supporting chassis 14.

When the detaching member 57 is rotatably supported by the supporting chassis 14, the right end of the operation portion 60 is disposed above the insertion hole 21 of the supporting chassis 14, and the lifting portions 59 and 59 are inserted under the flange 56a of the chucking pulley 56 and are positioned in correspondence with the member disposing holes 20 and 20 in the supporting chassis 14. Therefore, when the detaching member 57 is rotated in the direction in which the lifting members 59 and 59 move upward, the flange 56a is lifted by the lifting members 59 and 59, causing the chucking pulley 56 to move upward.

(k) Base Chassis

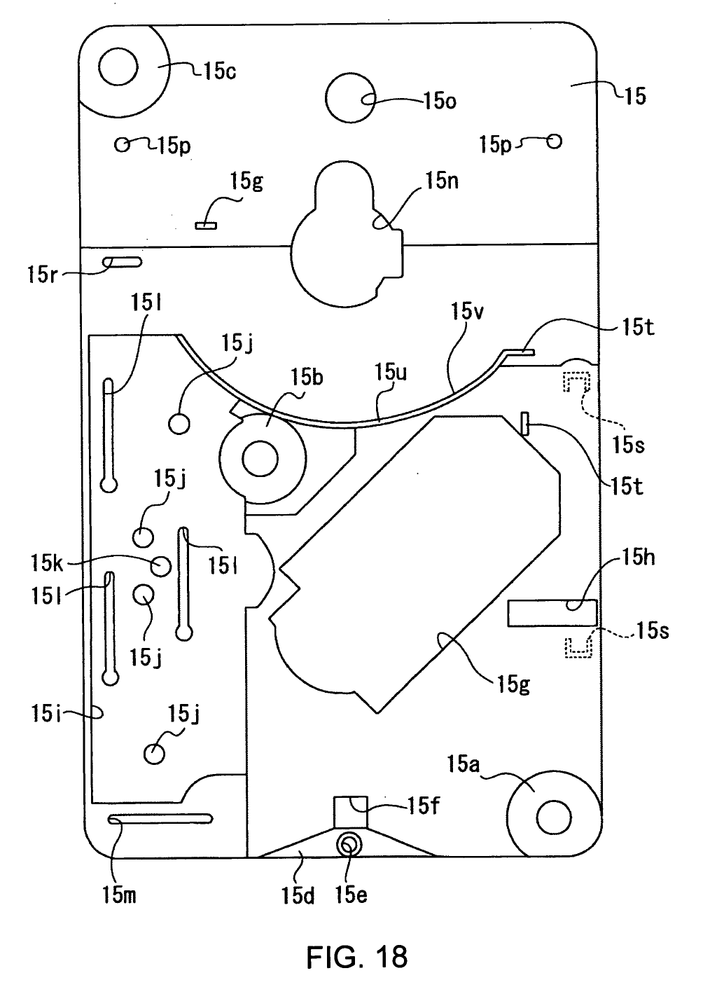

The base chassis 15 has a substantially rectangular shape that is longer than is wide in plan view, and has motor mounting portions 15a, 15b, and 15c at the front end, the central portion in the forward/backward direction, and the back end, respectively (see FIG. 18). The motor mounting portions 15a, 15b, and 15c have respective shaft mounting holes.

A clearance recess 15d extending forwardly and upwardly is formed in the central portion in the horizontal direction of the front end of the base chassis 15. A pin insertion hole 15e extending vertically is formed in the clearance recess 15d. A light transmission hole 15f is formed in the base chassis 15 so as to be immediately behind the pin insertion hole 15e.

A large pickup disposing hole 15g is formed in the front half portion of the base chassis 15. A lever insertion hole 15h is formed to the right of the pickup disposing hole 15g.

A disposing recess 15i, which is longer than is wide and opens upward, is formed in the left end of the front half portion of the base chassis 15. Four supporting shafts 15j which are spaced apart in substantially the forward/backward direction are formed in the bottom surface of the disposing recess 15i. A gear supporting shaft 15k is formed between the middle supporting shafts 15j and 15j. Pin supporting holes 15l, 15l, and 15l, which are long in the forward/backward direction, are formed in predetermined locations of the bottom surface of the disposing recess 15i.

A guide slit 15m, which is long in the horizontal direction, is formed in front of the disposing recess 15i in the base chassis 15.

Gear disposing holes 15n and 15o, which are spaced from each other in the forward/backward direction, are formed in the central portion in the horizontal direction of the back half of the base chassis 15.

Guide shafts 15p and 15p are formed towards the back end of the base chassis 15 so as to protrude upward from the left and right ends of the base chassis 15.

A spring supporting protrusion 15q is formed in the base chassis 15 so as to be disposed in front of the left guide shaft 15p. A guide hole 15r, which is long in the horizontal direction, is formed in front of the spring supporting protrusion 15q.

Shaft bearing portions 15s and 15s are formed in the right end of the lower surface of the base chassis 15 so as to be spaced apart in the forward/backward direction, and have U shapes whose open sides face each other.

Disc guides 15t and 15t, which are spaced apart in the forward/backward direction and which protrude upward, are formed towards the right end of the upper surface of the base chassis 15 so as to be disposed behind the pickup disposing hole 15g.

An arc-shaped dislodging preventing portion 15u is formed in the base chassis 15 so as to be disposed immediately behind the pickup disposing hole 15g, and comprises an upwardly protruding wall. The base chassis 15 has an arc-shaped surface which is formed continuously with the lower side of the dislodging preventing portion 15u and faces backwards. This surface is formed as a dislodging preventing portion 15v.

(1) Mode Producing Drive Mechanism

A mode producing drive mechanism for producing five operation modes (described later) is disposed at the lower surface of the base chassis 15, and operates by drive force of a mode motor 61.

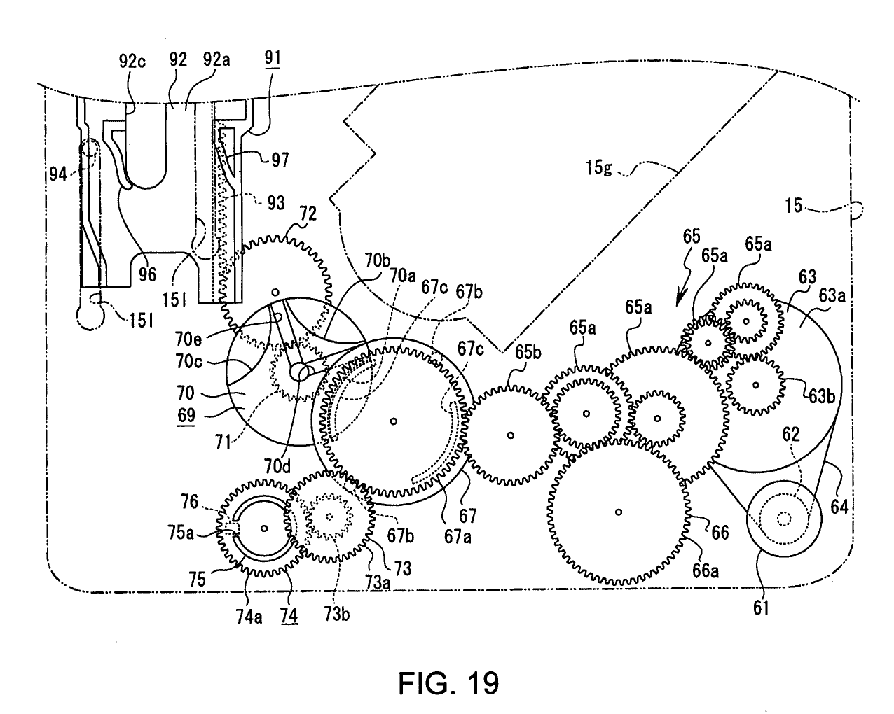

The mode motor 61 is mounted to the motor mounting portion 15a of the base chassis 15 (see FIG. 8). The shaft of the mode motor 61 protrudes downward from a shaft insertion hole. A small pulley 62 is secured to the shaft of the mode motor 61 (see FIG. 19).

A pulley gear 63 is supported at the lower surface of the base chassis 15, and comprise a pulley portion 63a and a geared portion 63b, which are coaxially integrally formed (see FIG. 19). A transmission belt 64 is wound between the pulley portion 63a and the small pulley 62.

A gear group 65 is supported at the front end of the lower surface of the base chassis 15, and comprises a plurality of step gears 65a functioning as reduction gears and one connecting gear 65b (see FIG. 19). The rightmost step gear 65a engages the geared portion 63b of the pulley gear 63. The leftmost step gear 65a engages the connecting gear 65b.

One step gear 65a of the gear group 65 engages a geared portion 66a of a rotary encoder 66 supported at the lower surface of the base chassis 15 (see FIG. 19). The rotary encoder 66 detects the amount of rotation of the mode motor 61 from its amount of rotation. Therefore, the rotation of the mode motor 61 is controlled based on the detection of the amount of rotation of the mode motor 61 by the rotary encoder 66 in order to set each operation mode described below.

A cam 67 is rotatably supported at the front end of the lower surface of the base chassis 15 (see FIG. 19).

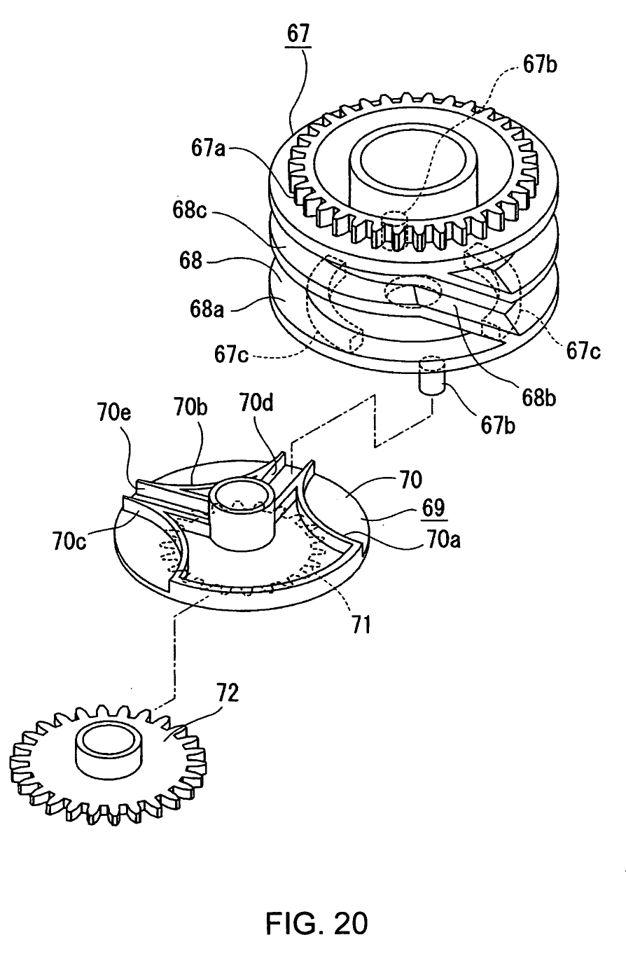

The cam 67 has a substantially cylindrical shape, and has a geared portion 67a formed at the upper end thereof (see FIGS. 20 to 22). Operating pins 67b and 67b protrude downward from the lower surface of the cam 67, and are disposed on opposite sides of the cam 67 serving as a center so as to be spaced 180 degrees apart from each other at the outer peripheral edge of the lower surface of the cam 67. Arc-shaped ribs 67c and 67c are formed at the lower surface of the cam 67 with the rotary shaft of the cam 67 serving as a center. The ribs 67c and 67c are disposed on opposite sides of the rotary shaft of the cam 67 serving as a center and between the-operating pins 67b and 67b so as to be spaced 180 degrees apart from each other.

A groove 68 is formed in the peripheral surface of the cam 67, and comprises a lower horizontal portion 68a, an inclined portion 68b, and an upper horizontal portion 68c. The lower horizontal portion 68a is long in a peripheral direction. The inclined portion 68b is formed continuously with the lower horizontal portion 68a and inclines upward as it extends away from the lower horizontal portion 68a. The upper horizontal portion 68c is formed continuously with the inclined portion 68b and is long in the peripheral direction.

The geared portion 67a of the cam 67 engages the connecting gear 65b of the gear group 65 (see FIG. 19).

A Geneva driven gear 69 is rotatably supported at a location near the cam 67 of the lower surface of the base chassis 15 (see FIGS. 19 to 21). In the Geneva driven gear 69, an upwardly disposed cam 70 and a gear 71 disposed under the cam 70 are integrally formed (see FIGS. 19 and 20).

The cam 70 is substantially disc-shaped, and has arc-shaped walls 70a, 70b, and 70c at the upper surface thereof. Both ends of the walls 70a, 70b, and 70c are continuously formed with the outer peripheral edge of the cam 70, and their central portions are disposed closest to the center of the cam 70. The walls 70a, 70b, and 70c are spaced at an equal interval from each other in the peripheral direction of the cam 70. Operation grooves 70d and 70e are formed between adjacent walls 70a, 70b and 70c, have linear forms that extend in radial directions of the cam 67 and that are perpendicular to each other, and open in the peripheral directions of the cam 70.

When the cam 67 is rotated, one of the ribs 67c slides along the inner side of any one of the walls 70a, 70b, and 70c of the Geneva driven gear 69. At this time, the Geneva driven gear 69 does not rotate. Next, one of the operating pins 67b is inserted into either one of the operation grooves 70d and 70e of the Geneva driven gear 69. When one of the operating pins 67b is inserted into either one of the operation grooves 70d and 70e, the rotation of the cam 67 causes the operating pin 67b to push a wall defining either one of the operation grooves 70d and 70e in order to rotate the Geneva driven gear 69. At this time, the operating pin 67b reciprocates in either the operation groove 70d or the operation groove 70e, causing the Geneva driven gear 69 to rotate through an angle of 90 degrees.

The Geneva driven gear 69 does not rotate when the rib 67c slides along the inner side of any one of the walls 70a, 70b, and 70c, whereas it rotates intermittently through an angle of 90 degrees each time by the rotation of the cam 67 when either one of the operating pins 67b and 67b is inserted into either one of the operation grooves 70d and 70e.

A connecting gear 72 is supported at the lower surface of the base chassis 15, and engages the geared portion 71 of the Geneva gear 69 (see FIGS. 19 and 20).

When the mode motor 61 rotates, its driving force is transmitted to the cam 67 via the small pulley 62, the transmission belt 64, the pulley gear 63, and the gear group 65. This causes the cam 67 to rotate in a direction corresponding to the direction of rotation of the mode motor 61. When the cam 67 rotates, as described above, the Geneva driven gear 69 is intermittently rotated. The rotation of the Geneva driven gear 69 causes the connecting gear 72 to rotate.

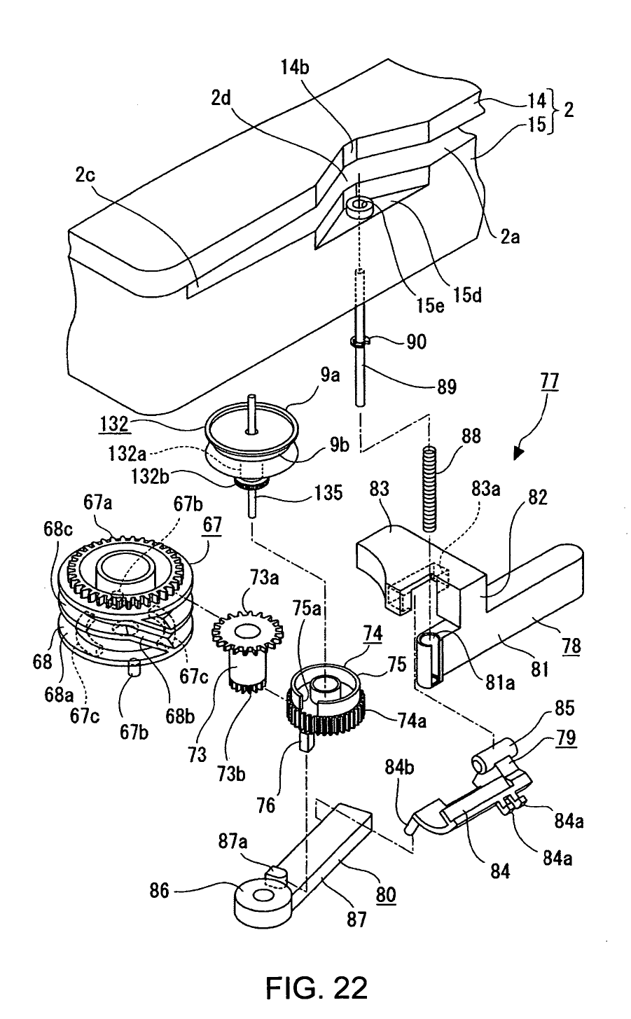

A two-speed gear 73 is supported at the front end of the lower surface of the base chassis 15, and has a large-diameter portion 73a and a small-diameter portion 73b, which are coaxially formed (see FIGS. 19 and 22). The large-diameter portion 73a of the two-speed gear 73 engages the geared portion 67a of the cam 67.

An operating gear 74 is supported at the front end of the lower surface of the base chassis 15 (see FIGS. 19 and 22). The operating gear 74 has a geared portion 74a along its peripheral surface and a restricting wall 75 extending in the peripheral direction at the upper surface thereof. An insertion cut portion 75a is formed between both edges of the restricting wall 75 in the peripheral direction. A downwardly protruding pushing pin 76 is formed at the outer peripheral edge of the lower surface of the operating gear 74, and is disposed directly below the insertion cut portion 75a.

The geared portion 74a of the operating gear 74 engages the small-diameter portion 73b of the two-speed gear 73, and is rotated by the rotation of the cam 67 through the two-speed gear 73.

(m) Insertion Restricting Means

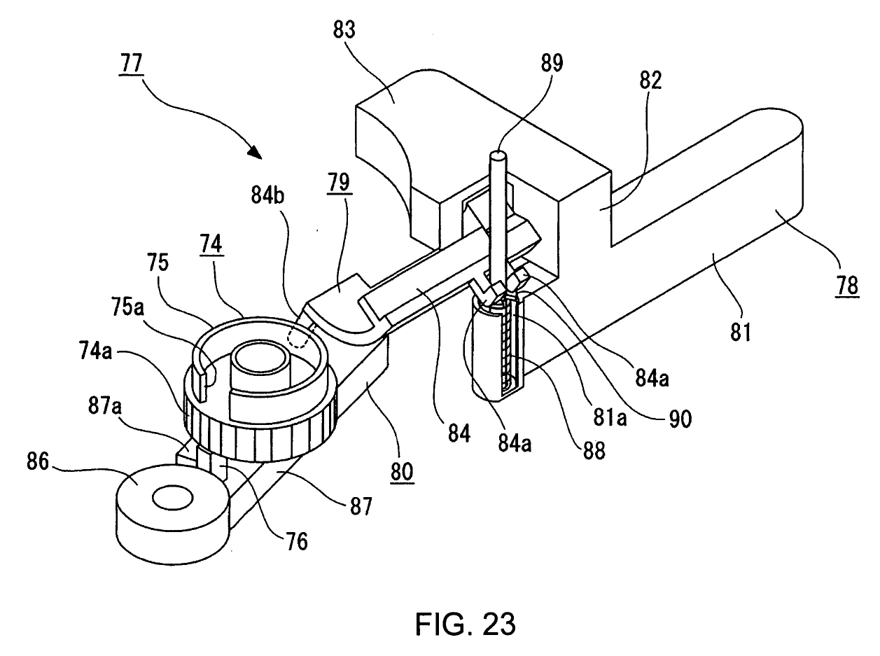

Insertion restricting means 77 is disposed at the front end of the lower surface of the base chassis 15 (see FIGS. 22 and 23). The insertion restricting means 77 comprises a holding member 78, a restricting lever 79, and an operating lever 80.

The holding member 78 comprises a holding portion 81, which is long in the horizontal direction, a connecting portion 82, which protrudes upwards from a leftward position of the holding portion 81, and a supporting protrusion 83, which protrudes backwards from the upper end of the connecting portion 82. A holding recess 81a is formed in the left end of the holding portion 81 so as to open upward. A supporting groove 83a is formed in the front end of the supporting protrusion 83 so as to be long sideways and to open downwards.

The holding member 78 is mounted to the lower surface of the base chassis 15 so that the holding portion 81 is disposed along the front surface of the base chassis 15.

In the restricting lever 79, a main portion 84, which has a shape that is long sideways, and a support shaft 85, which is disposed at the right end of the main portion 84 and which is long sideways, are integrally formed. Engaging protrusions 84a and 84a, which protrude substantially forwardly, are disposed towards the right end of the main portion 84, and are slightly spaced from each other in the horizontal direction. A push pin 84b, which protrudes substantially downward, is formed at the left end of the main portion 84a.

In the restricting lever 79, the support shaft 85 is inserted in and supported at the supporting groove 83a of the holding member 78, the engaging protrusions 84a and 84a move substantially vertically with respect to the holding member 78, and the push pin 84b is rotatable in a substantially forward/backward direction of movement.

In the operating lever 80, a support cylindrical portion 86 which has an axial direction corresponding to the vertical direction and a lever protrusion 87 which is long in the substantially horizontal direction and which protrudes substantially rightwards from the support cylindrical portion 86, are integrally formed. A push protrusion 87a is disposed at a location towards the left end of the lever protrusion 87 so as to protrude upwards.

In the operating lever 80, the support cylindrical portion 86 is supported at a location towards the left end of the lower surface of the base chassis 15. An end of the lever protrusion 87 is rotatable in the substantially forward/backward direction of movement.

When the restricting lever 79 and the operating lever 80 are supported as described above, the push pin 84b of the restricting lever 79 is disposed close to or in contact with the back side of an end of the lever protrusion 87 of the operating lever 80 (see FIG. 23). In the operating lever 80, the push protrusion 87a is disposed close to or in contact with the back side of the push pin 76 of the operating gear 74 (see FIG. 23).

A compression spring 88 is inserted in and held at the holding recess 81a of the holding member 78 (see FIGS. 22 and 23).

When the compression spring 88 is held at the holding recess 81a, a restricting pin 89 is inserted in the holding recess 81a (FIGS. 22 and 23). A stopper ring 90 is secured to substantially the central portion of the restricting pin 89 in the axial direction thereof. The restricting pin 89 is inserted in the holding recess 81a so that its lower portion extending from the stopper ring 90 is disposed in the compression spring 88. When it is inserted in the holding recess 81a, the restricting pin 89 is biased upwards by the compression spring 88 being in elastic contact with the stopper ring 90 from therebelow.

When the compression spring 88 and the restricting pin 89 are inserted in the holding recess 81a of the holding member 78, the portion of the restricting pin 89 extending above the stopper ring 90 is inserted between the engaging protrusions 84a and 84a of the restricting lever 79. Therefore, the engaging protrusions 84a and 84a engage the stopper ring 90 from thereabove, and restrict the upward movement of the restricting pin 89.

The portion of the restricting pin 89 protruding upward from the holding recess 81a is inserted into the pin insertion hole 15e formed in the front end of the base chassis 15 from therebelow, so that at least the upper side of the restricting pin 89 protrudes upward from the pin insertion hole 15e.

As described above, when the operating gear 74 is rotated by the rotation of the cam 67 by the mode motor 61, causing the pushing pin 76 to move closer to the push protrusion 87a of the operating lever 80, the push protrusion 87a is pushed backwards by the push pin 76. When the push protrusion 87a is pushed backwards by the pushing pin 76, the operating lever 80 rotates, causing the push pin 84b of the restricting lever 79 to be pushed backwards by the lever protrusion 87. When the push pin 84b is pushed backwards, the restricting lever 79 is rotated, so that the engaging protrusions 84a and 84a push the stopper ring 90 downwards, causing the restricting pin 89 to move downward against the biasing force of the compression spring 88.

In contrast, when the operating gear 74 is rotated in the direction in which the push pin 76 moves away from the push protrusion 87a of the operating lever 80, the pushing operation performed by the pushing pin 76 with respect to the push protrusion 87a and the pushing operation performed by the lever protrusion 87 with respect to the push pin 84b are cancelled. Therefore, the restricting pin 89 moves upward by the elastic force of the compression spring 88, so that the restricting lever 79 rotates in the direction in which the engaging protrusions 84a and 84a move substantially upwards.

(n) Mode Slider

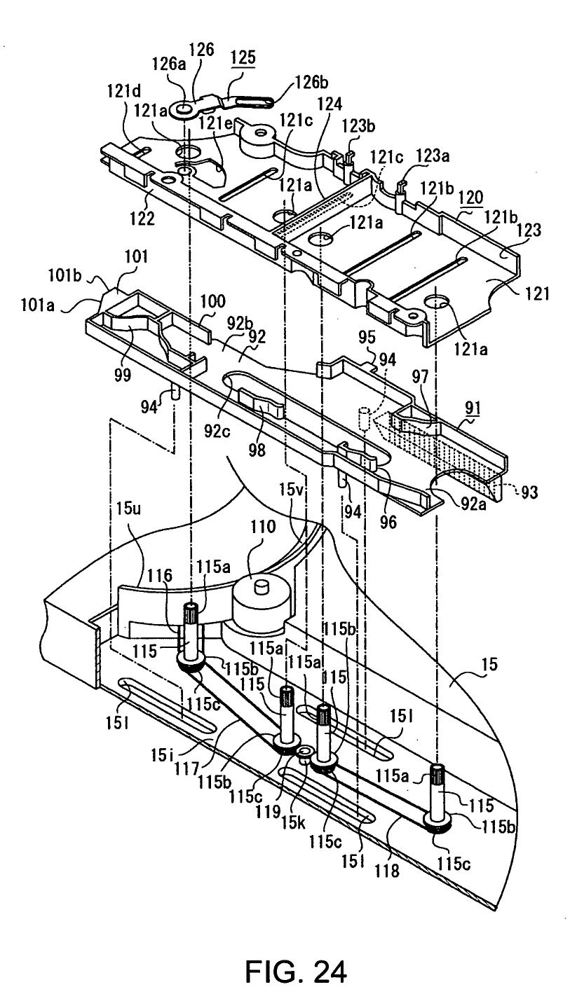

A mode slider 91 is disposed in the disposing recess 15i of the base chassis 15 so as to be movable in the forward/backward direction (see FIG. 24).

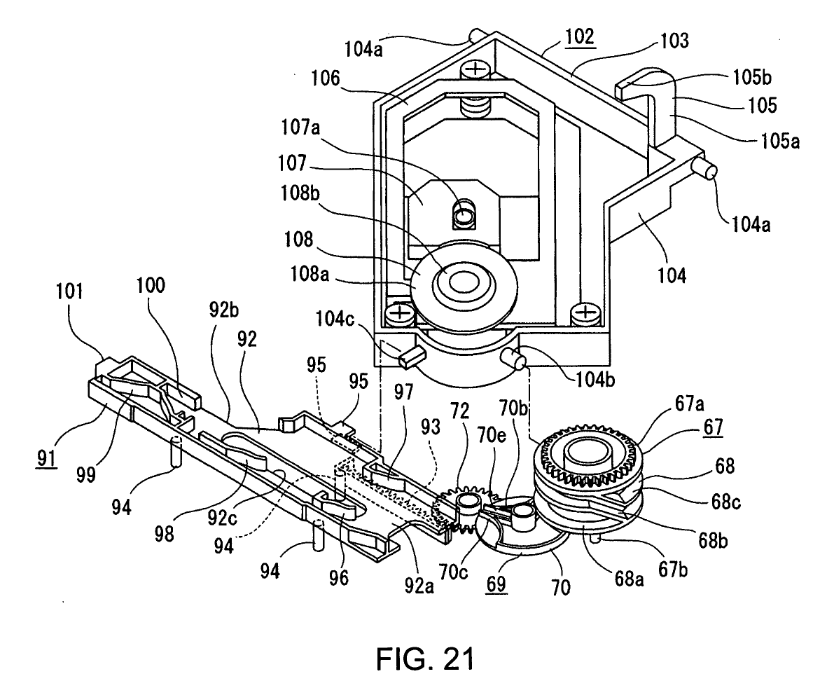

The mode slider 91 has a shape that is longer than is wide, and each part is integrally formed with a flat principal portion 92 (see FIGS. 21, 24, and 25). In the principal portion 92, the width of a front half portion 92a is slightly larger than the width of a back half portion 92b in the horizontal direction, with the right end portion of the front half portion 92a extending further rightward than the back half portion 92b. A clearance opening 92c, which is long in the forward/backward direction, is formed in the principal portion 92.

A rack 93 is formed in the front half portion 92a of the principal portion 92 so as to extend in the forward/backward direction at a location towards the right end of the lower surface of the front half portion 92a. The teeth of the rack 93 face rightwards. Downwardly protruding guide shafts 94, 94, and 94 are disposed at respective predetermined locations of the lower surface of the principal portion 92.

Rightward protruding supporting protrusions 95 and 95 are disposed at the right edge of the front half portion 92a of the principal portion 92 so as to be vertically spaced from each other.

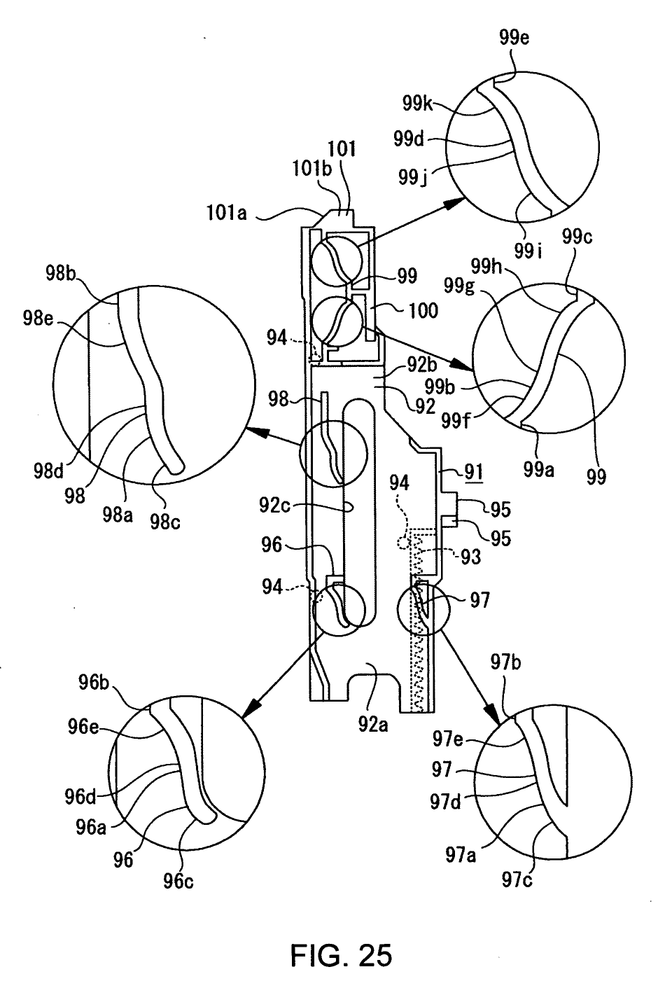

A first cam wall 96 is disposed at the leftward position of the forward end portion of the upper surface of the front half portion 92a. The first cam wall 96 has an inclined portion 96a inclining leftwards as it extends backwards and a linear portion 96b formed continuously with the back end of the inclined portion 96a and extending forwards and backwards. The inclined portion 96a has three substantially equally divided and smoothly curved portions in the forward/backward direction, that is, a front portion 96c, an intermediate portion 96d, and a back portion 96e (see the enlarged view of FIG. 25). The front portion 96c is formed so that its inclination angle becomes smaller as it extends backwards. The intermediate portion 96d is formed so that its inclination angle provides a gentle incline. The back portion 96e is formed so that its inclination angle becomes larger as it extends backwards.

At the back end portion of the upper surface of the front half portion 92a, a second cam wall 97 is disposed to the right of the first cam wall 96. The second cam wall 97 has an inclined portion 97a inclining leftwards as it extends backwards and a linear portion 97b formed continuously with the back end of the inclined portion 97a and extending in the forward/backward direction. Similarly to the inclined portion 96a of the first cam wall 96, the inclined portion 97a has smoothly curved portions, that is a front portion 97c, an intermediate portion 97d, and a back portion 97e. The front portion 97c is formed so that its inclination angle becomes smaller as it extends backwards. The intermediate portion 97d is formed so that its inclination angle provides a gentle incline. The back portion 97e is formed so that its inclination angle becomes larger as it extends backwards (see the enlarged view of FIG. 25).

At the back end portion of the upper surface of the front half portion 92a, a third cam wall 98 is disposed behind the first cam wall 96. The third cam wall 98 has an inclined portion 98a inclining leftwards as it extends backwards and a linear portion 98b formed continuously with the back end of the inclined portion 98a and extending in the forward/backward direction. Similarly to the inclined portion 96a of the first cam wall 96, the inclined portion 98a has smoothly curved portions, that is, a front portion 98c, an intermediate portion 98b, and a back portion 98e. The front portion 98c is formed so that its inclination angle becomes smaller as it extends backwards. The intermediate portion 98d is formed so that its inclination angle provides a gentle incline. The back portion 98e is formed so that its inclination angle becomes larger as it extends backwards (see the enlarged view of FIG. 25).

At the upper surface of the back half portion 92b of the principal portion 92, a fourth cam wall 99 is disposed behind the third cam wall 98. The fourth cam wall 99 has a front linear portion 99a extending in the forward/backward direction, a front inclined portion 99b formed continuously with the back end of the front linear portion 99a and inclining rightwards as it extends backwards, an intermediate linear portion 99c formed continuously with the back end of the front inclined portion 99b and extending in the forward/backward direction, a back inclined portion 99d formed continuously with the back end of the intermediate linear portion 99c and inclining leftwards as it extends backwards, and a back linear portion 99e formed continuously with the back end of the back inclined portion 99d and extending in the forward/backward direction (see the enlarged view of FIG. 25).

The front inclined portion 99b of the fourth cam wall 99 has three substantially equally divided and smoothly curved portions in the forward/backward direction, that is, a front portion 99f, an intermediate portion 99g, and a back portion 99h (see the enlarged view of FIG. 25). The front portion 99f is formed so that its inclination angle becomes smaller as it extends backwards. The intermediate portion 99g is formed so that its inclination angle provides a gentle incline. The back portion 99h is formed so that its inclination angle becomes larger as it extends backwards.

The back inclined portion 99d of the fourth cam wall 99 has three substantially equally divided and smoothly curved portions in the forward/backward direction, that is, a front portion 99i, an intermediate portion 99j, and a back portion 99k (see the enlarged view of FIG. 25). The front portion 99i is formed so that its inclination angle becomes smaller as it extends backwards. The intermediate portion 99j is formed so that its inclination angle provides a gentle incline. The back portion 99k is formed so that its inclination angle becomes larger as it extends backwards.

A pushing rib 100 extending in the forward/backward direction is disposed at the right end of the upper surface of the back half portion 92b of the principal portion 92.

A backwardly protruding cam protrusion 101 is disposed at the back end of the principal portion 92, and has an inclined surface 101a inclining backwards as it extends rightwards and a vertical surface 101b formed continuously with the right end of the inclined surface 101a and extending backwards.

The mode slider 91 is supported by the base chassis 15 so as to be movable forwards and backwards by slidably engaging the guide shafts 94, 94, and 94 in respective supporting holes 15l, 15l, and 15l formed in the disposing recess 15i.

(o) Base Unit

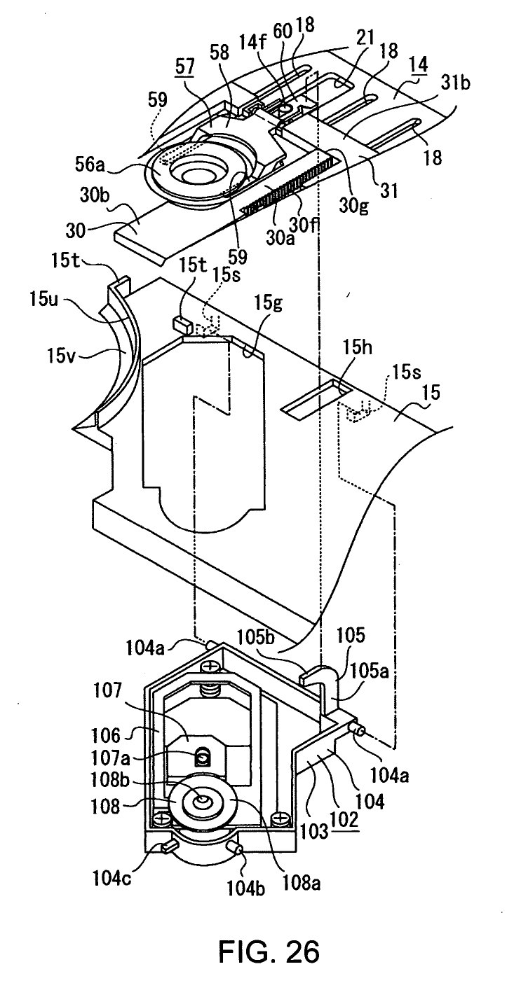

A base unit 102 is rotatably disposed in the pickup disposing hole 15g of the base chassis 15 (see FIGS. 8 and 26). Each portion of the base unit 102 is mounted to a supporting case 103 (see FIGS. 21 and 26).

The supporting case 103 comprises a frame 104 and an engaging lever 105 protruding upward from the right end of the frame 104. A forwardly protruding support shaft 104a and a backwardly protruding support shaft 104a are disposed at the right end of the frame 104 so as to be spaced apart from each other in the forward/backward direction. An outwardly protruding cam protruding pin 104b and an outwardly protruding support portion 104c are disposed at the left end of the frame 104 so as to be spaced apart from each other in the forward/backward direction.

A supporting base 106 is mounted to the frame 104 of the supporting case 103. An optical pickup 107 for reproducing an information signal from a disc-shaped recording medium 200 is disposed at the supporting base 106. The optical pickup 107 has an objective lens 107a. The disc-shaped recording medium 200 is irradiated with a laser beam through the objective lens 107a.

The engaging lever 105 has a protrusion 105a extending continuously with and vertically from the frame 104 and an engaging portion 105b protruding leftwards from the upper end of the protrusion 105a.

A spindle motor (not shown) is mounted to the supporting base 106. A disc table 108 is secured to the shaft of the spindle motor. The disc table 108 has a disc-shaped table body 108a and a centering protrusion 108b protruding upward from the central portion of the table body 108a and having a magnet (not shown) buried therein. Along with the chucking pulley 56 and the optical pickup 107, the disc table 108 is used in the reproducing unit 3 in order to reproduce an information signal from the disc-shaped recording medium 200.

The base unit 102 is supported by inserting the support shafts 104a and 104a at the supporting case 103 in the respective shaft bearing portions 15s and 15s formed at the right end of the base chassis 15 (see FIG. 26), and is rotatable substantially in the vertical movement directions of the disc table 108 and on the support shafts 104a and 104a serving as fulcra.

When the base unit 102 is rotatably supported at the base chassis 15, the upper end of the engaging lever 105 protrudes upward from the lever insertion hole 15h of the base chassis 15 (see FIG. 8).

When the base unit 102 is rotatably supported at the base chassis 15, the cam protruding pin 104b at the supporting case 103 slidably engages the groove 68 of the cam 67 (see FIG. 21). When the cam protruding pin 104b engages an upper horizontal portion 68a defining the groove 68, the support portion 104c is disposed at a height allowing its insertion between the supporting protrusions 95 and 95 of the mode slider 91 (see FIG. 21).

The base unit 102 rotates on the support shafts 104a and 104a as fulcra with respect to the base chassis 15 by changing the location of engagement of the cam protruding pin 104b with respect to the groove 68 by rotating the cam 67.

(p) Disc Sensor

At the base chassis 15, a disc sensor 109 is disposed under the light transmission hole 15f formed in the front end of the base chassis 15. The disc sensor 109 is, for example, an optical sensor, and operates to determine whether or not there is a disc-shaped recording medium 200 by emitting detection light upward through the light transmission hole 15f.

(q) Transportation Drive Unit

A transportation drive unit has a drive section for rotating each of the feed rollers 9a, 9c, 9e, 9g, 9i, and 9k disposed in the first transporting means 6, and operates by drive force of a drive motor 110.

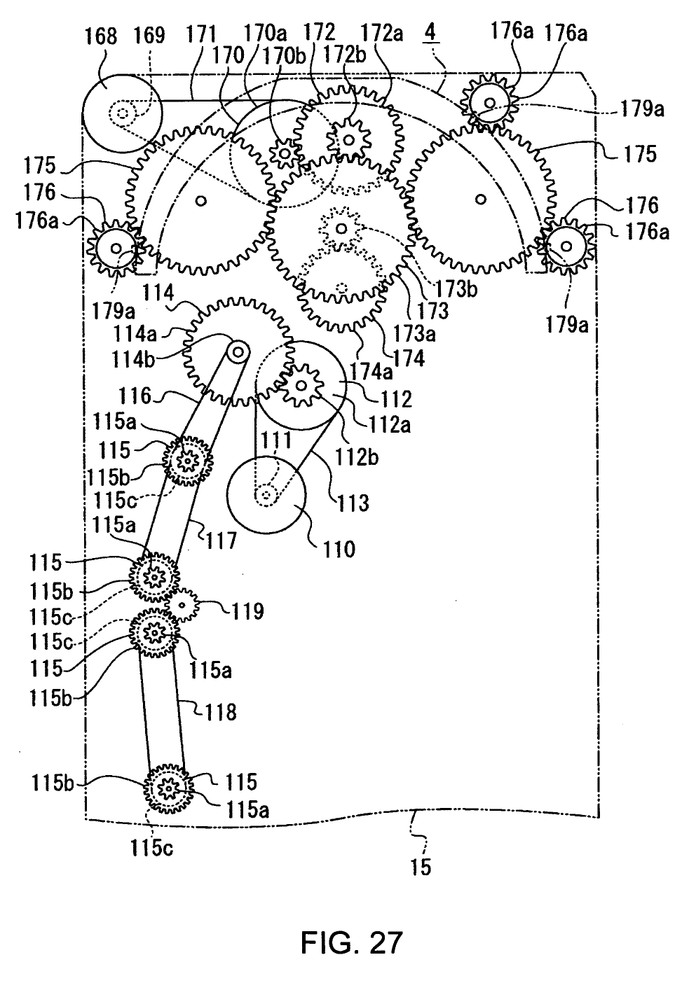

The drive motor 110 is mounted to the motor mounting portion 15b formed at the central portion of the base chassis 15 (see FIGS. 8 and 27). The shaft of the drive motor 110 protrudes downward from a shaft insertion hole. A small-diameter pulley 111 is secured to the shaft of the drive motor 110 (see FIG. 27).

A pulley 112 with a gear is supported at the lower surface of the base chassis 15, and comprises a pulley body 112a and a geared portion 112b, which are coaxially integrally formed. A belt 113 is wound between the pulley body 112a and the small-diameter pulley 111.

A feed gear 114 is supported near the pulley 112 with the gear disposed at the lower surface of the base chassis 15, and comprises a large geared portion 114a and a small geared portion 114b, which are coaxially formed. The large geared portion 114a engages the geared portion 112b of the pulley 112 with the gear.

Fulcra gears 115 are supported at the four supporting shafts 15j disposed at the disposing recess 15i of the base chassis 15 (see FIGS. 24 and 27), and are vertically elongated. Each fulcra gear 115 has a first geared portion 115a, a second geared portion 115b, and a third geared portion 115c, which are coaxially formed from the upper side in that order. The diameter of each third geared portion 115c is larger than the diameter of each first geared portion 115a, and is smaller than the diameter of each second geared portion 115b.

Of the fulcra gears 115, the two fulcra gears 115 and 115 in the middle have their first geared portions 115a and 115a protruding upward from the clearance opening 92c of the mode slider 91, and the two fulcra gears 115 and 115 at the front and the back are disposed away from the path of movement of the mode slider 91.

Of the four fulcra gears 115, the rearmost fulcrum gear 115 is such that a first timing belt 116 is wound between the lower half portion of its third geared portion 115c and the small-geared portion 114b of the feed gear 114. A second timing belt 117 is wound between the upper half portion of the third geared portion 115c of the rearmost fulcrum gear 115 and the third geared portion 115c of the second fulcrum gear 115 from the back. A third timing belt 118 is wound between the third geared portions 115c and 115c of the two front fulcra gears 115 and 115.

A synchronous gear 119 is supported at the gear supporting shaft 15k disposed at the disposing recess 15i of the base chassis 15, and engage the second geared portions 115b and 115b of the two middle fulcra gears 115 and 115.

When the drive motor 110 is rotated, its drive force is transmitted to the fulcra gears 115 through the small-diameter pulley 111, the belt 113, the pulley 112 with the gear, the feed gear 114, the first timing belt 116, the second timing belt 117, the synchronous gear 119, and the third timing belt 118, causing the fulcra gears 115 to rotate in synchronism in accordance with the direction of rotation of the drive motor 110.

(r) Subchassis

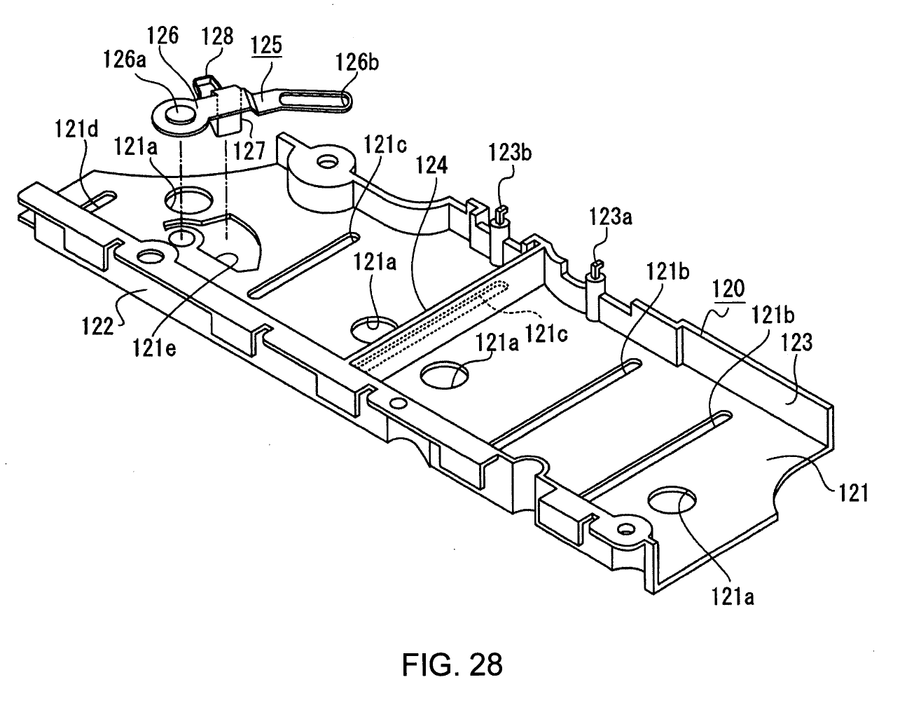

A subchassis 120 is mounted to the disposing recess 15i of the base chassis 15 so as to cover the mode slider 91 (see FIGS. 8 and 24). The subchassis 120 is longer than is wide, and has an upwardly facing and flat support surface 121, left and right surfaces 122 and 123 that are formed in a standing manner from the left and right edges of the support surface 121, and a partition wall 124 formed in a standing manner from the central portion of the support surface 121 in the forward/backward direction (see FIG. 28). These portions of the subchassis 120 are integrally formed.

Four gear insertion holes 121a are formed in the support surface 121 of the subchassis 120 so as to be spaced apart from each other in the forward/backward direction. The support surface 121 has guide slits 121b and 121b, guide slits 121c and 121c, and a guide slit 121d. The slits 121b and 121b are long in the leftward/rightward direction and are formed so as to be in front of the partition wall 124 and spaced apart from each other in the forward/backward direction. The guide slits 121c and 121c are long in the leftward/rightward direction and are formed so as to be behind the partition wall 124 and spaced apart from each other in the forward/backward direction. The guide slit 121d extends leftwards and rightwards at the back end of the support surface 121. A lever disposing opening 121e is formed in the support surface 121 so as to be disposed between the guide slit 121d and the back guide slit 121c.

Spring holding protrusions 123a and 123b are formed in the upper side of the right surface 123 of the subchassis 120 so as to be disposed at the front and back of the partition wall 124.

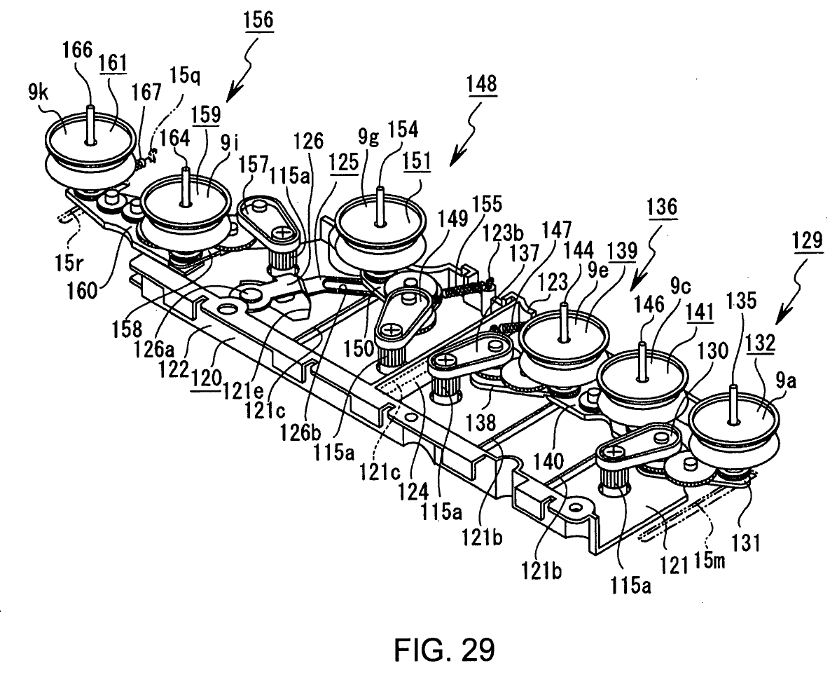

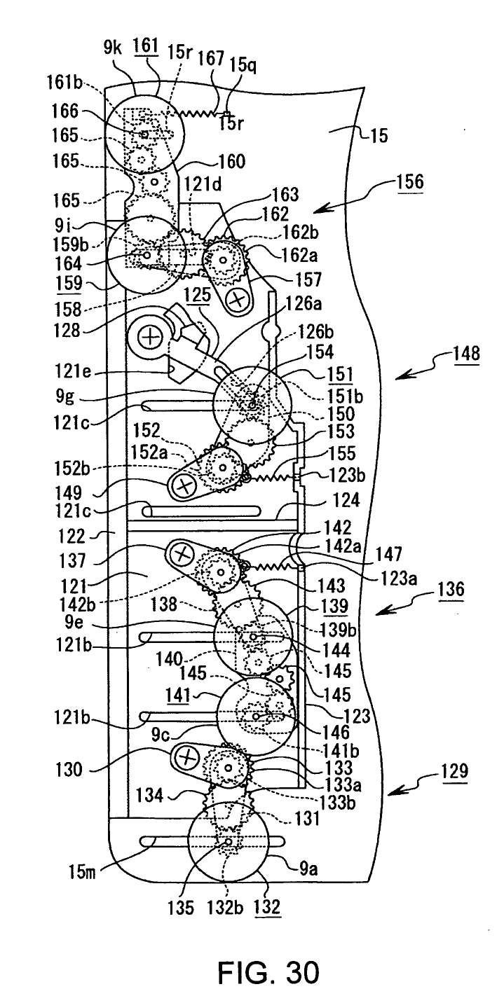

When the subchassis 120 is mounted to the disposing recess 15i, the first geared portions 115a of the respective fulcra gears 115 protrude upwards from the respective gear insertion holes 121a (see FIGS. 29 and 30).

An operating lever 125 is rotatably supported on a portion immediately to the left of the lever disposing hole 121e, serving as a fulcrum, in the support surface 121 of the subchassis 120 (see FIGS. 28 and 29).

In the operating lever 125, a lever body 126, a connecting portion 127, and an operation portion 128 are integrally formed. The lever body 126 is long in substantially one direction. The connecting portion 127 protrudes downwards from one edge of the lever body 126. The operation portion 128 protrudes from the connecting portion 127 in a direction opposite to the location of the lever body 126. The lever body 126 has a rotary supporting portion 126a at one end thereof and a supporting hole 126b at the other end thereof so as to be long in the direction of extension of the lever body 126.

The operating lever 125 is rotatable on the rotary supporting portion 126a serving as a fulcrum with respect to the subchassis 120. When the operating lever 125 is supported by the subchassis 120, the operation portion 128 is disposed below the support surface 121 via the lever disposing opening 121e.

(s) Rotary mechanisms

A first rotary mechanism 129 is supported at the front fulcrum gear 115 among the fulcra gears 115 disposed at the disposing recess 15i of the base chassis 15 (see FIGS. 29 and 30). The first rotary mechanism 129 comprises a rotary member 130, a rotary lever 131, and a first rotary member 132 (see FIGS. 29 to 31).

The rotary member 130 is long in one direction, and is supported on the fulcrum gear 115 with one end of the rotary member 130 serving as a fulcrum.

The rotary lever 131 is long in one direction, and is supported at the lower side of the other end of the rotary member 130 with one end of the rotary lever 131 serving as a fulcra. A first transmission gear 133 and a second transmission gear 134 are supported at the upper surface of the rotary lever 131. The first transmission gear 133 is disposed as a reduction gear and has a large-diameter geared portion 133a and a small-diameter geared portion 133b, which are coaxially integrally formed. The large-diameter geared portion 133a engages the first geared portion 115a of the fulcrum gear 115, and the small-diameter geared portion 133b engages the second transmission gear 134.

The first rotary member 132 comprises a flat substantially cylindrical first feed roller 9a, a shaft 132a protruding downward from the central portion of the lower surface of the first feed roller 9a, and a geared portion 132b disposed at the lower end of the shaft 132a. A holding groove 9b is formed in the entire periphery of the first feed roller 9a.

The first rotary member 132 is supported at the upper surface of the rotary lever 131 through a supporting shaft 135 passing through the central portion of the first rotary member 132. The geared portion 132b engages the second transmission gear 134.

The supporting shaft 135 is secured to the other end of the rotary lever 131 so that the lower end portion thereof protrudes downwards from the rotary lever 131. The lower end portion of the supporting shaft 135 slidably engages the guide slit 15m formed in the front end of the base chassis 15. Therefore, the first rotary member 132 is movable towards the left and right by being guided by the guide slit 15m.

When the first rotary mechanism 129 is supported by the fulcrum gear 115, the rotary member 130 and the rotary lever 131 are supported at an angle such that a protrusion is formed in the substantially rightward direction (see FIG. 30).

In the first rotary mechanism 129, when the fulcrum gear 115 is rotated by the transmission of the drive force of the drive motor 110 as described above, the drive force of the drive motor 110 is transmitted to the first transmission gear 133, the second transmission gear 134, and the geared portion 132b in that order, causing the first feed roller 9a to rotate in a direction corresponding to the direction of rotation of the fulcrum gear 115. At this time, a torque is generated at the rotary lever 131 in a direction corresponding to the direction of rotation of the fulcrum gear 115 and to the relationship between the position of the rotary member 130 and the rotary lever 131. Based on the torque, a leftward or a rightward moving force is applied to the first feed roller 9a.

A second rotary mechanism 136 is supported at the second fulcrum gear 115 from the front (see FIGS. 29 and 30). The second rotary mechanism 136 comprises a rotary member 137, a first rotary lever 138, a third rotary member 139, a second rotary lever 140, and a second rotary member 141 (see FIGS. 29 to 31).

The rotary member 137 is long in one direction, and is supported on the fulcrum gear 115 with one end of the rotary member 137 serving as a fulcrum.

The first rotary lever 138 is long in one direction, and is supported at the lower surface of the other end of the rotary member 137 with one end of the first rotary lever 138 serving as a fulcrum. A first transmission gear 142 and a second transmission gear 143 are supported at the upper surface of the first rotary lever 138. The first transmission gear 142 is disposed as a reduction gear and has a large-diameter geared portion 142a and a small-diameter geared portion 142b, which are coaxially integrally formed. The large-diameter geared portion 142a engages the first geared portion 115a of the fulcrum gear 115, and the small-diameter geared portion 142b engages the second transmission gear 143.

The third rotary member 139 comprises a flat substantially cylindrical third feed roller 9e, a shaft 139a protruding downward from the central portion of the lower surface of the third feed roller 9e, and a geared portion 139b disposed at the lower end of the shaft 139a. A holding groove 9f is formed in the entire periphery of the third feed roller 9e.

The third rotary member 139 is supported at the upper surface of the first rotary lever 138 through a supporting shaft 144 passing through the central portion of the third rotary member 139. The geared portion 139b engages the second transmission gear 143.

The second rotary lever 140 is long in one direction, and is supported at the lower surface of the other end of the first rotary lever 138 with one end portion of the second rotary lever 140 serving as a fulcrum. Third transmission gears 145, 145, and 145 being successively engaged are supported at the upper surface of the second rotary lever 140.

The second rotary member 141 comprises a flat substantially cylindrical second feed roller 9c, a shaft 141a protruding downward from the central portion of the lower surface of the second feed roller 9c, and a geared portion 141b disposed at the lower end of the shaft 141a. A holding groove 9d is formed in the entire periphery of the second feed roller 9c.

The second rotary member 141 is supported at the upper surface of the second rotary lever 140 through a supporting shaft 146 passing through the central portion of the second rotary member 141. The geared portion 141b engages one third transmission gear 145.

The supporting shaft 144, which supports the third rotary member 139, is secured to the other end of the first rotary lever 138 so that the lower end portion thereof protrudes downwards from the second rotary lever 140. The lower end portion of the supporting shaft 144 slidably engages the second guide slit 121b from the front of the subchassis 120. Therefore, the third rotary member 139 is movable towards the left and right by being guided by the guide slit 121b.

The supporting shaft 146, which supports the second rotary member 141, is secured to the other end of the second rotary lever 140 so that the lower end portion thereof protrudes downwards from the second rotary lever 140. The lower end portion of the supporting shaft 146 slidably engages the front guide slit 121b of the subchassis 120. Therefore, the second rotary member 141 is movable towards the left and right by being guided by the guide slit 121b.

A biasing spring 147 is tightly stretched between the rotary member 137 and the spring holding protrusion 123a of the subchassis 120. The biasing spring 147 may be, for example, a tensile spring, and biases the second rotary mechanism 136 rightwards.

When the second rotary mechanism 136 is supported by the fulcrum gear 115, the rotary member 137 and the first and second rotary levers 138 and 140 are supported at an angle such that a protrusion is formed in the substantially rightward direction (see FIG. 30).

In the second rotary mechanism 136, when the fulcrum gear 115 is rotated by the transmission of the drive force of the drive motor 110 as described above, the drive force of the drive motor 110 is transmitted to the first transmission gear 142, the second transmission gear 143, the geared portion 139b, the third transmission gears 145, 145, and 145, and the geared portion 141b in that order, causing the third feed roller 9e and the second feed roller 9c to rotate in a direction corresponding to the direction of rotation of the fulcrum gear 115. At this time, a torque is generated at the first rotary lever 138 and the second rotary lever 140 in a direction corresponding to the direction of rotation of the fulcrum gear 115 and to the relationship between the positions of the rotary member 137 and the first and second rotary levers 138 and 140. Based on the torque, a leftward or a rightward moving force is applied to the third feed roller 9e and the second feed roller 9c.

A third rotary mechanism 148 is supported at the third fulcrum gear 115 from the front (see FIGS. 29 and 30). The third rotary mechanism 148 comprises a rotary member 149, a rotary lever 15o, and a fourth rotary member 151 (see FIGS. 29 to 31).

The rotary member 149 is long in one direction, and is supported on the fulcrum gear 115 with one end of the rotary member 149 serving as a fulcrum.

The rotary lever 150 is substantially triangular, and is supported at the lower surface of the other end of the rotary member 149 with one corner of the rotary lever 150 serving as a fulcrum. A first transmission gear 152 and a second transmission gear 153 are supported at the upper surface of the rotary lever 150. The first transmission gear 152 is disposed as a reduction gear and has a large-diameter geared portion 152a and a small-diameter geared portion 152b, which are coaxially integrally formed. The large-diameter geared portion 152a engages the first geared portion 115a of the fulcrum gear 115, and the small-diameter geared portion 152b engages the second transmission gear 153.

The fourth rotary member 151 comprises a flat substantially cylindrical fourth feed roller 9g, a shaft 151a protruding downward from the central portion of the lower surface of the fourth feed roller 9g, and a geared portion 151b disposed at the lower end of the shaft 151a. A holding groove 9h is formed in the entire periphery of the fourth feed roller 9g.

The fourth rotary member 151 is supported at the upper surface of the rotary lever 150 through a supporting shaft 154 passing through the central portion of the fourth rotary member 151. The geared portion 151b engages the second transmission gear 153.

The supporting shaft 154 is secured to a corner that is different from the aforementioned corner of the rotary lever 150 so that the lower end portion thereof protrudes downwards from the rotary lever 150. The lower end portion of the supporting shaft 154 slidably engages the supporting hole 126b of the operating lever 125 supported at the subchassis 120 and the back guide slit 121c of the subchassis 120. Therefore, the fourth rotary member 151 is movable towards the left and right by being guided by the guide slit 121c.

A biasing spring 155 is tightly stretched between the rotary member 149 and the spring holding protrusion 123b of the subchassis 120. The biasing spring 155 may be, for example, a tensile spring, and biases the third rotary mechanism 148 rightwards.

When the third rotary mechanism 148 is supported by the fulcrum gear 115, the rotary member 149 and the rotary lever 150 are supported at an angle such that a protrusion is formed in the substantially rightward direction (see FIG. 30).

In the third rotary mechanism 148, when the fulcrum gear 115 is rotated by the transmission of the drive force of the drive motor 110 as described above, the drive force of the drive motor 110 is transmitted to the first transmission gear 152, the second transmission gear 153, and the geared portion 151b in that order, causing the fourth feed roller 9g to rotate in a direction corresponding to the direction of rotation of the fulcrum gear 115. At this time, a torque is generated at the rotary lever 150 in a direction corresponding to the direction of rotation of the fulcrum gear 115 and to the relationship between the position of the rotary member 149 and the position of the rotary lever 150. Based on the torque, a leftward or a rightward moving force is applied to the fourth feed roller 9g.

A fourth rotary mechanism 156 is supported at the rear fulcrum gear 115 (see FIGS. 29 and 30). The fourth rotary mechanism 156 comprises a rotary member 157, a first rotary lever 158, a fifth rotary member 159, a second rotary lever 160, and a sixth rotary member 161 (see FIGS. 29 to 31).

The rotary member 157 is long in one direction, and is supported on the fulcrum gear 115 with one end of the rotary member 157 serving as a fulcrum.

The first rotary lever 158 is long in one direction, and is supported at the lower surface of the other end of the rotary member 157 with one end of the first rotary lever 158 serving as a fulcrum. A first transmission gear 162 and a second transmission gear 163 are supported at the upper surface of the first rotary lever 158. The first transmission gear 162 is disposed as a reduction gear and has a large-diameter geared portion 162a and a small-diameter geared portion 162b, which are coaxially integrally formed. The large-diameter geared portion 162a engages the first geared portion 115a of the fulcrum gear 115, and the small-diameter geared portion 162b engages the second transmission gear 163.

The fifth rotary member 159 comprises a flat substantially cylindrical fifth feed roller 9i, a shaft 159a protruding downward from the central portion of the lower surface of the fifth feed roller 9i, and a geared portion 159b disposed at the lower end of the shaft 159a. A holding groove 9j is formed in the entire periphery of the fifth feed roller 9i.

The fifth rotary member 159 is supported at the upper surface of the first rotary lever 158 through a supporting shaft 164 passing through the central portion of the fifth rotary member 159. The geared portion 159b engages the second transmission gear 163.

The diameter of a portion of the fifth feed roller 9i that comes into contact with the outer peripheral surface of a disc-shaped recording medium 200 is slightly smaller than those of the rollers 9a, 9c, 9e, and 9g, and the feed members 10a, 10c, 10e, and 10g.

The second rotary lever 160 is long in one direction, and is supported at the lower surface of the other end of the first rotary lever 158 with one end portion of the second rotary lever 160 serving as a fulcrum. Third transmission gears 165, 165, and 165 being successively engaged are supported at the upper surface of the second rotary lever 160.

The sixth rotary member 161 comprises a flat substantially cylindrical sixth feed roller 9k, a shaft 161a protruding downward from the central portion of the lower surface of the sixth feed roller 9k, and a geared portion 161b disposed at the lower end of the shaft 161a. A holding groove 91 is formed in the entire periphery of the sixth feed roller 9k.

The sixth rotary member 161 is supported at the upper surface of the second rotary lever 160 through a supporting shaft 166 passing through the central portion of the sixth rotary member 161. The geared portion 161b engages one third transmission gear 165.

The supporting shaft 164, which supports the fifth rotary member 159, is secured to the other end of the first rotary lever 158 so that the lower end portion thereof protrudes downwards from the second rotary lever 160. The lower end portion of the supporting shaft 164 slidably engages the guide slit 121d that is the rearmost guide slit of the subchassis 120. Therefore, the fifth rotary member 159 is movable towards the left and right by being guided by the guide slit 121d.

The supporting shaft 166, which supports the sixth rotary member 161, is secured to the other end of the second rotary lever 160 so that the lower end portion thereof protrudes downwards from the second rotary lever 160. The lower end portion of the supporting shaft 166 slidably engages the guide slit 15r, disposed behind the subchassis 120, of the base chassis 15. Therefore, the sixth rotary member 161 is movable towards the left and right by being guided by the guide slit 15r.

A biasing spring 167 is tightly stretched between the rotary member 157 and the spring holding protrusion 15q disposed to the right of the guide slit 15r of the base chassis 15. The biasing spring 167 may be, for example, a tensile spring, and biases the fourth rotary mechanism 156 rightwards.

When the fourth rotary mechanism 156 is supported by the fulcrum gear 115, the rotary member 157 and the first rotary lever 158 and the second rotary lever 160 are supported in the form of a crank.

In the fourth rotary mechanism 156, when the fulcrum gear 115 is rotated by the transmission of the drive force of the drive motor 110 as described above, the drive force of the drive motor 110 is transmitted to the first transmission gear 162, the second transmission gear 163, the geared portion 159b, the third transmission gears 165, 165, and 165, and the geared portion 161b in that order, causing the fifth feed roller 9i and the sixth feed roller 9k to rotate in a direction corresponding to the direction of rotation of the fulcrum gear 115. At this time, a torque is generated at the first rotary lever 158 and the second rotary lever 160 in a direction corresponding to the direction of rotation of the fulcrum gear 115 and to the relationship between the positions of the rotary member 157, the first rotary lever 158, and the second rotary lever 160. Based on the torque, a leftward or a rightward moving force is applied to the fifth feed roller 9i and the sixth feed roller 9k.

For example, annular rubber members (not shown) are mounted to the holding grooves 9b, 9d, 9f, 9h, 9j, and 9l of the respective feed rollers 9a, 9c, 9e, 9g, 9i, and 9k. When they are pushed against the outer peripheral surface of a disc-shaped recording medium 200, a predetermined friction force is generated in order to prevent the feed rollers from sliding with respect to the outer peripheral surface of the disc-shaped recording medium 200.

As described above, the supporting shafts 144, 146, 154, and 164 are supported by being inserted in the respective guide slits 121b, 121b, 121c, and 121d of the subchassis 120. Therefore, by the subchassis 120, that is, by one member, the supporting shafts 144, 146, 154, and 164 are prevented from tilting and are positioned in the height direction of the feed rollers 9c, 9e, 9g, and 9i, thereby making it possible to prevent displacement in the height direction of the feed rollers and to reduce the number of parts.

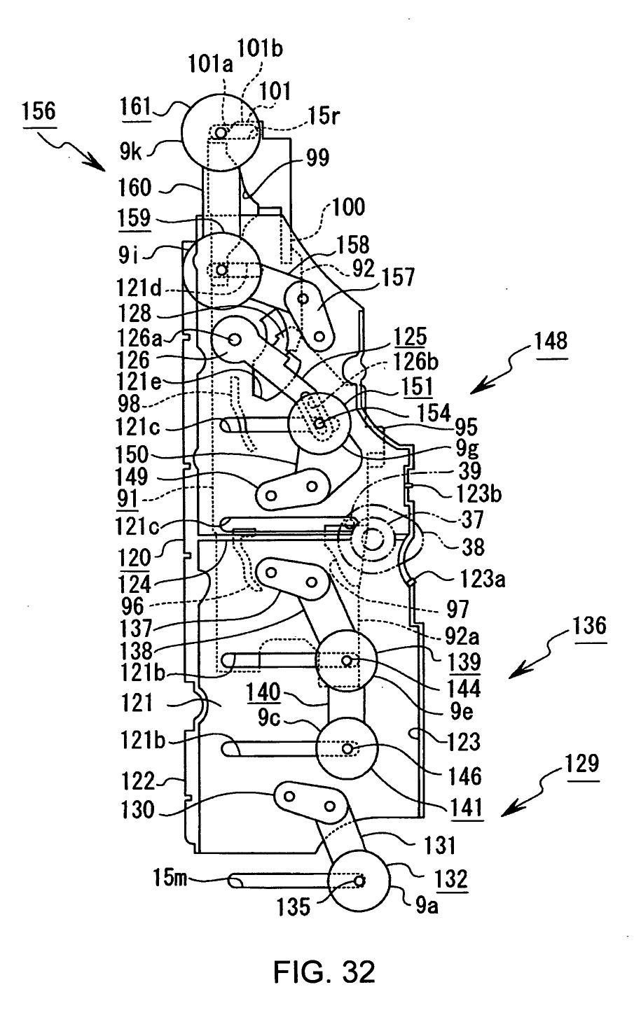

In the state in which the supporting shafts 144, 146, 154, and 164 are inserted in the respective guide slits 121b, 121b, 121c, and 121d of the subchassis 120 as mentioned above, when the mode slider 91 moves in the forward/backward direction, the first cam wall 96 or the second cam wall 97 is disposed at a location that allows it to come into sliding contact with the lower end of the supporting shaft 146, and the fourth cam wall 99 is at a location that allows it to come into sliding contact with the lower end of the supporting shaft 164 (see FIG. 32). When the mode slider 91 moves in the forward/backward direction, the pushing rib 100 is disposed at a location that allows it to come into sliding contact with the operation portion 128 of the operating lever 125 rotatably supported at the subchassis 120 (see FIG. 32).

As described above, the feed rollers 9a, 9c, 9e, 9g, 9i, and 9k are rotated by rotating the respective fulcra gears 115 at the same time by the drive force of the drive motor 110. Therefore, when the drive motor 110 is rotated, the feed rollers 9a, 9c, 9e, 9g, 9i, and 9k are rotated at the same time in accordance with the direction of rotation of the drive motor 110.

The feed rollers 9a, 9c, 9e, 9g, 9i, and 9k form the aforementioned first transporting means 6. The feed rollers 9a, 9c, 9e, 9g, 9i, and 9k and the feed members 10a, 10c, 10e, 10g, 10i, and 10k of the second transporting means 7 mounted to the sliding means 24, 29, 43, and 48 supported by the supporting chassis 14 serve as the aforementioned feeding means 8. The first transporting means 6 and the second transporting means 7 are components of the transporting mechanism 5.

(t) Stocker Ascending/Descending Mechanism

The stocker ascending/descending mechanism raises and lowers the stocker 4, and operates by drive force of an ascending/descending motor 168.

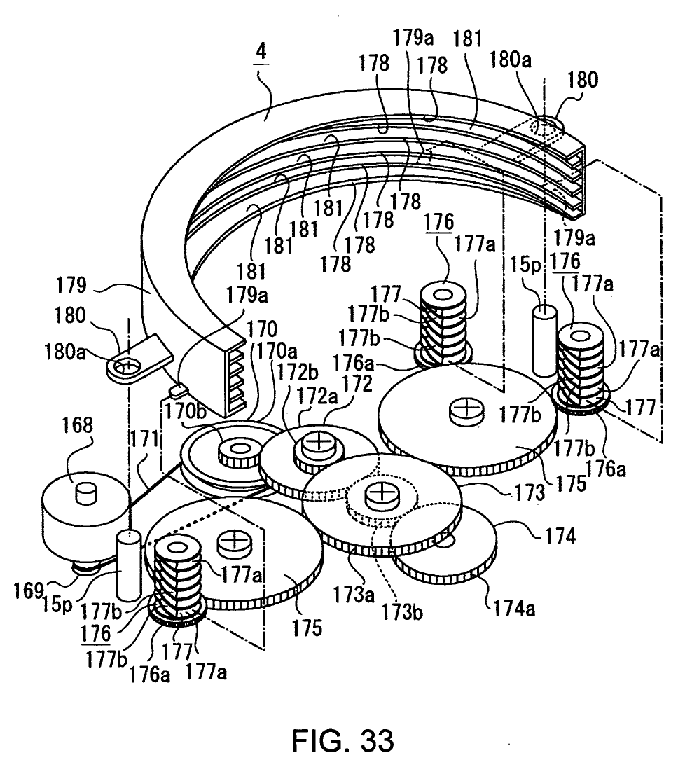

The ascending/descending motor 168 is mounted to the motor mounting portion 15c formed at the back end of the base chassis 15 (see FIGS. 7, 8, and 27). The shaft of the ascending/descending motor 168 protrudes downward from a shaft insertion hole. A pulley 169 is secured to the shaft of the ascending/descending motor 168 (see FIGS. 27 and 33).

A pulley 170 with a gear is supported at the lower surface of the base chassis 15, and has a pulley body 170a and a geared portion 170b, which are coaxially and integrally formed. A belt 171 is wound between the pulley body 170a and the pulley 169.

A coupling gear 172 is supported at the back end of the lower surface of the base chassis 15, and has a large-diameter portion 172a and a small-diameter portion 172b, which are coaxially integrally formed. The large-diameter portion 172a of the coupling gear 172 engages the geared portion 170b of the pulley 170 with the gear. The small-diameter portion 172b of the coupling gear 172 protrudes upwards from the rearwardly disposed gear disposing hole 15o of the base chassis 15.

An intermediate gear 173 is supported at the rearward location of the upper surface of the base chassis 15 so as to be disposed at substantially the central portion thereof in the leftward/rightward direction. The intermediate gear 173 has a large-diameter portion 173a and a small-diameter portion 173b, which are coaxially integrally formed. The large-diameter portion 173a engages the small-diameter portion 172b of the coupling gear 172. The small-diameter portion 173b of the intermediate gear 173 protrudes downwards from the forwardly disposed gear disposing hole 15n of the base chassis 15, and engages a geared portion 174a of a rotary encoder 174 supported at the lower surface of the base chassis 15. The rotary encoder 174 detects the amount of rotation of the ascending/descending motor 168 from its amount of rotation. Therefore, based on the detection of the amount of rotation of the ascending/descending motor 168 by the rotary encoder 174, the rotation of the ascending/descending motor 168 is controlled, so that the position of the stocker 4 in the height direction is set.

Synchronous flat gears 175 and 175 are supported at the rearward end location of the upper surface of the base chassis 15 so as to be disposed on the left and right sides of the intermediate gear 173, and engage the large-diameter portion 173a of the intermediate gear 173.

Rotary cams 176, 176, and 176 are supported at the left and right ends of the rear end portion or the rearward end portion of the base chassis 15 (see FIGS. 7, 8, 27, and 33).

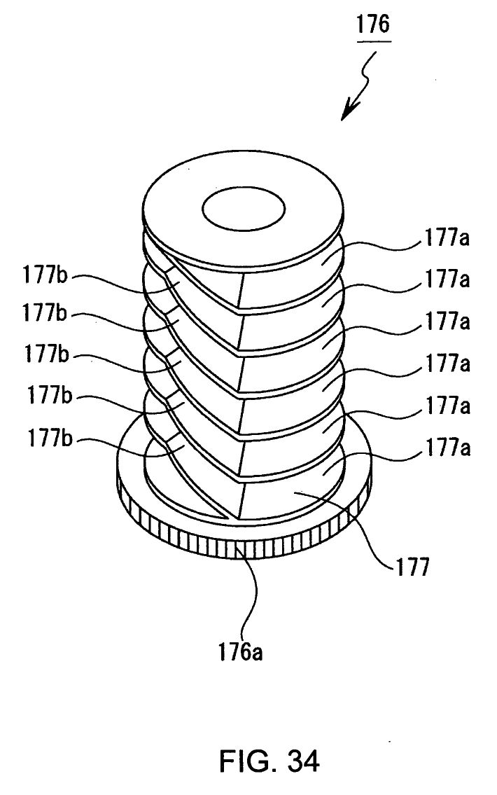

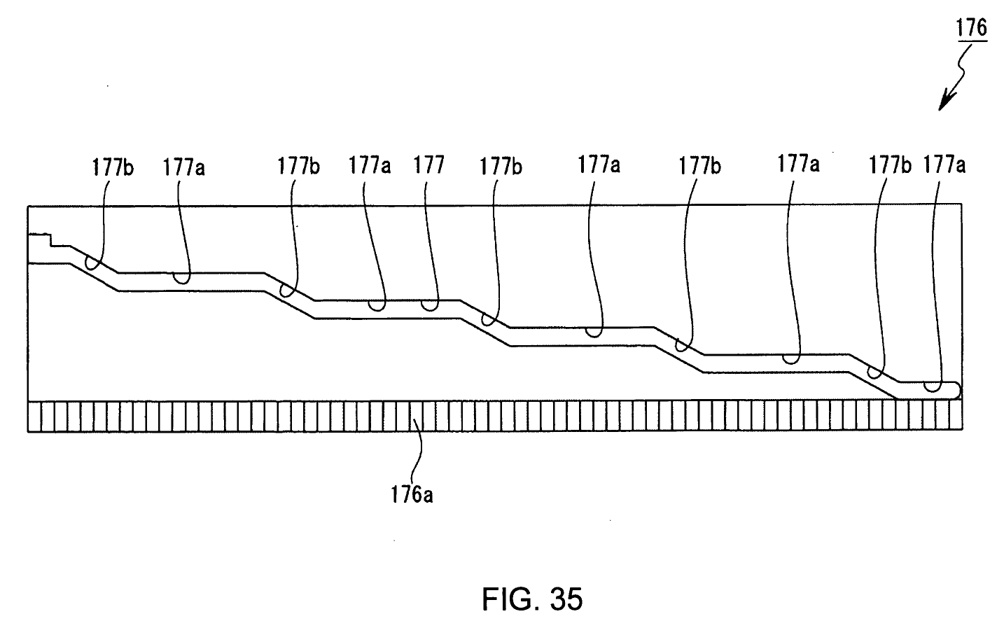

The rotary cams 176, 176, and 176 are substantially cylindrical and vertically long, and have respective geared portions 176a, 176a, and 176a disposed at the lower ends thereof (see FIG. 34). Grooves 177, 177, and 177 are formed along the peripheries of the respective rotary cams 176, 176, and 176. In the grooves 177, horizontal non-operating portions 177a and inclined operating portions 177b that connect the non-operating portions 177a are alternately formed (see FIGS. 34 and 35). The length of the non-operating portions 177a is greater than the length of the operating portions 177b, and equals to, for example, a length defined by a central angle equal to or greater than 180 degrees of the rotary cams 176.

The rotary cams 176, 176, and 176 are such that the geared portion 176a of the left rotary cam 176 engages the left synchronous flat gear 175, and the geared portions 176a and 176a of the two right rotary cams 176 and 176 engage the right synchronous flat gear 175.

(u) Stocker

The stocker 4 is supported at the guide shafts 15p and 15p disposed at the rearward end location of the base chassis 15 so that it can be raised and lowered (see FIGS. 7, 8, 27, and 33). In the stocker 4, substantially arc-shaped shelves 178 vertically separated from each other at an equal interval, a peripheral portion 179 disposed so as to connect the outer peripheral edges of the shelves 178, and guide portions 180 protruding in the leftward/rightward direction from the leftward and rightward end locations of the lower end of the peripheral portion 179 (see FIG. 33). Guide holes 180a and 180a are formed in ends of the respective guide portions 180 and 180.

The spaces between the shelves 178 of the stocker 4 are formed as disc accommodating portions 181 for accommodating large-diameter disc-shaped recording media 200a. Guide protrusions 179a, 179a, and 179a are disposed at the lower end of the peripheral portion 179 so as to be spaced apart from each other in the peripheral direction and so as to protrude outwards.

The stocker 4 is supported so that it can be raised and lowered by inserting the guide shafts 15p and 15p of the base chassis 15 in the guide holes 180a and 180a of the guide portions 180 and 180, respectively. When the stocker 4 is supported by the guide shafts 15p and 15p, the guide protrusions 179a, 179a, and 179a slidably engage the grooves 177, 177, and 177 of the rotary cams 176, 176, and 176, respectively.

When the ascending/descending motor 168 is rotated, its drive force is transmitted to the pulley 169, the belt 171, the pulley 170 with the gear, the coupling gear 172, the intermediate gear 173, the synchronous flat gears 175 and 175, and the rotary cams 176, 176, and 176 in that order, thereby causing the rotary cams 176, 176, and 176 to rotate in synchronism. When the rotary cams 176, 176, and 176 rotate in synchronism, the locations of the guide protrusions 179a, 179a, and 179a of the stocker 4 change with respect to the grooves 177, 177, and 177, so that the stocker 4 is moved upwards or downwards depending upon the direction of rotation of the rotary cams 176, 176, and 176.

(v) Structure of Housing

In this way, the supporting chassis 14 having each part disposed thereat is mounted to the base chassis 15 having each part disposed thereat from above the base chassis 15, thereby forming the housing 2 (see FIGS. 7 and 8). When the supporting chassis 14 is mounted to the base chassis 15, a space having a predetermined size is formed therebetween as a space for inserting and transporting disc-shaped recording media 200.

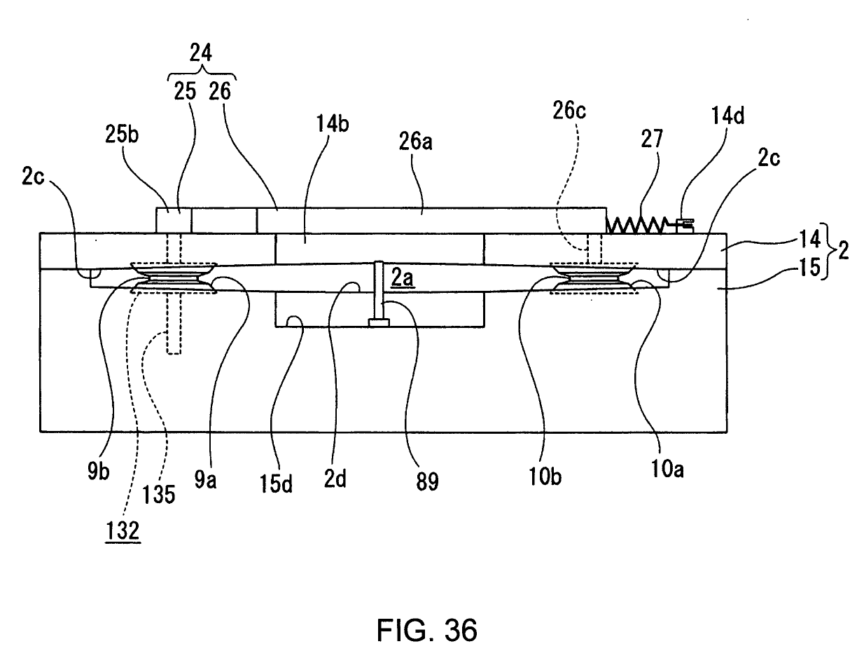

In the state in which the housing 2 is formed by mounting the supporting chassis 14 to the base chassis 15, the disc insertion slot 2a that is longer than is wide is formed in the front surface of the housing 2 (see FIGS. 7 and 36). The vertical width of the disc insertion slot 2a is smallest at left and right end portions 2c and 2c, becomes gradually larger towards a center 2d in the leftward/rightward direction from the left and right end portions 2c and 2c, and is largest at the center 2d. The vertical width of the left and right end portions 2c and 2c defining the disc insertion slot 2a is less than twice the thickness of a disc-shaped recording medium 200.

Ordinarily, a disc-shaped recording medium 200 is inserted into the disc insertion slot 2a from its central portion. As described above, since the width at the center 2d is largest, the disc-shaped recording medium 200 can be properly inserted. Since the vertical width of the left and right end portions 2c and 2c defining the disc insertion slot 2a is less than twice the thickness of the disc-shaped recording medium 200, it is possible to prevent insertion of a plurality of stacked disc-shaped recording media 200, so that the disc-shaped recording media 200 can be correctly inserted into the disc insertion slot 2a.

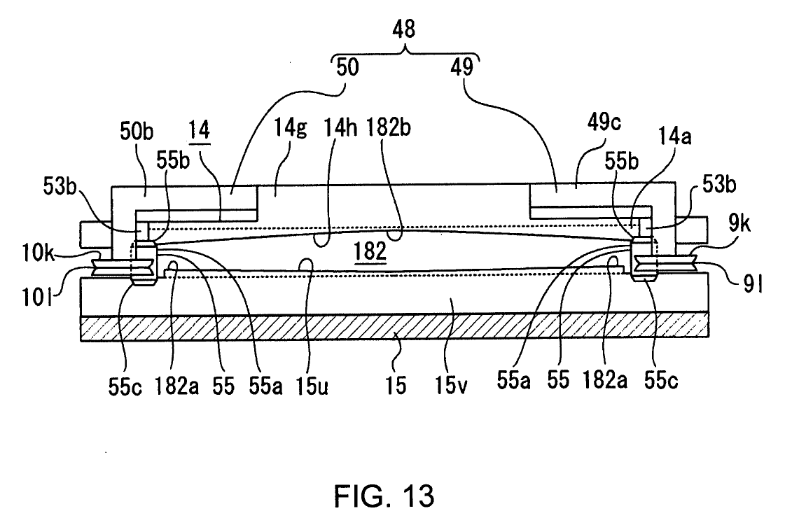

In the state in which the housing 2 is formed by mounting the supporting chassis 14 to the base chassis 15, the dislodging preventing portion 14h of the supporting chassis 14 and the dislodging preventing portion 15u of the base chassis 15 are vertically spaced apart, so that a disc passage 182, which is longer than is wide, is formed between them (see FIG. 13). The shape and size of the disc passage 182 are substantially the same as those of the disc insertion slot 2a. Its vertical width is smallest at left and right end portions 182a and 182a, becomes gradually larger towards a center 182b in the leftward/rightward direction from the left and right end portions 182a and 182a, and is largest at the center 182b. The vertical width of the left and right end portions 182a and 182a defining the disc passage 182 is less than twice the thickness of a disc-shaped recording medium 200.

As described later, even if, for example, an attempt is made to transport a plurality of stacked disc-shaped recording media due to malfunctioning of, for example, a microcomputer towards the reproducing unit 3 from the stocker 4, since the vertical width of the left and right end portions 182a and 182a defining the disc passage 182 is less than twice the thickness of a disc-shaped recording medium 200, it is possible to prevent the transportation of the plurality of stacked disc-shaped recording media 200, so that a disc-shaped recording medium 200 can be properly inserted into the disc passage 182.

When the housing 2 is formed, the supporting shaft 135 supporting the first rotary member 132 of the first rotary mechanism 129 is rotatably supported by the supporting cylindrical portion 25c of the drive slider 25 of the first sliding means 24. The supporting shafts 146 and 144 supporting the respective second rotary member 141 and third rotary member 139 of the second rotary mechanism 136 are rotatably supported by the supporting cylindrical portions 30d and 30d of the drive slider 30 of the second sliding means 29, respectively. The supporting shaft 154 supporting the fourth rotary member 151 of the third rotary mechanism 148 is rotatably supported by the supporting cylindrical portion 44c of the drive slider 44 of the fourth sliding means 43. The supporting shafts 164 and 166 of the respective fifth rotary member 159 and sixth rotary member 161 of the fourth rotary mechanism 156 are rotatably supported by the supporting cylindrical portions 49d and 49d of the drive slider 49 of the fifth sliding means 48, respectively.

In this way, when the supporting shafts 146, 144, 154, 164, and 166 are rotatably supported by the respective supporting cylindrical portions 30d, 30d, 44c, 49d, and 49d, the springs 32, 46, and 51 supported by the respective sliders 31, 44, and 49 apply rightward tensile forces to the upper ends of the supporting shafts 146, 144, 154, 164, and 166. Since rightward tensile forces are applied to the rotary members 137, 149, and 157 of the respective rotary mechanisms 136, 148, and 156, by the biasing springs 147, 155, and 167, it is possible prevent the supporting shafts 146, 144, 154, 164, and 166 from tilting with respect to the subchassis 120 or the base chassis 15.

When the housing 2 is formed, the lower end of the guide shaft 39 mounted to the first slider 35 of the third sliding means 34 is inserted in the forwardly disposed guide slit 121c formed in the central portion of the subchassis 120 in the forward/backward direction. When the lower end of the guide shaft 39 is inserted in the guide slit 121c, the third cam wall 98 of the mode slider 91 can slidably contact the lower end of the guide shaft 39.

When the housing 2 is formed, the engaging lever 105 of the supporting case 103 of the base unit 102 protrudes upward from the insertion hole 21 of the supporting chassis 14, and the engaging portion 105b engages the upper side of the operation portion 60 of the detaching member 57 supported at the upper surface of the supporting chassis 14 (see FIGS. 7 and 36). Therefore, when the base unit 102 is rotated in the direction of upward movement of the disc table 108, the detaching member 57 is rotated in the direction of downward movement of the lifting portions 59 and 59, thereby moving the chucking pulley 56 downwards by its own weight. In contrast, when the base unit 102 is rotated in the direction of downward movement of the disc table 108, the detaching member 57 is rotated in the direction of upward movement of the lifting portions 59 and 59, so that the flange 56a is lifted, thereby moving the chucking pulley 56 upward.

(4) Operation of the Disc Loading Device

Hereunder, the operation of the disc loading device 1 will be described (see FIGS. 37 to 95).

In the disc loading device 1, a disc-shaped recording medium 200 is transported while it is nipped between the feed rollers 9 and the feed members 10.

(a) Condition of Transportation

First, the conditions of the feed rollers 9 and feed members 10 required for transporting a disc-shaped recording medium 200 will be described (see FIG. 37).

The springs 27, 32, 46, and 51 supported at the respective sliding means 24, 29, 43, and 48 push the feed rollers 9 and the feed members 10 against the outer peripheral surface of the disc-shaped recording medium 200 in order to transport the disc-shaped recording medium 200 by transferring it between the feed rollers 9 and the feed members 10, which are spaced from each other in the direction of transportation.

When the force of each spring is X, the friction coefficient between the feed rollers (feed members) and the disc-shaped recording medium is μ, and the vertical drag exerted upon the feed rollers by the disc-shaped recording medium is N, the conditional expression Xsin θ=μN is established. Here, when a line segment passing through a center P of the disc-shaped recording medium and extending in a transportation direction S is L1, θ is an angle formed by a line segment L2 perpendicular to the line segment L1 and passing through the center P and a line segment L3 joining the center P and a rotational center Q of the feed rollers (the angle θ is hereunder referred to as “contact angle”). Since N=Xcos θ, Xsin θ=μXcosθ is established, and becomes sin θ=μcos θ, so that μ=tan θ. Therefore, the larger the contact angle θ, the larger the friction coefficient μ must be. Consequently, the feed rollers tend to slide with respect to the disc-shaped recording medium.

As described above, whether or not the feed rollers slide with respect to the disc-shaped recording medium does not depend upon the spring force X, but depends upon the friction coefficient μ. Therefore, in order to reliably transport the disc-shaped recording medium, the contact angle θ should be as small as possible. When the disc-shaped recording medium is transferred from a feed roller and a feed member to the next feed roller and feed member, it is desirable that the next feed roller and feed member be separated by the maximum distance possible, and, thus, be disposed at a large distance from the line segment L1 extending along the transportation direction S.

When the disc-shaped recording medium is being transported, the spring force X is a load with respect to the transportation because the feed rollers and the respective feed members move away from each other against the spring force X until the centers of the feed rollers and the respective feed members are aligned with the line segment L2. After the centers of the feed rollers and the respective feed members are aligned with the line segment L2, the spring force X causes the feed rollers and the respective feed members to move toward each other so as to help the transportation.

(b) Five Operation Modes

In the disc loading device 1, five operation modes are set for the following operations.

The five operation modes are a transportation mode, an ascending/descending mode, an accommodation/take-out mode, a chucking mode, and a disc holding canceling mode. The transportation mode is set when a disc-shaped recording medium 200a or a disc-shaped recording medium 200b is to be transported between the disc insertion slot 2a and the reproducing unit 3. The ascending/descending mode is set when the stocker 4 is to be raised or lowered. The accommodation/take-out mode is set when the disc-shaped recording medium 200a is to be transported between the reproducing unit 3 and the stocker 4. The chucking mode is set when the disc-shaped recording medium 200a or the disc-shaped recording medium 200b transported to the reproducing unit 3 is to be chucked or unchucked. The disc holding canceling mode is set when the holding of the chucked disc-shaped recording medium 200a or disc-shaped recording medium 200b by the feed rollers 9 and feed members 10 is to be cancelled.

(c) Transportation Mode

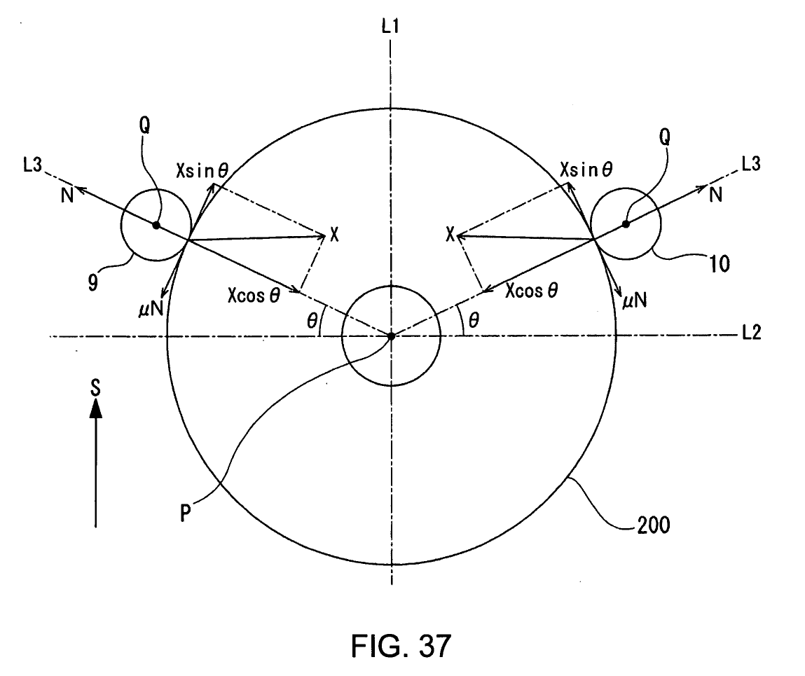

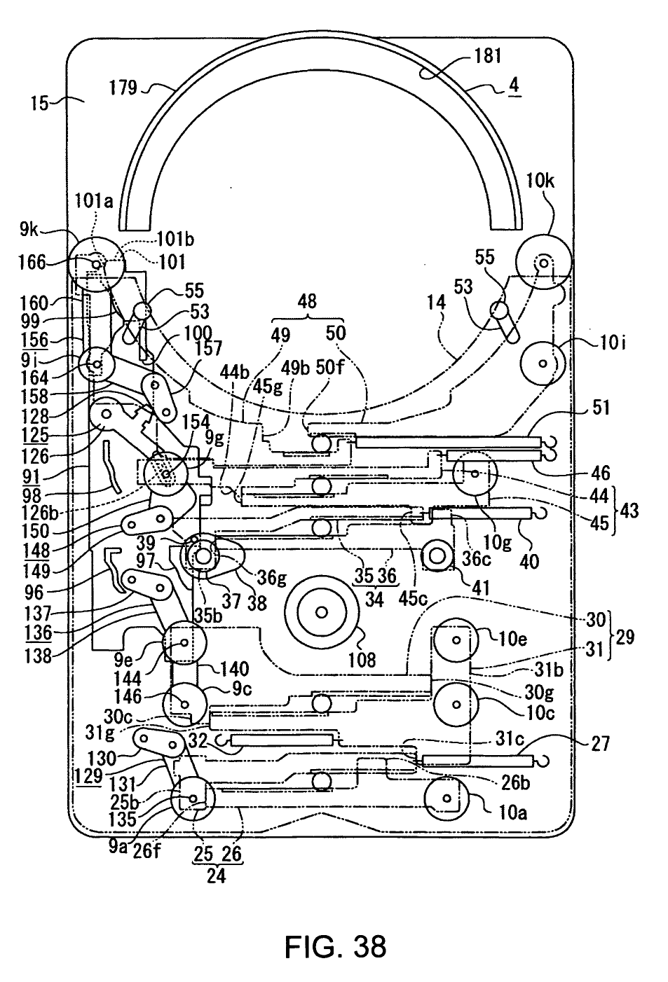

The transportation mode that is set when a disc-shaped recording medium 200a inserted from the disc insertion slot 2a is to be transported between the disc insertion slot 2a and the reproducing unit 3 will be described. In the transportation mode, the state of each part is as follows (see FIGS. 38 to 41).

The first sliding means 24 supported by the supporting chassis 14 is such that the restricting portion 26f of the driven slider 26 is in contact with the restricting protrusion 25b of the drive slider 25 by the force of the spring 27, and the drive slider 25 and the driven slider 26 are at movement ends in the directions in which they move towards each other (see FIG. 38). Therefore, the first feed roller 9a, supported by the drive slider 25, and the first feed member 10a, mounted to the driven slider 26, are held at movement ends in the directions in which they move towards each other.

The second sliding means 29 is such that the restricting portion 31g of the driven slider 31 is in contact with the restricting protrusion 30c of the driven slider 30 by the force of the spring 32, the restricting portion 30g of the drive slider 30 is in contact with the restricting protrusion 31b of the driven slider 31, and the drive slider 30 and the driven slider 31 are at movement ends in the directions in which they move towards each other (see FIG. 38). Therefore, the second feed roller 9c and third feed roller 9e, supported at the drive slider 30, and the second feed member 10c and third feed member 10e, mounted to the driven slider 31, are held at movement ends in the directions in which they move towards each other. At this time, the pushing protrusion 26b of the driven slider 26 of the first sliding means 24 is disposed at a predetermined distance from the left side of the pushing protrusion 31c of the driven slider 31.

The third sliding means 34 is such that the restricting portion 36g of the second slider 36 is in contact with the restricting protrusion 35b of the first slider 35 by the force of the spring 40, and the first slider 35 and the second slider 36 are disposed at movement ends in the directions in which they move towards each other (see FIG. 38). Therefore, the first restricting roller 37, supported at the first slider 35, and the second restricting roller 41, supported at the second slider 36, are held at movement ends in the directions in which they move towards each other.

The fourth sliding means 43 is such that the restricting portion 45g of the driven slider 45 is in contact with the restricting protrusion 44b of the drive slider 44 by the force of the spring 46, and the drive slider 44 and the driven slider 45 are disposed at movement ends in the directions in which they move towards each other (see FIG. 38). Therefore, the fourth feed roller 9g supported at the drive slider 44 and the fourth feed member 10g mounted to the driven slider 45 are held at movement ends in the directions in which they move towards each other. At this time, the pushing protrusion 45c of the driven slider 45 is in contact with the left side of the push protrusion 36c of the second slider 36 of the third sliding means 34. Here, the operation portion 128 of the operating lever 125 supported at the subchassis 120 faces obliquely rightwards and backwards (see FIG. 38).

Since the supporting shaft 166 supported at the support cylindrical portion 49d of the drive slider 49 engages the left end of the inclined surface 101a of the cam protrusion 101 of the mode slider 91, the drive slider 49 and the driven slider 50 of the fifth sliding means 48 are disposed at movement ends in the directions in which they move away from each other (see FIG. 38). Therefore, the fifth feed roller 9i and the sixth feed roller 9k supported at the drive slider 49 and the fifth feed member 10i and the sixth feed member 10k, mounted to the driven slider 50, are held at movement ends in the directions in which they move away from each other.

The movable levers 53 and 53 supported at rearward end locations of the supporting chassis 14 are biased towards each other by the torsional coil springs 54 and 54, and the stoppers 55 and 55 supported at the respective movable levers 53 and 53 are held at movement ends in the directions in which they move towards each other (see FIG. 38).

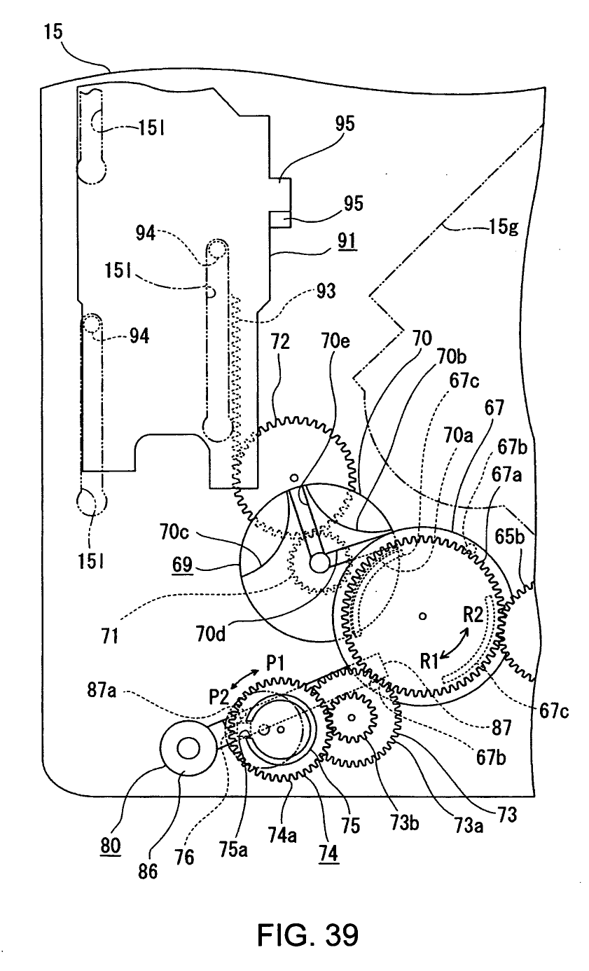

The cam 67 supported at the lower surface of the base chassis 15 is such that one of the ribs 67c at the lower surface of the cam 67 is in contact with or is disposed close to the wall 70a of the Geneva driven gear 69 (see FIG. 39). At this time, the operating gear 74 engaging the geared portion 67a of the cam 67 through the two-speed gear 73 is such that its insertion cut portion 75a of the restricting wall 75 is disposed at the left (see FIG. 39). Therefore, when the drive slider 25 is moved leftwards, the supporting shaft 135 supported at the drive slider 25 of the first sliding means 24 is capable of passing through the insertion cut portion 75a. As a result, the drive slider 25 is movable towards the left or right, and is not locked (see FIG. 39).

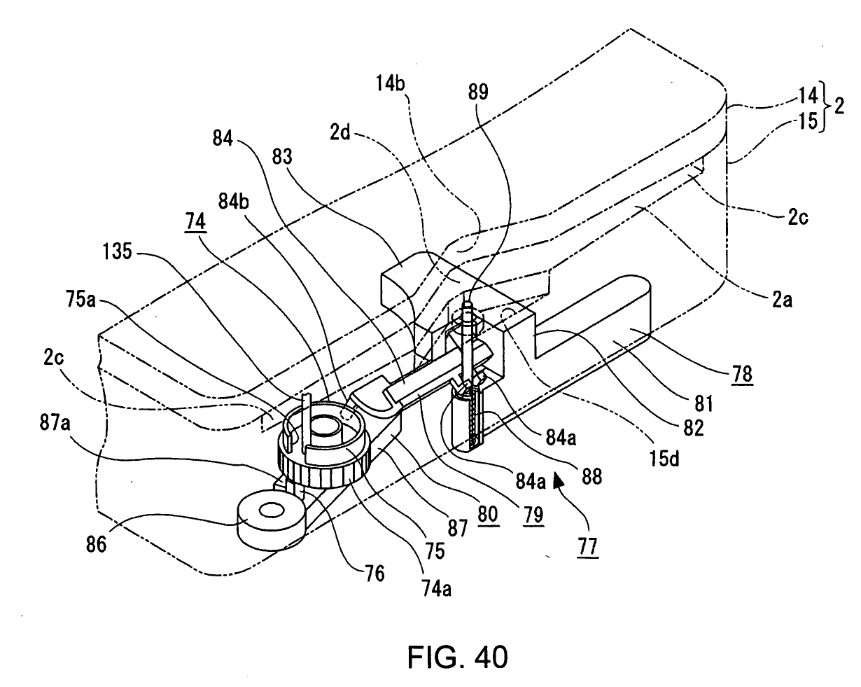

The insertion restricting means 77 disposed at the lower surface of the base chassis 15 is such that its push protrusion 87a of the operating lever 80 is pushed backwards by the pushing pin 76 of the operating gear 74, so that the operating lever 80 is rotated backwards (see FIGS. 39 and 40). Since the operating lever 80 is rotated backwards, the push pin 84b of the restricting lever 79 is pushed backwards by the protrusion 87 of the operating lever 80, causing the engaging protrusions 84a and 84a of the restricting lever 79 to rotate downwards (see FIG. 40). Therefore, the engaging protrusions 84a and 84a push the stopper ring 90, mounted to the restricting pin 89 held by the holding member 78, downwards against the biasing force of the compression spring 88, so that the upper end of the restricting pin 89 protrudes slightly upwards from the pin insertion hole 15e of the base chassis 15.

Since the upper end of the restricting pin 89 protrudes slightly upwards from the pin insertion hole 15e, the upper end of the restricting pin 89 is disposed at the clearance recess 15d of the base chassis 15, and thus is not disposed in front of the disc insertion slot 2a (see FIG. 40). Therefore, in the transmission mode, the disc loading device is set in an unrestricted state in which the disc-shaped recording medium 200a can be inserted into and taken out of the disc insertion slot 2a.

The mode slider 91 is disposed at a rearward movement end (see FIGS. 38 and 39). Therefore, the front end of the rack 93 engages the coupling gear 72 supported at the lower surface of the base chassis 15 (see FIG. 39).

The supporting protrusions 95 and 95 of the mode slider 91 are disposed behind the support portion 104c of the base unit 102. The first cam wall 96 and the second cam wall 97 of the mode slider 91 are disposed behind the supporting shaft 144 supporting the third feed roller 9e, and the third cam wall 98 of the mode slider 91 is disposed behind the guide shaft 39 supported by the first slider 35 (see FIG. 38). The front linear portion 99a of the fourth cam wall 99 of the mode slider 91 engages the right side of the supporting shaft 164 supporting the fifth feed roller 9i (see FIG. 38). At this time, the supporting shaft 164 elastically contacts the front linear portion 99a of the fourth cam wall 99 by the spring 51 and the biasing spring 167 biasing the fifth sliding means 48 and the fourth rotary mechanism 156 rightwards. The pushing rib 100 of the mode slider 91 is disposed behind the operation portion 128 of the operating lever 125 supported by the subchassis 120 (see FIG. 38). The left end of the inclined surface 101a of the cam protrusion 101 of the mode slider 91 engages the supporting shaft 166 supporting the sixth feed roller 9k (see FIG. 38).

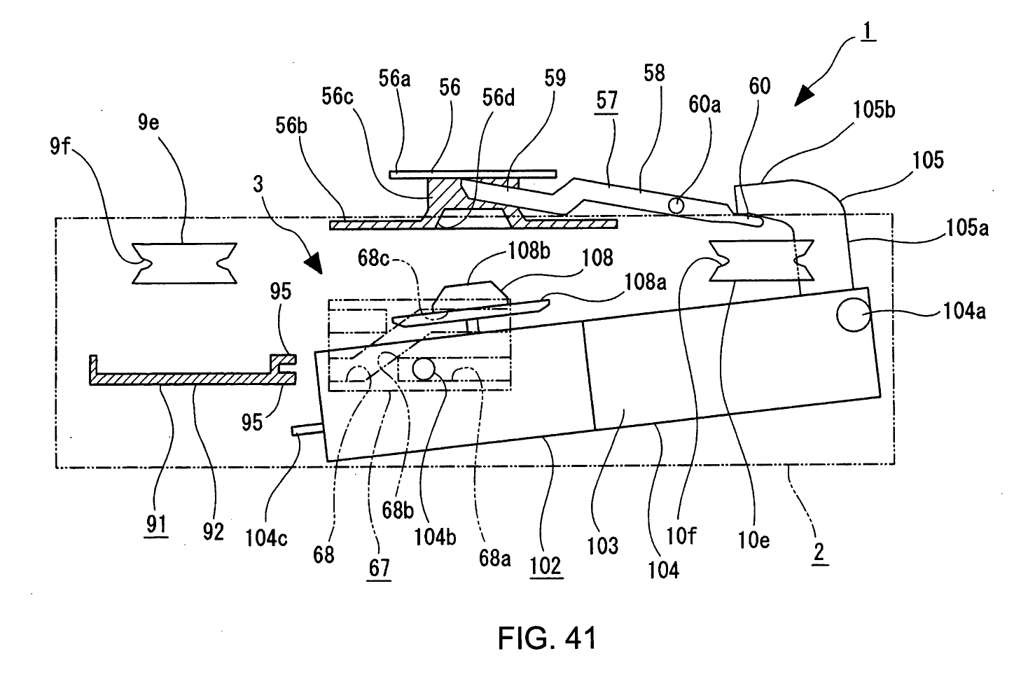

The cam protruding pin 104b of the supporting case 103 of the base unit 102 engages the lower horizontal portion 68a defining the groove 68 of the cam 67 (see FIG. 41). Therefore, while the disc table 108 is disposed at the lower movement end, the base unit 102 is inclined with respect to the base chassis 15.

Since the base unit 102 is inclined, the detaching member 57 is rotated in the direction of upward movement of the lifting portions 59 and 59 by the engaging portion 105b of the engaging lever 105, so that the chucking pulley 56 is lifted by the detaching member 57 (see FIG. 41). Therefore, a space having a predetermined size is formed between the chucking pulley 56 and the disc table 108.

(d) Transporting Operation Between the Disc Insertion Slot and the Stocker

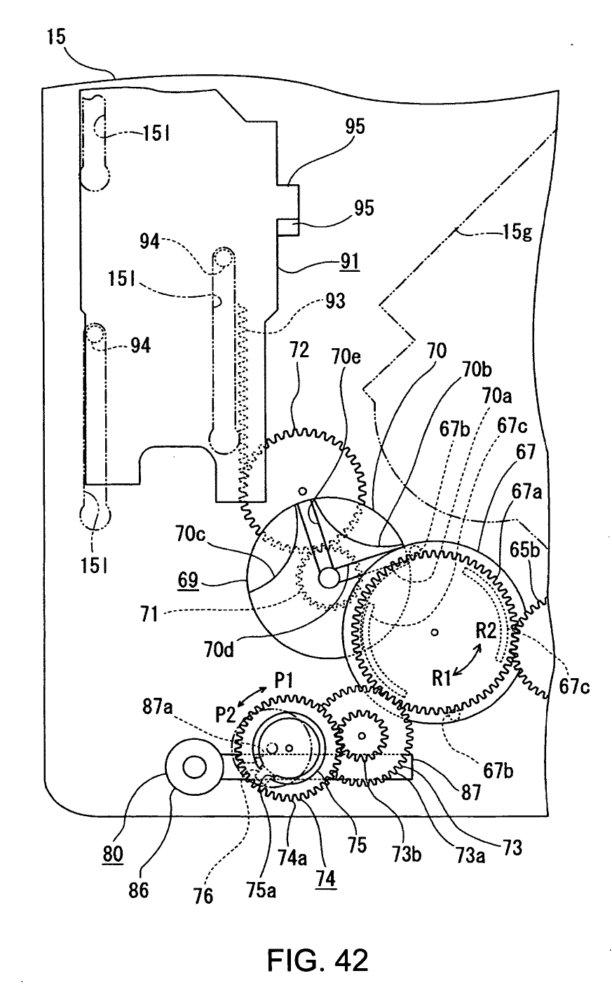

Next, the transporting operation for transporting a disc-shaped recording medium 200a between the disc insertion slot 2a and the stocker 4 will be described (see FIGS. 42 to 71).

When the disc-shaped recording medium 200a is to be transported to the stocker 4 from the disc insertion slot 2a and accommodated, an accommodation knob (not shown) is operated. When the accommodation knob is operated, first, the ascending/descending mode in which the stocker 4 is raised or lowered is set. At this time, of the disc accommodation portions 181 of the stocker 4, a predetermined disc accommodation portion 181 to which the disc-shaped recording medium 200a is to be accommodated is selected. In the ascending/descending mode, the state of each part is as follows (see FIGS. 42 to 44).

The states of the sliding means 24, 29, 34, 43, and 48 are the same as those in the transportation mode.

The cam 67 supported at the lower surface of the base chassis 15 is rotated by a predetermined angle in a counterclockwise direction (that is, a direction R2 shown in FIG. 42) in plan view by rotation of the mode motor 61 from the state in the transportation mode, so that one of the operating pins 67b is stopped at a location where it is situated immediately before it is inserted into the operation groove 70d of the Geneva driven gear 69 (see FIG. 42).

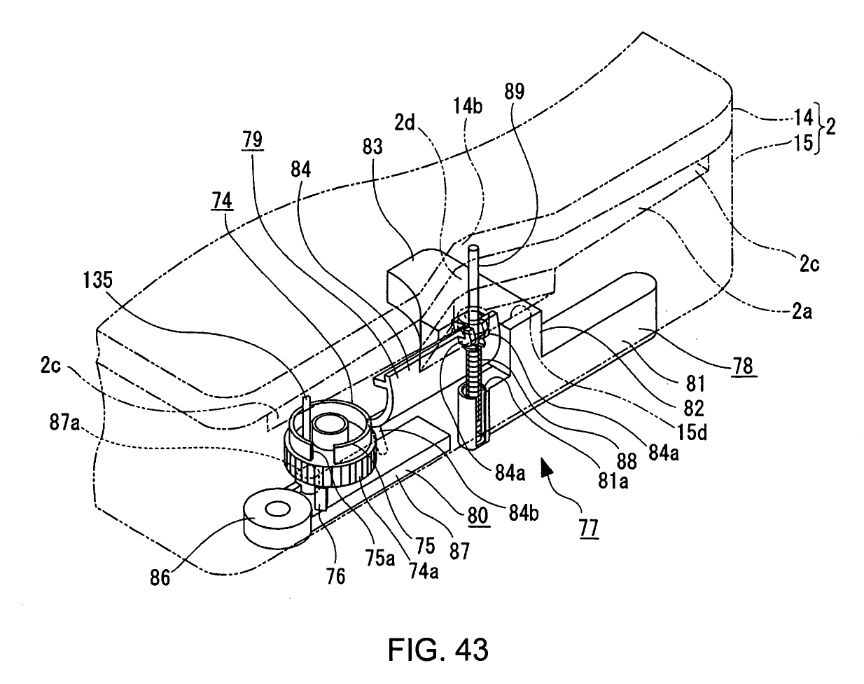

In the insertion restricting means 77 disposed at the lower surface of the base chassis 15, since the operating gear 74 is rotated counterclockwise (that is, in a direction P2 shown in FIG. 42) in plan view by the rotation of the cam 67, the backward pushing operation performed on the push protrusion 87a of the operating lever 80 by the pushing pin 76 is cancelled (see FIGS. 42 and 43). At this time, the insertion cut portion 75a of the restricting wall 75 of the operating gear 74 is not positioned at the left side. Therefore, the supporting shaft 135 supported at the drive slider 25 of the first sliding means 24 cannot pass through the insertion cut portion 75a because its movement is restricted by the restricting wall 75 even if it tries to move leftwards by the leftward movement of the drive slider 25. Consequently, the drive slider 25 cannot move in the horizontal direction and is thus in a locked state (see FIGS. 42 and 43).

The drive slider 25 is locked not only in the ascending/descending mode but also in the accommodation/take-out mode in which the disc-shaped recording medium 200a is transported between the reproducing unit 3 and the stocker 4, in the chucking mode in which the disc-shaped recording medium 200a transported to the reproducing unit 3 is chucked or unchucked, and the disc holding canceling mode in which the holding of the chucked disc-shaped recording medium 200a by the feed rollers 9 and 9 and feed members 10 and 10 is cancelled or the disc-shaped recording medium 200a is held again. The drive slider 25 is unlocked so as to be movable only in the transportation mode.

Therefore, in the operation modes other than the transportation mode, the restricting wall 75 of the operating gear 74 serves as restricting means for restricting the movement of the drive slider 25.

In the disc loading device 1, since the drive slider 25 is locked so as not to be movable in the operation modes other than the transportation mode, it is possible to reliably prevent improper insertion of the disc-shaped recording medium 200 in the operation modes other than the transportation mode.

In the insertion restricting means 77, since the backward pushing operation performed on the push protrusion 87a by the pushing pin 76 is cancelled, the restricting lever 79 is rotated in the direction of upward movement of the engaging protrusions 84a and 84a by the force of the compression spring 88, causing the restricting pin 89 to move upward by the biasing force of the compression spring 88, so that the upper end of the restricting pin 89 is disposed in front of the disc insertion slot 2a (see FIG. 43). Therefore, in the ascending/descending mode, the disc-shaped recording medium 200a cannot be inserted into or taken out of the disc insertion slot 2a. At this time, the protrusion 87 of the operating lever 80 is pushed forward by the push pin 84b of the restricting lever 79, so that the protrusion 87 extends in the leftward/rightward direction (see FIGS. 42 and 43).

The disc-shaped recording medium 200a is incapable of being inserted into or taken out of the disc insertion slot 2a not only in the ascending/descending mode but also in the accommodation/take-out mode in which the disc-shaped recording medium 200a is transported between the reproducing unit 3 and the stocker 4, in the chucking mode in which the disc-shaped recording medium 200a transported to the reproducing unit 3 is chucked or unchucked, and the disc holding canceling mode in which the holding of the chucked disc-shaped recording medium 200a by the feed rollers 9 and 9 and feed members 10 and 10 is cancelled or the disc-shaped recording medium 200a is held again. The unrestricted state in which the disc-shaped recording medium 200a is capable of being inserted into or taken out of the disc insertion slot 2a is set only in the transportation mode.

In the disc loading device 1, since the drive slider 25 is set in the locked state as mentioned above, it is possible to prevent the transportation of the disc-shaped recording medium 200a in the modes other than the transportation mode. When the locked state is only set, the disc-shaped recording medium 200 can be inserted from the disc insertion slot 2a until the outer peripheral surface of the disc-shaped recording medium 200a comes into contact with the first feed roller 9a and the first feed member 10a. At this time, for example, when a disc-shaped recording medium 200 exists at the reproducing unit 3, the outer peripheral portion of the disc-shaped recording medium 200 existing at the reproducing unit 3 and the outer peripheral portion of the disc-shaped recording medium 200 that one is trying to insert from the disc insertion slot 2a come into contact with each other. This may damage the disc-shaped recording media 200.

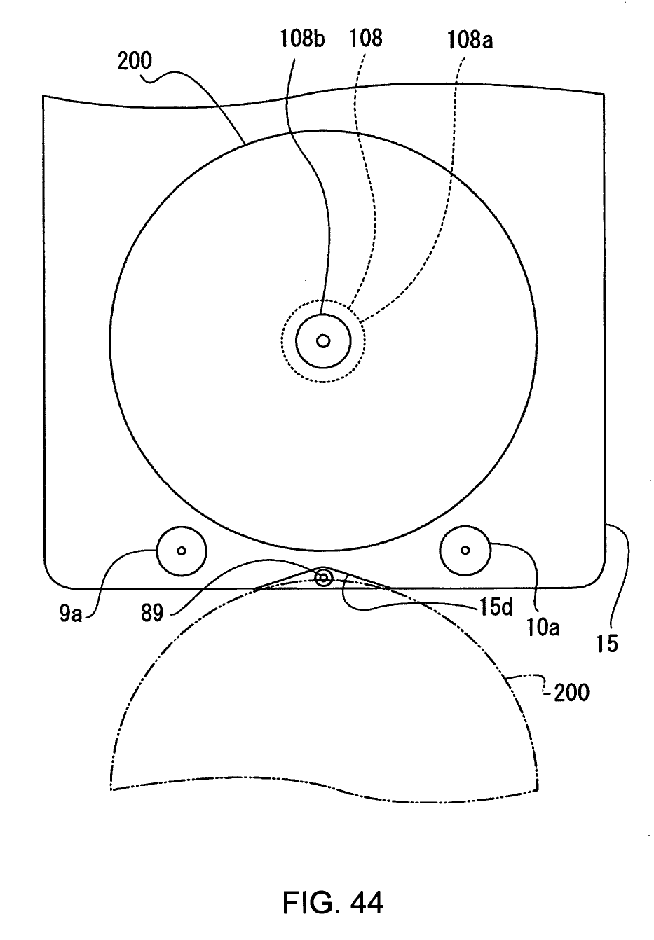

Therefore, in the disc loading device 1, the drive slider 25 is set in the locked state and at the same time a restricted state is set in which the disc-shaped recording medium 200 is incapable of being inserted into and taken out of the disc insertion slot 2a in order to prevent the insertion of the outer peripheral portion of the disc-shaped recording medium 200 from the disc insertion slot 2a (see FIG. 44).

Accordingly, when the locked state is set, the disc-shaped recording medium 200 cannot be inserted at the same time from the disc insertion slot 2a. Therefore, the outer peripheral portion of the disc-shaped recording medium 200 is prevented from being inserted from the disc insertion slot 2a. Consequently, even if another disc-shaped recording medium 200 exists near the disc insertion slot 2a during reproduction, it is possible to prevent the disc-shaped recording media 200 and 200 from contacting each other.

In the ascending/descending mode, the mode slider 91 is disposed at the rearward movement end as in the transportation mode (see FIG. 42).

As in the transportation mode, the base unit 102 is inclined with respect to the base chassis 15 while the disc table 108 is disposed at the lower movement end.

When the ascending/descending mode described above has been set, the ascending/descending motor 168 is rotated so that a predetermined disc accommodation portion 181 selected by the operation of the accommodation knob is moved to an accommodation/take-out position.

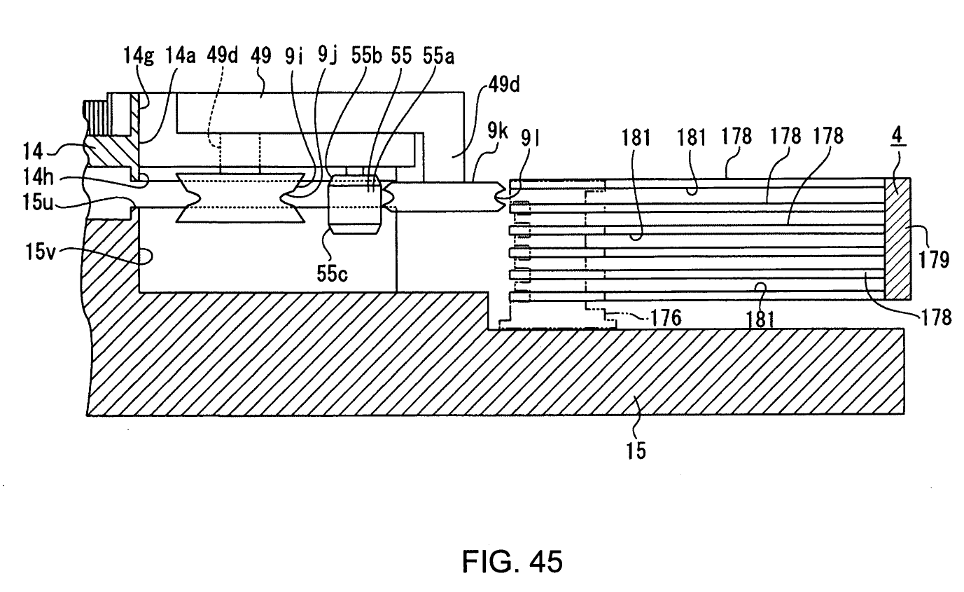

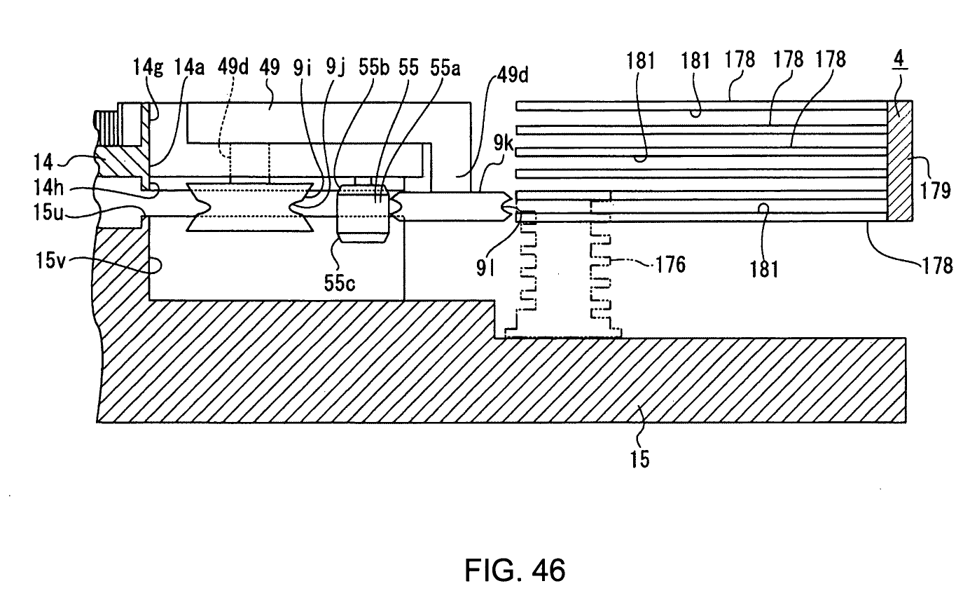

When the ascending/descending motor 168 is rotated, as described above, the rotary cams 176, 176, and 176 are rotated in a direction in accordance with the direction of rotation of the ascending/descending motor 168, so that the locations of the guide protrusions 179a, 179a, and 179a of the stocker 4 change with respect to the cam grooves 177, 177, and 177, causing the stocker 4 to be raised or lowered. For example, when the selected disc accommodation portion 181 is disposed at the uppermost end, the stocker 4 is moved to the lower movement end, so that the disc accommodation portion 181 is disposed directly behind the sixth feed roller 9k and the sixth feed member 10k, that is, at the accommodation/take-out position (see FIG. 45). When the selected disc accommodation portion 181 is disposed at the lowest end, the stocker 4 is moved to the upper movement end in order to dispose the disc accommodation portion 181 at the accommodation/take-out position (see FIG. 46).

Since, as described above, the stocker 4 is raised and lowered by rotating the rotary cams 176, 176, and 176, differences in the precision of the stopping position of the stocker 4 caused by backlash between a rack and an ascending/descending gear, which are used to raise and lower the stocker, do not occur, so that it is possible to increase the precision of the stopping position of the stocker 4.

Even if the guide protrusions 179a, 179a, 179a of the stocker 4 engage any non-operating portions 177a, 177a, and 177a of the rotary cams 176, 176, and 176, the stocker 4 is stopped, so that it is not necessary to strictly set the precision of control of the rotation of the rotary cams 176, 176, and 176. Therefore, it is possible to facilitate the control of the rotation of the ascending/descending motor 168 by the rotary encoder 174.

When the predetermined disc accommodation portion 181 has been disposed at the accommodation/take-out position by raising or lowering the stocker 4 as mentioned above, the mode motor 61 is rotated in order to set the transportation mode. When the transportation mode is set, as described above, the unlocked state is set by disposing the insertion cut portion 75a of the operating gear 74 to the left of the supporting shaft 135 supported by the drive slider 25 of the first sliding means 24, and the unrestricted state is set by lowering the restricting pin 89 (see FIGS. 39 and 40).

When the transportation mode has been set, the drive motor 110 is rotated in one direction. When the drive motor 110 is rotated in one direction, as described above, the feed rollers 9a, 9c, 9e, 9g, 9i, and 9k are rotated counterclockwise in plan view.

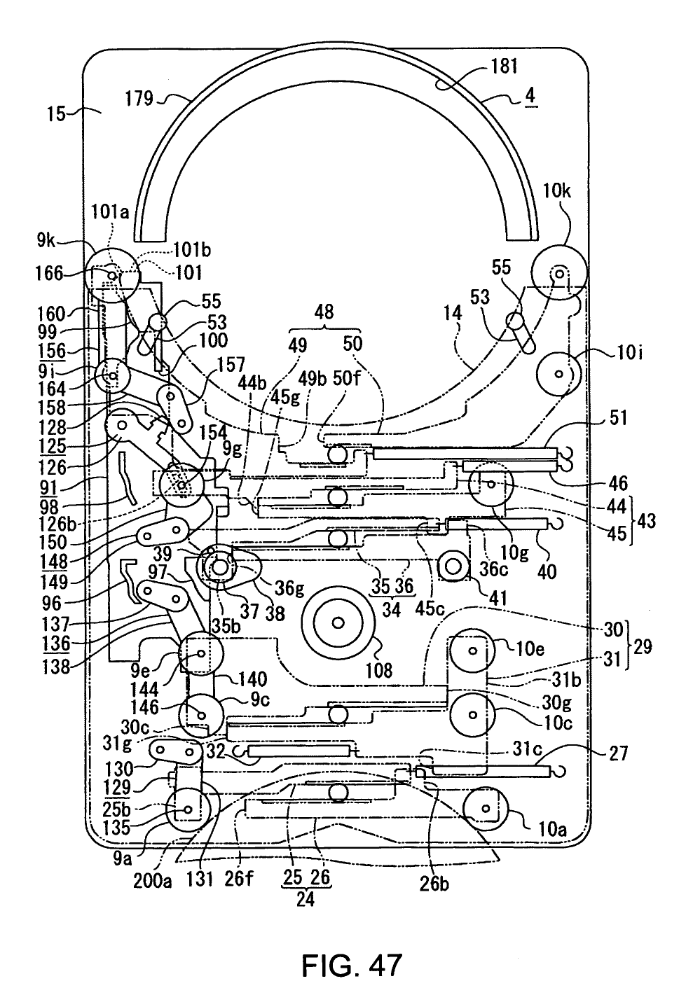

When a disc-shaped recording medium 200a is inserted from the disc insertion slot 2a, the outer peripheral surface of the disc-shaped recording medium 200a is pushed against the feed roller 9a and the feed roller 10a, and the disc-shaped recording medium 200a is pulled into the housing 2 by the rotation of the feed roller 9a (see FIG. 47). As the disc-shaped recording medium 200a gets pulled in, the feed roller 9a rolls on the outer peripheral surface of the disc-shaped recording medium 200a.

As the disc-shaped recording medium 200a gets pulled in, the distance between the feed roller 9a and the feed member 10a changes constantly in accordance with the location of the disc-shaped recording medium 200a being pulled in, so that the drive slider 25 and the driven slider 26 of the first sliding means 24 slides away from each other with respect to the supporting chassis 14 so as to oppose the force of the spring 27 (see FIG. 47). While the inclination angle between the rotary member 130 and the rotary lever 131 of the first rotary mechanism 129 changes, the supporting shaft 135 is moved in the leftward/rightward direction by being guided in the guide hole 15m formed in the base chassis 15.

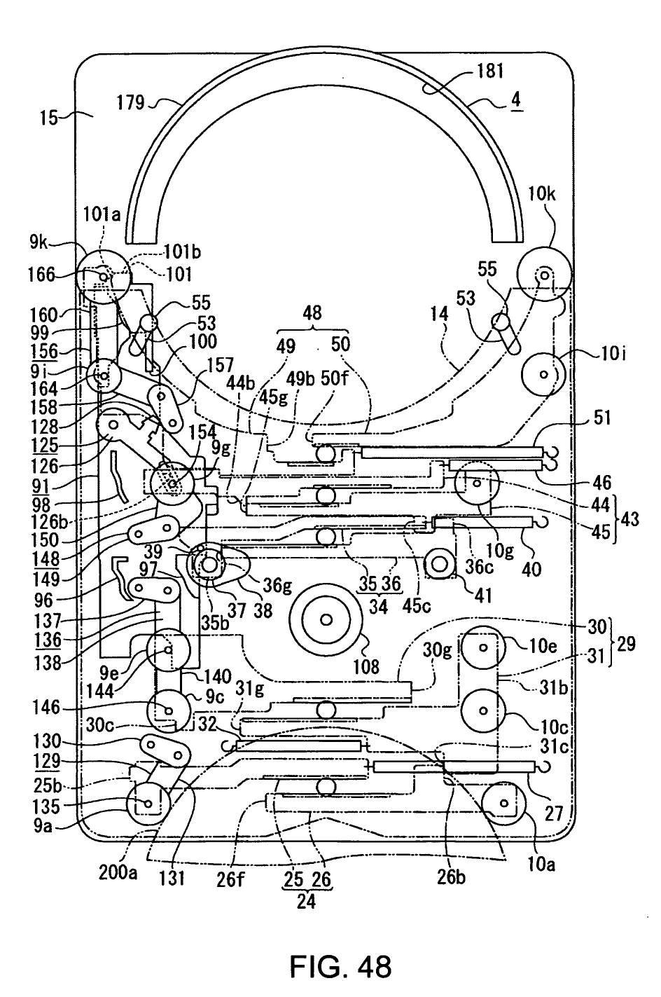

As the disc-shaped recording medium 200a gets pulled in, and the drive slider 25 and the driven slider 26 further slide away from each other so as to oppose the force of the spring 27, the pushing protrusion 26b of the driven slider 26 pushes the push protrusion 31c of the driven slider 31 of the second sliding means 29. The sliding of the drive slider 25 and the driven slider 26 causes the drive slider 30 and the driven slider 31 to slide away from each other (see FIG. 48). When the drive slider 30 and the driven slider 31 start sliding, the outer peripheral surface of the disc-shaped recording medium 200a is not in contact with the feed roller 9c and the feed member 10c.

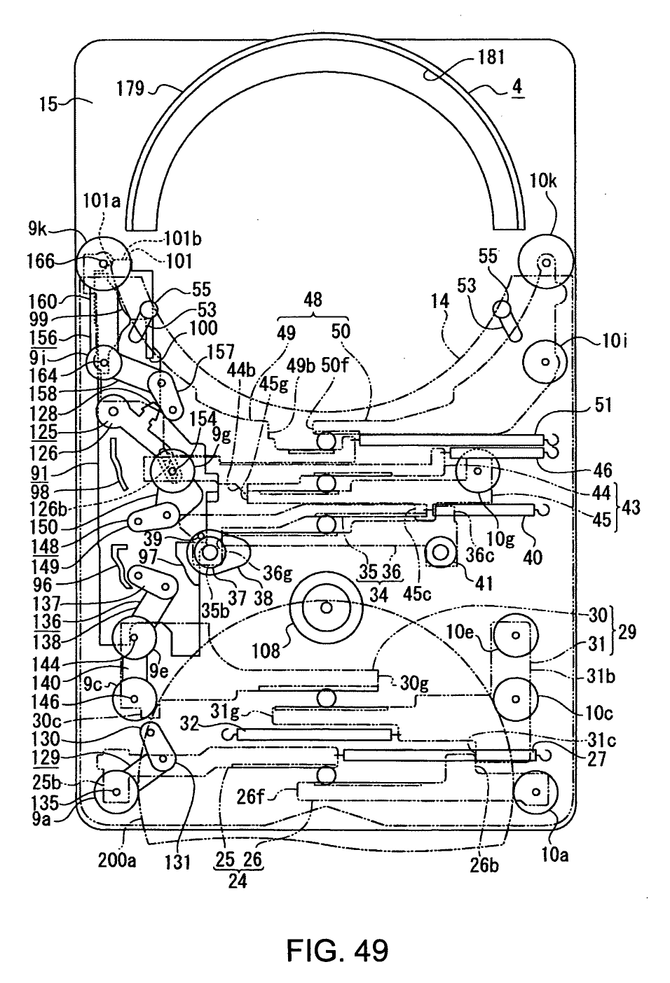

When the drive slider 25 and the driven slider 26 further slide away from each other so as to oppose the force of the spring 27, the outer peripheral surface of the disc-shaped recording medium 200a is transferred from the first feed roller 9a and the first feed member 10a to the second feed roller 9c and the second feed member 10c (see FIG. 49). When the disc-shaped recording medium 200a is to be transferred, the first feed roller 9a, the second feed roller 9c, the first feed member 10a, and the second feed member 10c are in contact with the outer peripheral surface of the disc-shaped recording medium 200a.

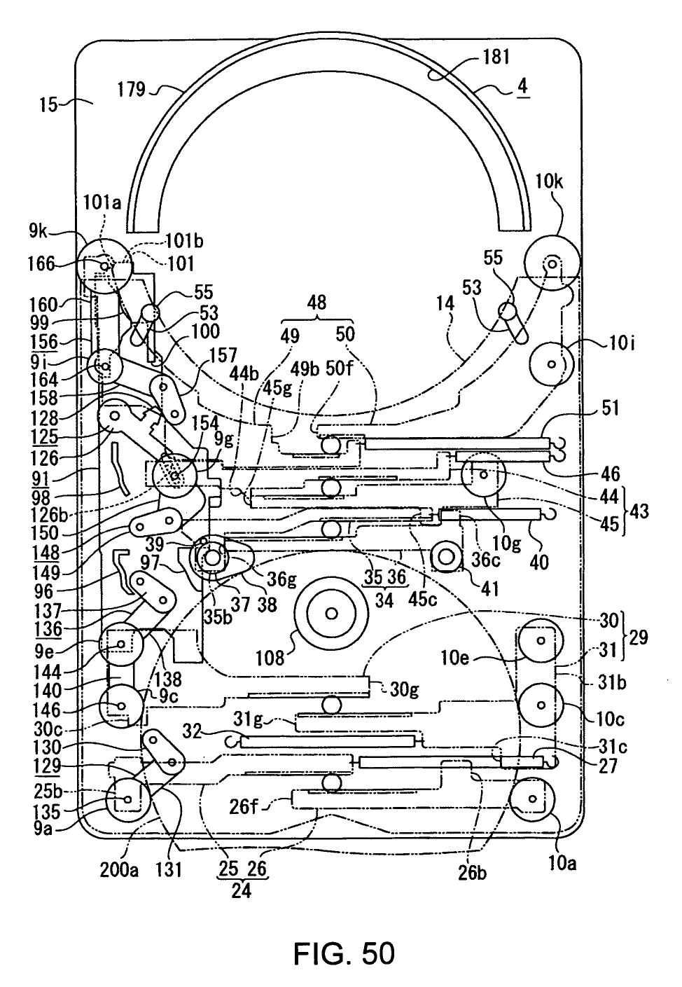

When the disc-shaped recording medium 200a is further pulled in, the drive slider 30 and the driven slider 31 further slide away from each other so as to oppose the force of the spring 32, whereas the drive slider 25 and the driven slider 26 slide towards each other by the force of the spring 27 (see FIG. 50).

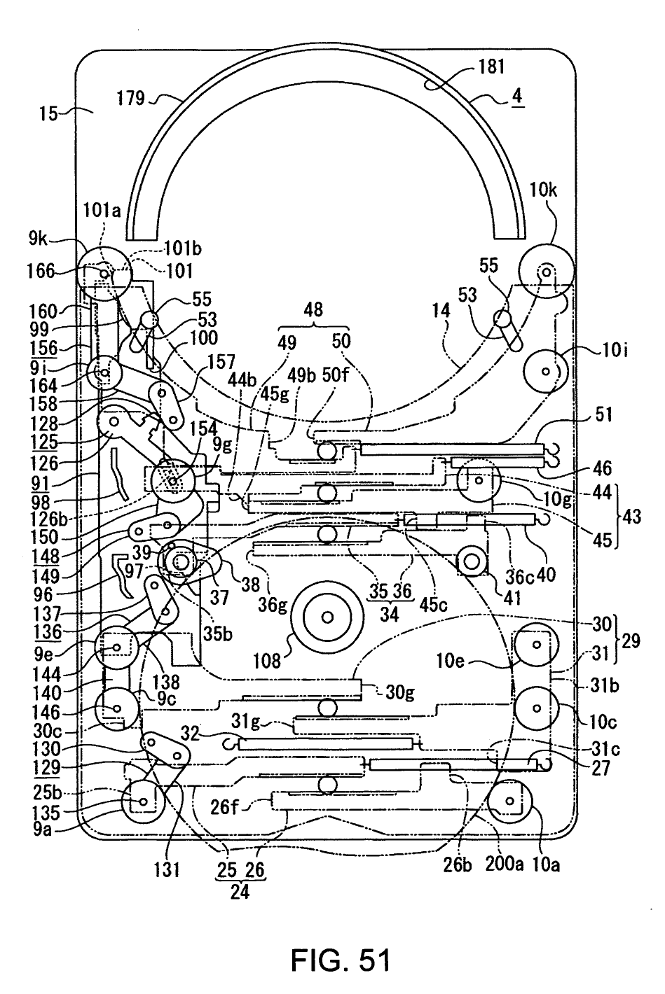

When the disc-shaped recording medium 200a is further pulled in, the outer peripheral surface of the disc-shaped recording medium 200a come into contact with the first restricting roller 37 and the second restricting roller 41 supported at the respective first slider 35 and second slider 36 of the third sliding means 34 (see FIG. 51).

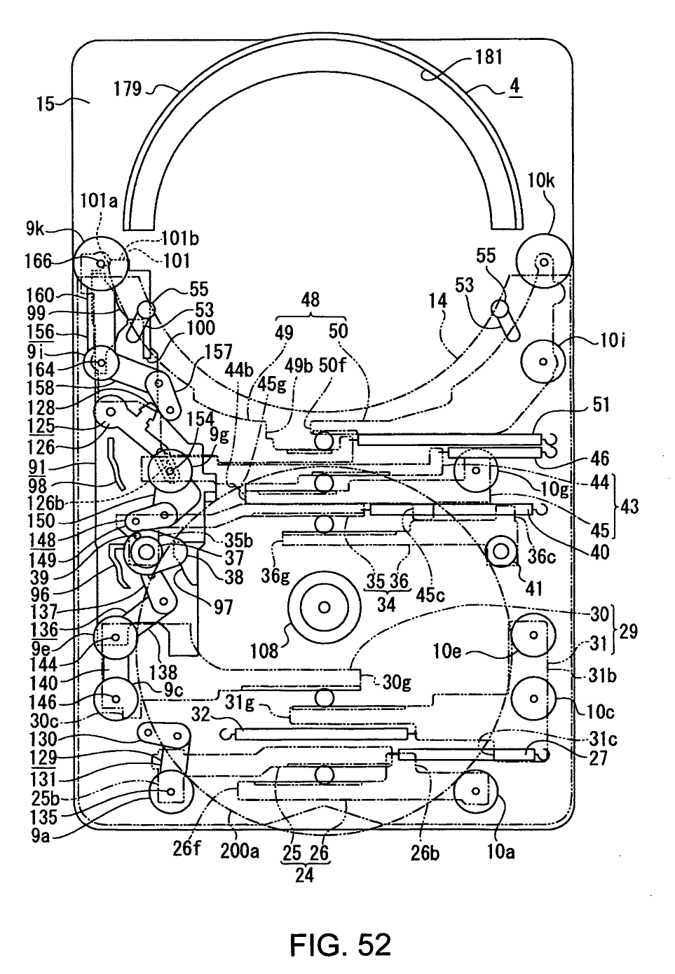

As the disc-shaped recording medium 200a is pulled in, the first slider 35 and the second slider 36 slide away from each other, and the disc-shaped recording medium 200a is transferred from the second feed roller 9c and the second feed member 10c to the third feed roller 9e and the third feed member 10e (see FIG. 52). When the disc-shaped recording medium 200a is transferred, the first feed roller 9a, the third feed roller 9e, the first restricting roller 37, the first feed member 10a, the third feed member 10e, and the second restricting roller 41 are in contact with the outer peripheral surface of the disc-shaped recording medium 200a. Even if the first restricting roller 37 and the second restricting roller 41 are in contact with the outer peripheral surface of the disc-shaped recording medium 200a, they idle with respect to the outer peripheral surface of the disc-shaped recording medium 200a, so that they do not operate as means for transporting the disc-shaped recording medium 200a.

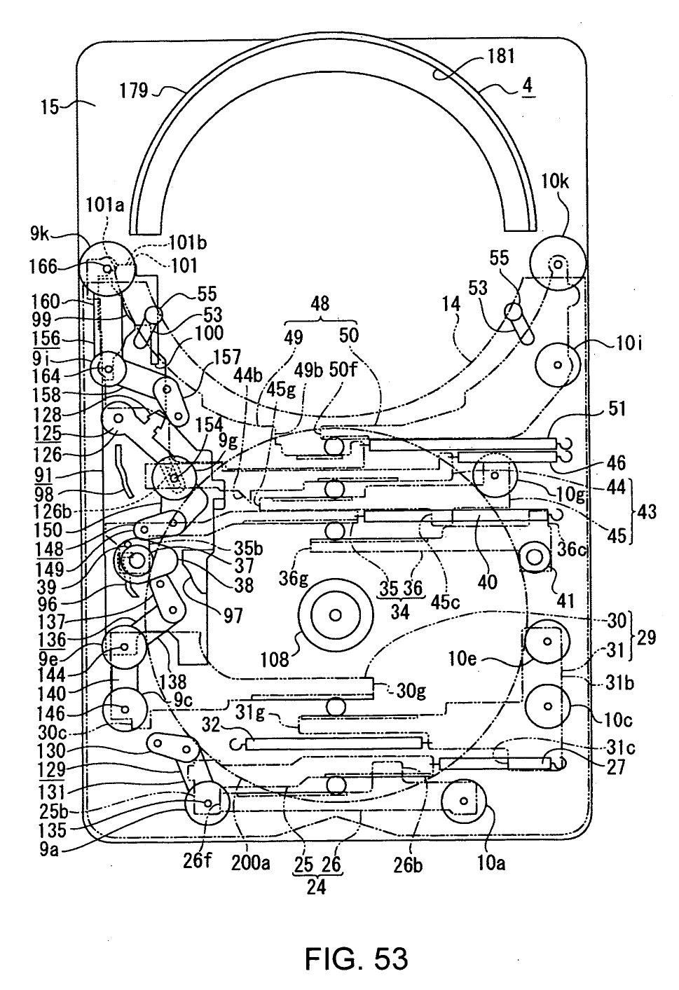

When the disc-shaped recording medium 200a is transferred to the third feed roller 9e and the third feed member 10e, and is further pulled in, the outer peripheral surface of the disc-shaped recording medium 200a comes into contact with the fourth feed roller 9g and the fourth feed member 10g (see FIG. 53). At this time, the first feed roller 9a and the first feed member 10a separate from the outer peripheral surface of the disc-shaped recording medium 200a, so that the third feed roller 9e, the fourth feed roller 9g, the first restricting roller 37, the third feed member 10e, the fourth feed member 10g, and the second restricting roller 41 are in contact with the outer peripheral surface of the disc-shaped recording medium 200a.

When the fourth feed roller 9g and the fourth feed member 10g come into contact with the outer peripheral surface of the disc-shaped recording medium 200a, the rotation of the drive motor 110 is temporarily stopped. At this time, the center hole of the disc-shaped recording medium 200a is disposed substantially right above the disc table 108, and is held at a location where it can be mounted to the disc table 108 (see FIG. 53).

When the rotation of the drive motor 110 has been stopped, the mode motor 61 is rotated. The mode motor 61 is rotated in the direction in which the cam 67 is rotated in the direction R2 shown in FIG. 42.

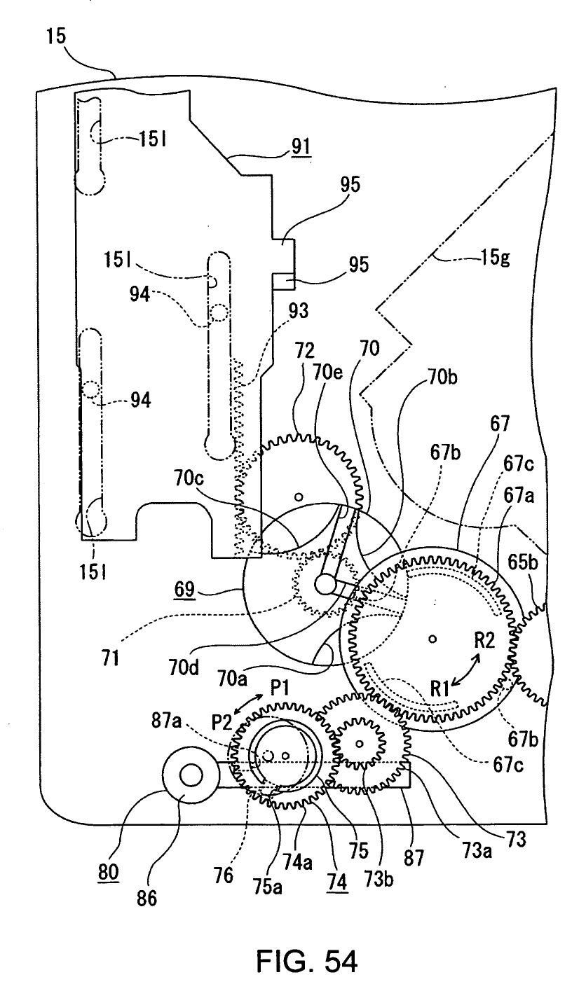

When the cam 67 is rotated by the rotation of the mode motor 61, one of the operating pins 67b is inserted into the operation groove 70d of the Geneva driven gear 69 (see Fig. 54). When the operating pin 67b is inserted into the operation groove 70d, the Geneva driven gear 69 is rotated, causing the mode slider 91 to move forward through the coupling gear 72.

The Geneva driven gear 69 is rotated through an angle of 90 degrees by the rotation of the cam 67 by the time the operating pin 67b is moved out of the operation groove 70d, so that the rotation of the mode motor 61 is stopped when the rib 67c of the cam 67 comes into contact with or is disposed close to the wall 70b of the Geneva driven gear 69.

When the rotation of the mode motor 61 is stopped, the cam protruding pin 104b of the base unit 102 engages an end at the inclined portion 68b side of the lower horizontal portion 68a defining the groove 68 of the cam 67.

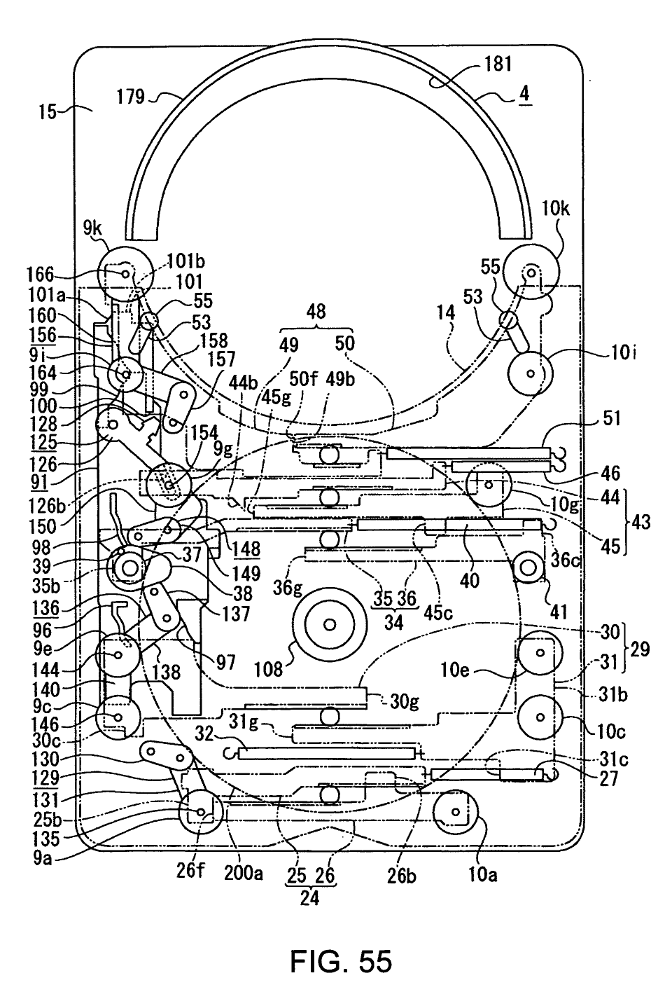

When the mode slider 91 is moved forward, the cam protrusion 101 separates from the supporting shaft 166 of the fourth rotary mechanism 156, and the supporting shaft 166 comes into sliding contact with the intermediate linear portion 99c through the front inclined portion 99b from the front linear portion 99a. Therefore, the drive slider 49 and the driven slider 50 of the fifth sliding means 48 move towards each other (see FIG. 55). The fifth sliding means 48 is such that the restricting portion 50f of the driven slider 50 contacts the restricting portion 49b of the drive slider 49 of the fifth sliding means 48 by the force of the spring 51, and that the drive slider 49 and the driven slider 50 are disposed at the movement ends in the directions in which they move towards each other. Therefore, the fifth feed roller 9i and the sixth feed roller 9k, supported at the drive slider 49, and the fifth feed member 10i and the sixth feed member 10k, mounted to the driven slider 50, are held at the movement ends in the directions in which they move towards each other.

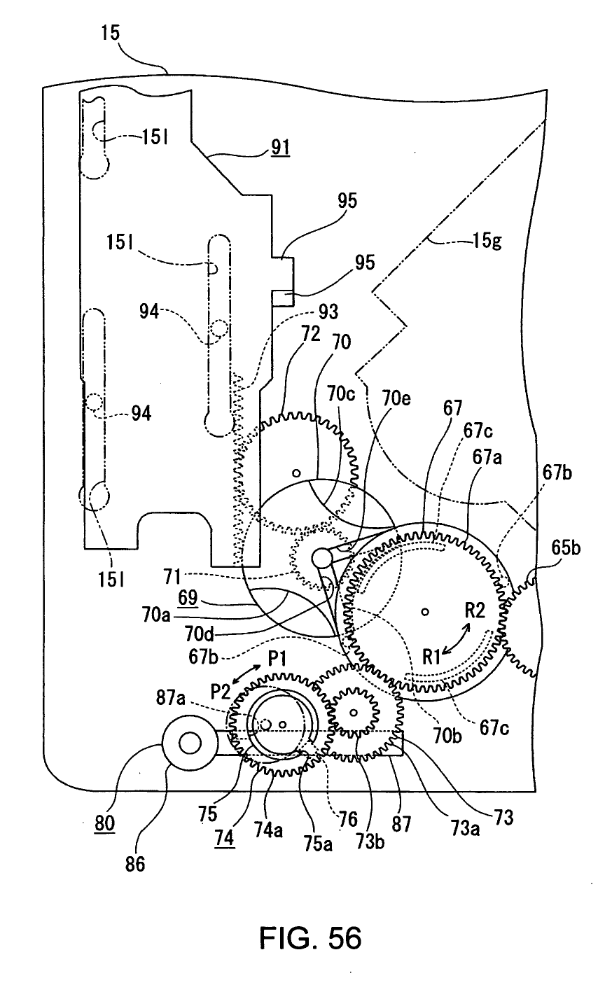

The mode slider 91 is stopped with the guide shafts 94, 94, and 94 being disposed in substantially the central portions of the respective supporting holes 15l, 15l, and 15l of the base chassis 15 in the forward/backward direction, and the accommodation/take-out mode is set for carrying out transportation of the disc-shaped recording medium 200a between the reproducing unit 3 and the stocker 4 (see FIG. 56). At this time, the supporting shaft 164 of the fourth rotary mechanism 156 engages the intermediate linear portion 99c of the fourth cam wall 99.

When the accommodation/take-out mode has been set, the drive motor 110 is rotated again in one direction. When the drive motor 110 is rotated in one direction, the feed rollers 9a, 9c, 9e, 9g, 9i, and 9k are rotated counterclockwise in plan view.

In the accommodation/take-out mode, since the third feed roller 9e, the fourth feed roller 9g, the third feed member 10e, and the fourth feed member 10g are in contact with the outer peripheral surface of the disc-shaped recording medium 200a, the disc-shaped recording medium 200a is pulled in by the rotation of the third feed roller 9e and the fourth feed roller 9g, and is transported towards the stocker 4.

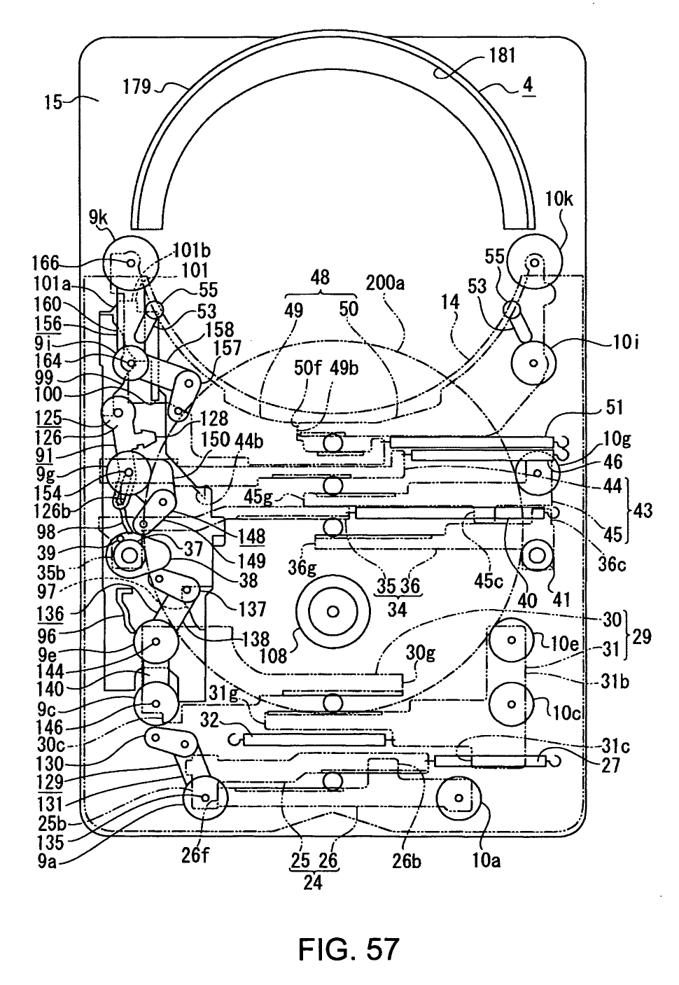

As the disc-shaped recording medium 200a gets pulled in, the drive slider 44 and the driven slider 45 of the fourth sliding means 43 slide away from each other so as to oppose the force of the spring 46, whereas the drive slider 30 and the driven slider 31 of the second sliding means 29 slide in the directions in which they contact each other by the force of the spring 32 (see FIG. 57).

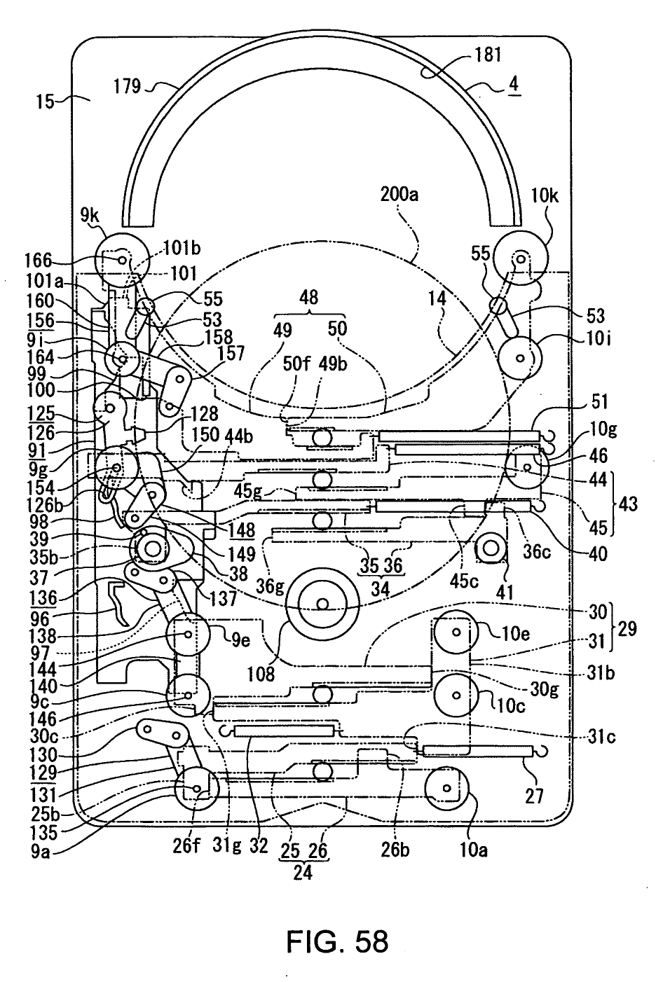

When the disc-shaped recording medium 200a is further pulled in, the outer peripheral surface of the disc-shaped recording medium 200a separates from the drive slider 30 and the driven slider 31 of the second sliding means 29. Then, the disc-shaped recording medium 200a is pulled in only by the rotation of the fourth feed roller 9g supported by the drive slider 44 of the fourth sliding means 43 (see FIG. 58). At this time, the first slider 35 and the second slider 36 of the third sliding means 34 slide in the directions in which they contact each other by the force of the spring 40.

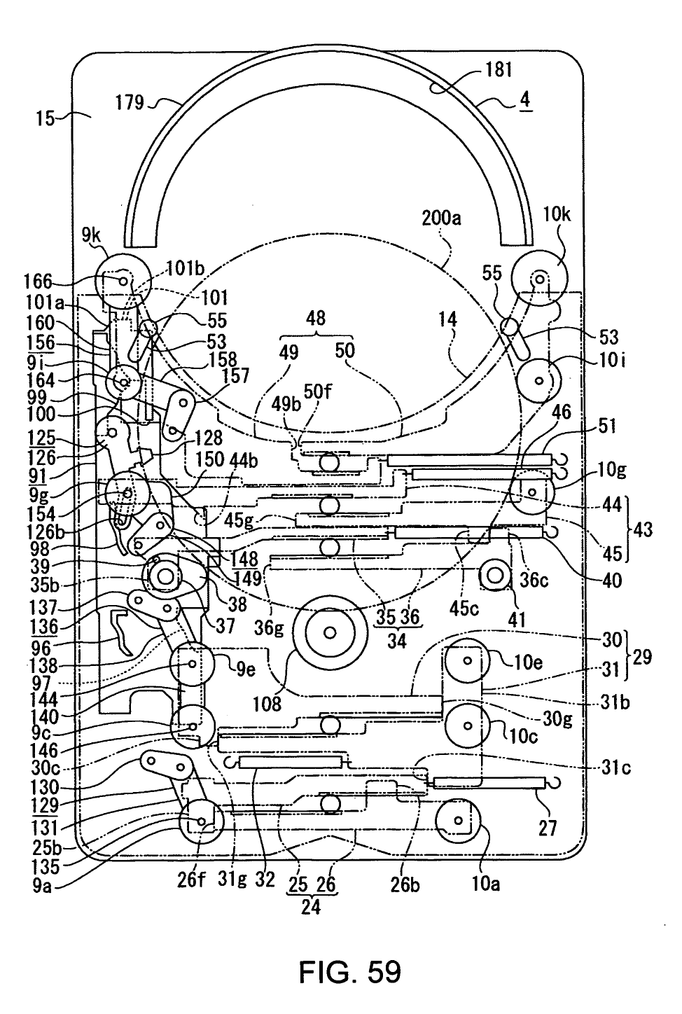

When the disc-shaped recording medium 200a is further pulled in, the outer peripheral surface of the disc-shaped recording medium 200a comes into contact with the fifth feed roller 9i and the fifth feed member 10i. Then, the disc-shaped recording medium 200a is transported towards the stocker 4 by the rotation of the fourth feed roller 9g and the fifth feed roller 9i (see FIG. 59). At this time, the drive slider 44 and the driven slider 45 of the fourth sliding means 43 slide in the directions in which they contact each other by the force of the spring 46.

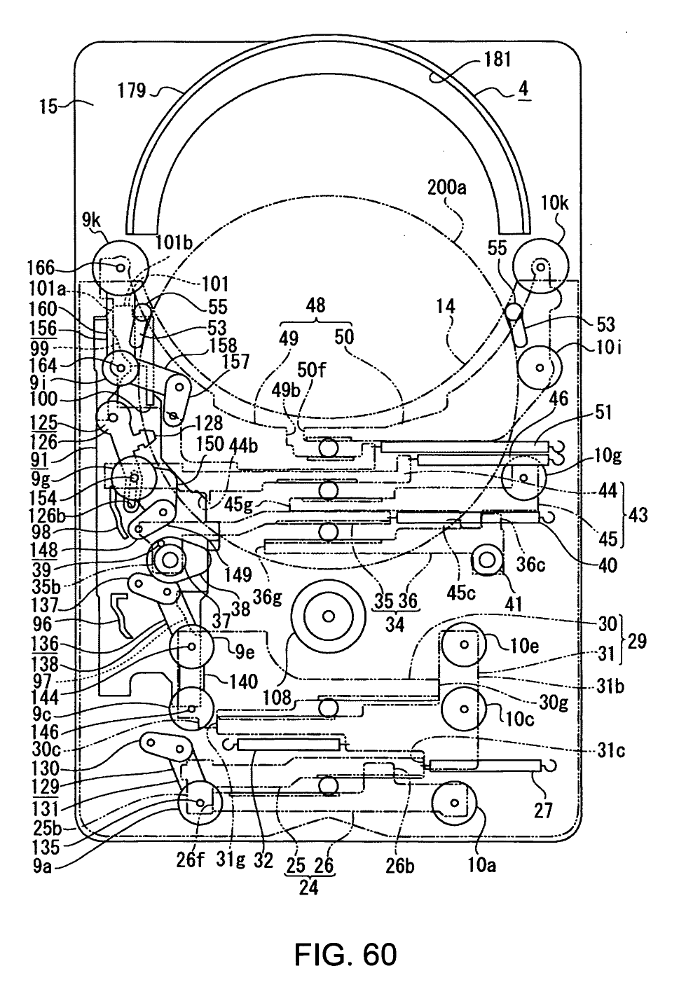

When the disc-shaped recording medium 200a is further pulled in, the drive slider 49 and the driven slider 50 of the fifth sliding means 48 slide away from each other so as to oppose the force of the spring 51. Then, the outer peripheral surface of the disc-shaped recording medium 200a is transported towards the stocker 4 only by the rotation of the fifth feed roller 9i (see FIG. 60). At this time, since the stoppers 55 and 55 come into sliding contact with the outer peripheral surface of the disc-shaped recording medium 200a, the movable levers 53 and 53 supported by the supporting chassis 14 are slightly rotated away from each other so as to oppose the force of the torsional coil springs 54 and 54.

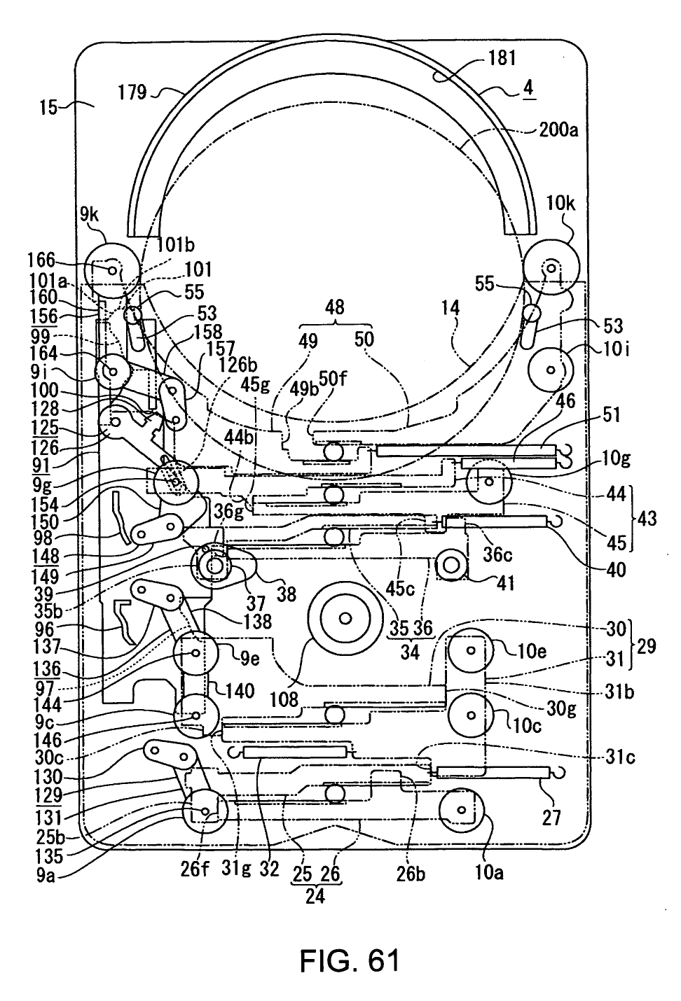

When the disc-shaped recording medium 200a is further pulled in, the outer peripheral surface of the disc-shaped recording medium 200a separates from the fifth feed roller 9i and the fifth feed member 10i. Then, the disc-shaped recording medium 200a is pulled in only by the rotation of the sixth feed roller 9k (see FIG. 61).

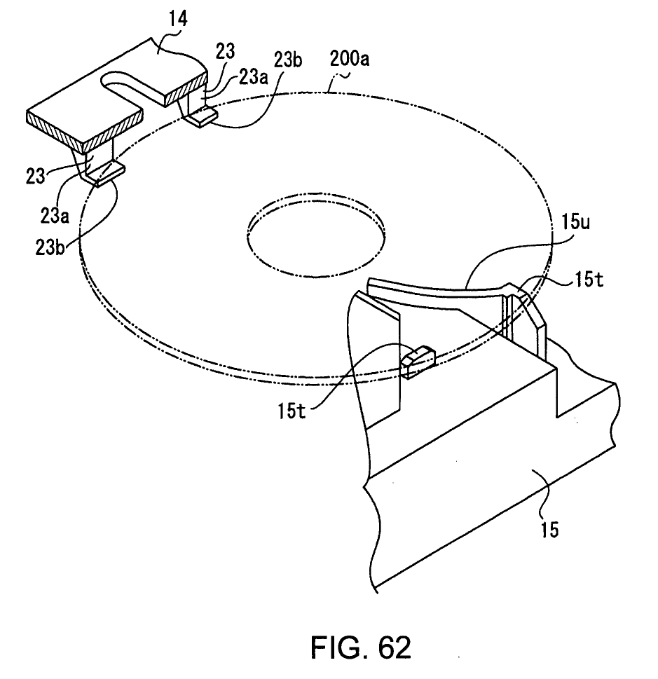

When the disc-shaped recording medium 200a is transported towards the stocker 4 from the reproducing unit 3 as mentioned above, the outer peripheral edge, that is, the portion other than the recording surface, of the disc-shaped recording medium 200a is moved while it is disposed close to or is in contact with the receivers 23b and 23b of the disc guides 23 and 23 disposed at the lower surface of the supporting chassis 14 and the disc guides 15t and 15t disposed at the upper surface of the base chassis 15 (see FIG. 62). Therefore, it is possible to more reliably transport the disc-shaped recording medium 200a by preventing the disc-shaped recording medium 200a from being tilted during the transportation. In addition, since the portion other than the recording surface of the disc-shaped recording medium 200a is in contact with the disc guides 23 and 23 and the disc guides 15t and 15t, it is possible to prevent damage to the recording surface.

In the disc loading device 1, since the disc guides 23 and 23 and the disc guides 15t and 15t support the disc-shaped recording medium 200a in the thickness direction, it is possible to reliably prevent tilting of the disc-shaped recording medium 200a.

In the disc loading device 1, although the disc guides 23 and 23 and the disc guides 15t and 15t are provided for preventing the tilting of the disc-shaped recording medium 200a that is being transported between the reproducing unit 3 and the stocker 4, disc guides may also be provided at the supporting chassis 14 and the base chassis 15 for preventing the tilting of the disc-shaped recording medium 200a that is being transported between the disc insertion slot 2a and the reproducing unit 3.

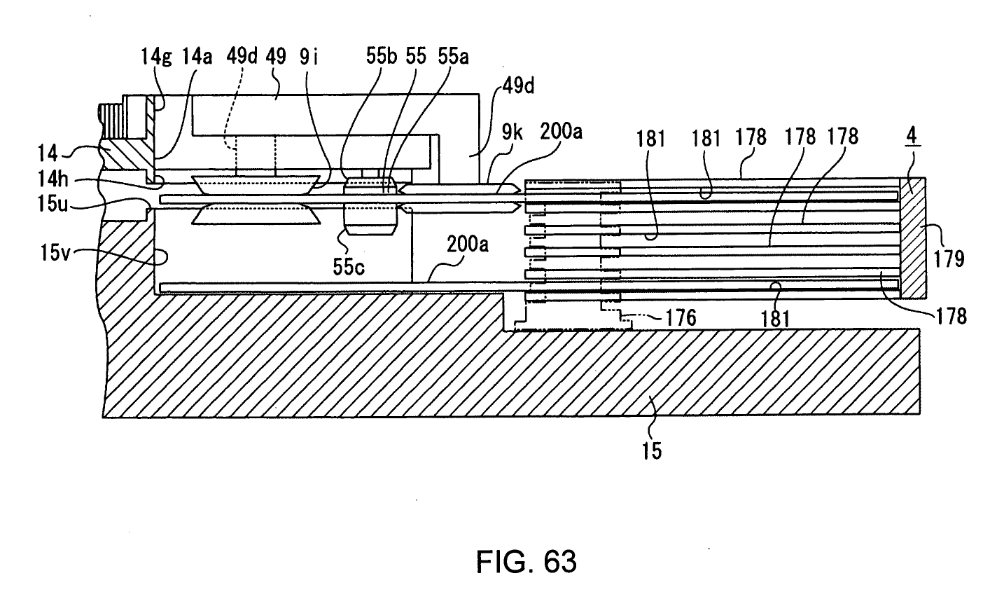

The disc-shaped recording medium 200a is accommodated in a disc accommodation portion 181 of the stocker 4 by being pulled in only by the rotation of the sixth feed roller 9k (see FIG. 63). When the disc-shaped recording medium 200a is accommodated in the disc accommodation portion 181, the rotation of the drive motor 110 is stopped.

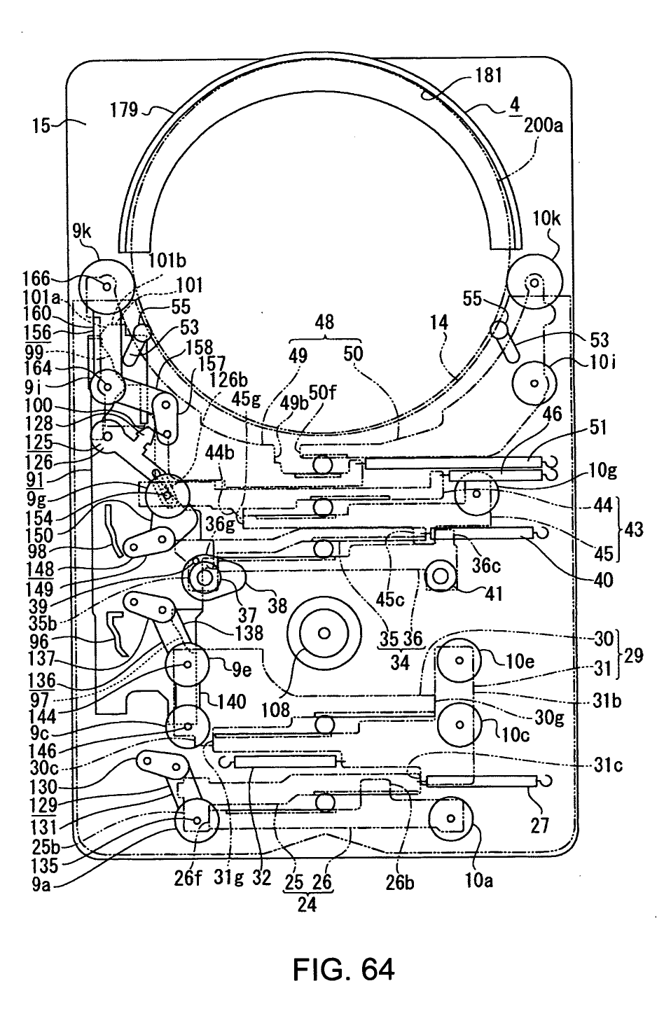

When the disc-shaped recording medium 200a is accommodated in the disc accommodation portion 181, the force of the spring 51 for biasing the drive slider 49 and the driven slider 50 towards each other causes the sixth feed roller 9k and the sixth feed member 10k to elastically contact the outer peripheral surface of the disc-shaped recording medium 200a (see FIG. 64). Therefore, the sixth feed roller 9k and the sixth feed member 10k prevent the disc-shaped recording medium 200a from becoming dislodged from the disc accommodation portion 181. At this time, the movable levers 53 and 53 are disposed at rotational ends in the directions in which they move towards each other, and the stoppers 55 and 55 are in contact with or are disposed close to the outer peripheral surface of the disc-shaped recording medium 200a.

When the disc-shaped recording medium 200a is accommodated in the disc accommodation portion 181 as described above, operating an eject knob (not shown) causes the disc-shaped recording medium 200a to be transported to the disc insertion slot 2a from the stocker 4 as follows. Since the transportation of the disc-shaped recording medium 200a from the stocker 4 to the disc insertion slot 2a is achieved by carrying out the above-described operation for transporting the disc-shaped recording medium 200a from the disc insertion slot 2a to the stocker 4 in the reverse order, it will be simply described.

When the eject knob is operated, the accommodation/take-out mode is set, and the drive motor 110 rotates in the other direction that is opposite to the aforementioned direction. When the drive motor 110 is rotated in the other direction, the feed rollers 9a, 9c, 9e, 9g, 9i, and 9k are rotated clockwise in plan view.

When the drive motor 110 is rotated, the rotation of the sixth feed roller 9k causes the disc-shaped recording medium 200a to be taken out from the disc accommodation portion 181 and to be transported towards the reproducing unit 3.

The disc-shaped recording medium 200a is transported to the reproducing unit 3 by being transferred from the sixth feed roller 9k and the sixth feed member 10k to the fourth feed roller 9g and the fourth feed member 10g and then to the third feed roller 9e and the third feed member 10e via the fifth feed roller 9i and the fifth feed member 10i. When the disc-shaped recording medium 200a is transported to the reproducing unit 3, the rotation of the drive motor 110 is temporarily stopped, after which the mode motor 61 is rotated in order to move the mode slider 91 backwards and set the transportation mode. When the transportation mode is set, as described above, the insertion cut portion 75a of the operation gear 74 is disposed to the left of the supporting shaft 135 supported at the drive slider 25 of the first sliding means 24 in order to set the unlocked state, and the restricting pin 89 is lowered in order to set the unrestricted state (see FIGS. 39 and 40).

When the transportation mode is set, the rotation of the mode motor 61 is stopped, and the drive motor 110 is re-rotated in the other direction in order to re-rotate the feed rollers 9a, 9c, 9e, 9g, 9i, and 9k clockwise in plan view.

The disc-shaped recording medium 200a protrudes from the front side of the disc insertion slot 2a by being transferred from the fourth feed roller 9g and the fourth feed member 10g to the first feed roller 9a and the first feed member 10a via the third feed roller 9e and the third feed member 10e and the second feed roller 9c and the second feed member 10c. By holding and pulling out the protruding disc-shaped recording medium 200a, the disc-shaped recording medium 200a can be taken out of the housing 200a.

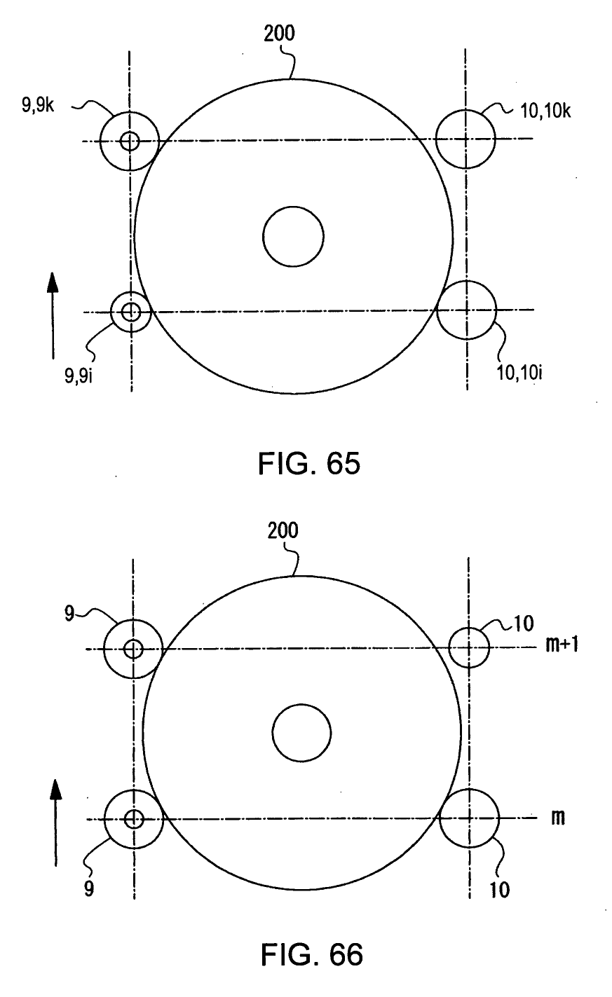

In the disc loading device 1, as mentioned above, the diameter of the portion of the fifth feed roller 9i that comes into contact with the outer peripheral surface of the disc-shaped recording medium 200a is smaller than those of the feed rollers 9a, 9c, 9e, and 9g and the feed members 10a, 10c, 10e, and 10g. Therefore, when the disc-shaped recording medium 200 is transported towards the stocker 4 from the reproducing unit 3, the outer peripheral surface of the disc-shaped recording medium 200 that has been moved towards the stocker 4 by the rotation of the fifth feed roller 9i reliably contacts the sixth feed roller 9k before it comes into contact with the sixth feed member 10k (see FIG. 65). In this way, since the outer peripheral surface of the disc-shaped recording medium 200 moved by the rotation of the fifth feed roller 9i is always in contact with the sixth feed roller 9k, for example, even if the diameter of the portion of the sixth feed roller 9k that comes into contact with the disc-shaped recording medium 200a changes due to wearing with time or the fifth feed roller 9i, the fifth feed member 10i, the sixth feed roller 9k, and the sixth feed member 10k are slightly displaced from their design positions due to, for example, dimensional manufacturing errors, the disc-shaped recording medium 200 is reliably transferred from the fifth feed roller 9i to the sixth feed roller 9k. Therefore, it is possible to more reliably transport the disc-shaped recording medium 200.

In the disc loading device 1, as described above, the diameter of the portion of the fifth feed roller 9i that comes into contact with the outer peripheral surface of the disc-shaped recording medium 200 is smaller than those of the feed rollers 9a, 9c, 9e, and 9g, and the feed members 10a, 10c, 10e, and 10g. In order to reliably transfer the disc-shaped recording medium 200, the transportation may be reliably performed as follows when, of the feed rollers 9a, 9c, 9e, 9g, 9i, and 9k and the feed members 10a, 10c, 10e, 10g, 10i, and 10k, the feed rollers 9 and 9 and the feed members 10 and 10 that surround the disc-shaped recording medium 200 are represented as an mth feed roller and an mth feed member if they transfer the disc-shaped recording medium and as an (m+1)th feed roller and an (m+1)th feed member if they receive the disc-shaped recording medium 200.

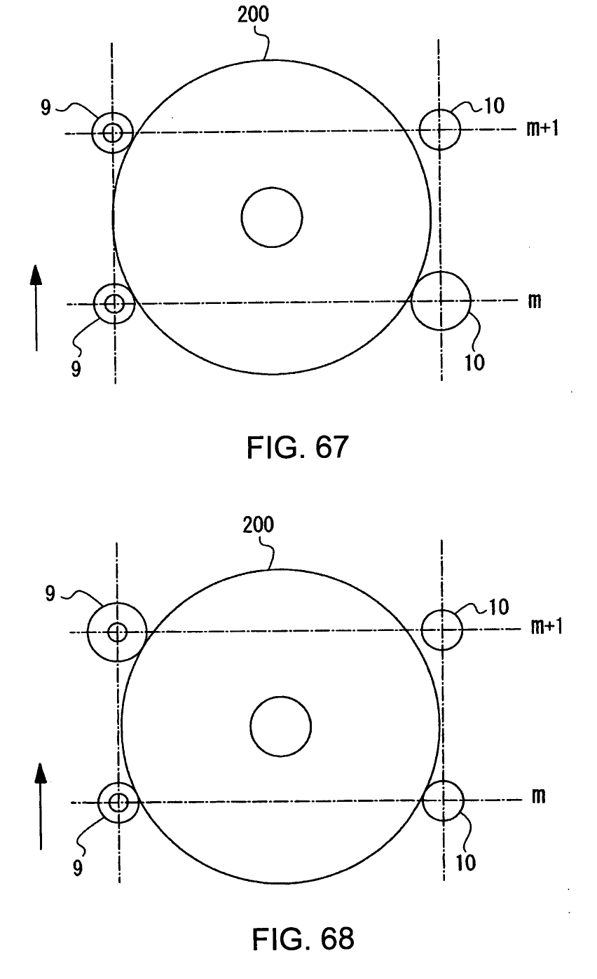

When the disc-shaped recording medium 200 is transported towards the stocker 4 from the disc insertion slot 2a, it is possible for the diameter of the (m+1)th feed member 10 to be smaller than the diameters of the mth feed roller 9, the (m+1)th feed roller 9, and the mth feed member 10 (see FIG. 66), or the diameter of the mth feed member 10 to be larger than the diameters of the mth feed roller 9, the (m+1)th feed roller 9, and the (m+1)th feed member 10 (see FIG. 67), or the diameter of the (m+1)th feed roller 9 to be larger than the diameters of the mth feed roller 9, the mth feed member 10, and the (m+1)th feed member 10 (see FIG. 68).

When the disc-shaped recording medium 200 is transported towards the disc insertion slot 2a from the stocker 4, it is possible for the diameter of the mth feed roller 9 to be smaller than the diameters of the (m+1)th feed roller 9, the mth feed member 10, and the (m+1)th feed member 10, or the diameter of the (m+1)th feed member 10 to be smaller than the diameters of the mth feed roller 9, the (m+1)th feed roller 9, and the mth feed member 10, or the diameter of the (m+1)th feed roller 9 to be larger than the diameters of the mth feed roller 9, the (m+1)th feed member 10, and the mth feed member 10, or the diameter of the mth feed member 10 to be larger than the diameters of the mth feed roller 9, the (m+1)th feed roller 9, and the (m+1)th feed member 10.

Even if the diameters are as mentioned above, the mth feed roller 9 and the (m+1)th feed roller 9 reliably contact the outer peripheral surface of the disc-shaped recording medium 200, so that it is possible to reliably transport the disc-shaped recording medium 200.

As mentioned above, the diameters of the feed rollers 9 and 9 and the feed members 10 and 10 that surround the disc-shaped recording medium 200 that is being transported may be changed. When the feed roller 9, the feed member 10, the first restricting roller 37, and the second restricting roller 42 are disposed so as to surround the disc-shaped recording medium 200 that is being transported, in order to eliminate the problem that the disc-shaped recording medium 200 cannot be transported when the feed roller 9 does not contact the outer peripheral surface of the disc-shaped recording medium 200 though the feed member 10, the first restricting roller 37, and the second restricting roller 42 contact the outer peripheral surface of the disc-shaped recording medium 200, it is possible for the feed roller 9 to always contact the outer peripheral surface of the disc-shaped recording medium 200 by changing the diameter of the first restricting roller 37 or the second restricting roller 42.

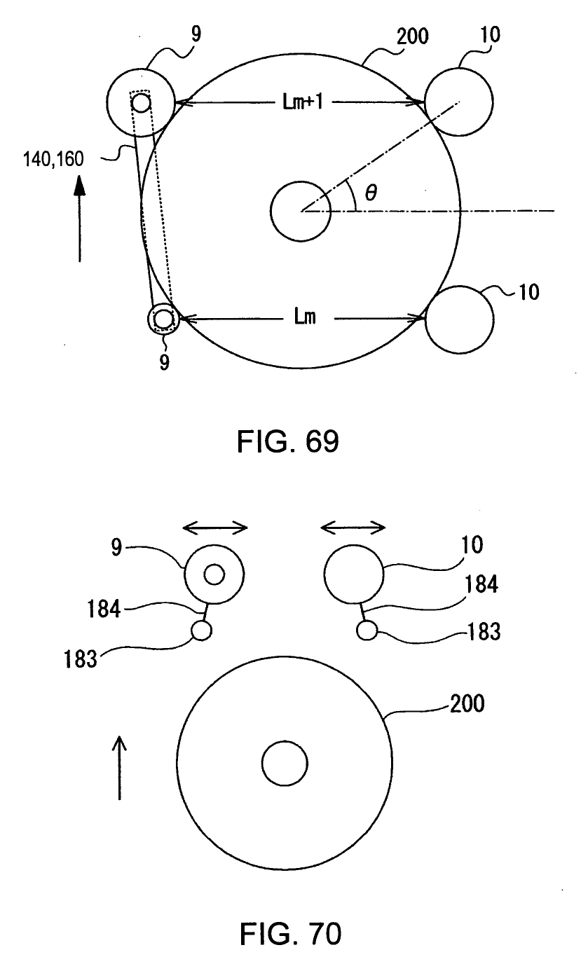

When, as described above, the diameter of at least one of the feed rollers 9 or the feed members 10 is different from those of the remaining feed rollers 9 and the feed members 10, it is possible to couple at least the mth feed roller 9 and the (m+1)th feed roller 9 or the mth feed member 10 and the (m+1)th feed member 10 by a predetermined linking means, tilt the linking means with respect to the transportation direction of the disc-shaped recording medium 200, and to make a distance Lm+1 between the (m+1)th feed roller 9 and feed member 10 greater than a distance Lm between the mth feed roller 9 and feed member 10 (see FIG. 69).

When the distance Lm+1 is greater than the distance Lm, as described above, the contact angle θ (see FIG. 37) when the disc-shaped recording medium 200 is transferred to the feed roller 9 and the feed member 10 is small. Therefore, the feed roller 9 and the feed member 10 do not slide with respect to the outer peripheral surface of the disc-shaped recording medium 200, so that the disc-shaped recording medium 200 can be reliably transported. In addition, the force for transporting the disc-shaped recording medium 200 is small, so that it is possible to use the drive motor 110 providing a small drive force.

In the disc loading device 1, for example, the second feed roller 9c and the third feed roller 9e are coupled by the second rotary lever 140 serving as the linking means, and the fifth feed roller 9i and the sixth feed roller 9k are coupled by the second rotary lever 160 serving as the linking means.

In the disc loading device 1, when the disc-shaped recording medium 200 is transferred from the mth feed roller 9 to the (m+1) th feed roller 9, and the feed speed of the mth feed roller 9 in the transportation direction is A and the feed speed of the (m+1)th feed roller 9 in the transportation direction is B, the feed speed B may be equal to or greater than the feed speed A. The feed speeds A and B may be set by, for example, changing the diameters of the gears for transmitting the drive force of the drive motor 110 to the feed rollers 9 or controlling by a microcomputer.

By setting the feed speed B equal to or greater than the feed speed A in this way, when the disc-shaped recording medium 200 is transferred from the feed roller 9 to the next feed roller 9, the rotation of the receiving feed roller 9 does not become a load on the feed operation of the transferring feed roller 9, so that the transportation efficiency can be increased.

In the disc loading device 1, as described above, when the drive slider 25 and the driven slider 26 of the first sliding means 24 slide away from each other so as to oppose the force of the spring 27 by the insertion of the disc-shaped recording medium 200 from the disc insertion slot 2a, the pushing protrusion 26b of the driven slider 26 pushes the push protrusion 31c of the driven slider 31 of the second sliding means 29. When the drive slider 25 and the driven slider 26 slide, the drive slider 30 and the driven slider 31 slide away from each other (see FIG. 48). Therefore, when the disc-shaped recording medium 200 contacts the second feed roller 9c, the third feed roller 9e, the second feed member 10c, and the third feed member 10e, supported by the drive slider 30, the distance between the second feed roller 9c and the second feed member 10c and the distance between the third feed roller 9e and the third feed member 10e are large, and the contact angle θ (see FIG. 37) is small. Therefore, the second feed roller 9c, the third feed roller 9e, the second feed member 10c, and the third feed member 10e do not slide with respect to the outer peripheral surface of the disc-shaped recording medium 200, so that it is possible to reliably transport the disc-shaped recording medium 200. In addition, since the force for transporting the disc-shaped recording medium 200 is small, it is possible to use the drive motor 110 providing a small drive force. Further, when the disc-shaped recording medium 200 is transported, the feed roller 9 and the feed member 10, which are disposed on the left and right, move away from each other in accordance with the transportation position of the disc-shaped recording medium 200, so that it is possible to increase the distances between the feed rollers 9 and between the feed members 10 in the transportation direction.

Therefore, it is possible to reduce the number of parts accordingly.

In the disc loading device 1, although the sliding of the drive slider 25 and the driven slider 26 causes the drive slider 30 and the driven slider 31 to slide away from each other, it is also possible for the sliding of transferring drive sliders 25, 30, 44, and 49, first slider 35, driven sliders 26, 31, 45, and 50, and second slider 36, which transfer the disc-shaped recording medium 200 in the transportation direction, to cause sliding of receiving drive sliders 25, 30, 44, and 49 and driven sliders 26, 31, 45, and 50, which receive the disc-shaped recording medium 200 in the transportation direction.

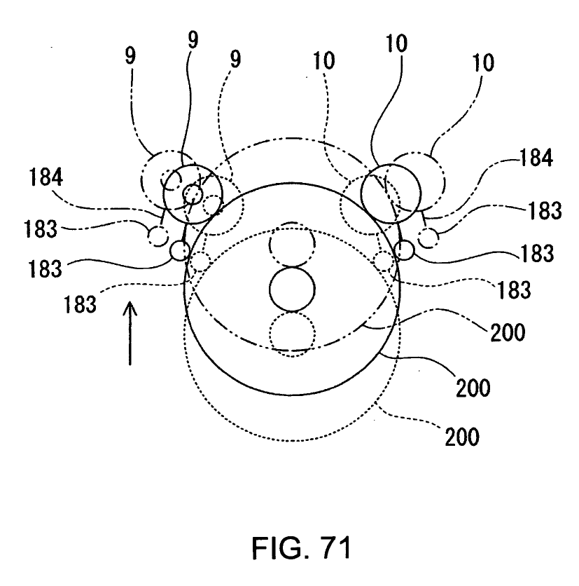

Although, in the foregoing description, the sliding of the transferring drive sliders 25, 30, 44, and 49, first slider 35, driven sliders 26, 31, 45, and 50, and second slider 36, which transfer the disc-shaped recording medium 200, causes the receiving drive sliders 25, 30, 44, and 49 and driven sliders 26, 31, 45, and 50, which receive the disc-shaped recording medium 200, to slide away from each other, the following is possible. In this example, a pair of operating members 183 and 183 are used to slide the receiving driven sliders 26, 31, 45, and 50 and the drive sliders 25, 30, 44, and 49, which receive the disc-shaped recording medium 200, away from each other (see FIGS. 70 and 71).

The operating members 183 and 183 are, for example, in the form of round shafts connected to the feed roller 9 and the feed member 10 through connectors 184 and 184. The operating members 183 and 183 are disposed closer to the disc-shaped recording medium 200 being transported than the feed roller 9 and the feed member 10 (see FIG. 70). When the disc-shaped recording medium 200 is being transported, the outer peripheral surface of the disc-shaped recording medium 200 first comes into contact with the operating members 183 and 183 (see dotted lines in FIG. 71). When the disc-shaped recording medium 200 is further transported, the outer peripheral surface of the disc-shaped recording medium 200 pushes the operating members 183 and 183, causing the operating members 183 and 183 and the feed roller 9 and the feed member 10 to move away from each other. This causes the drive slider and the driven slider to slide away from each other, so that the disc-shaped recording medium 200 is in contact with the feed roller 9, the feed member 10, and the operating members 183 and 183 (see solid lines in FIG. 71). When the disc-shaped recording medium 200 is further transported, its outer peripheral surface separates from the operating members 183 and 183 and pushes the feed roller 9 and the feed member 10 away from each other. The disc-shaped recording medium 200 is transported by the rotation of the feed roller 9 (see alternate long and two short dash lines in FIG. 71).

In this way, even if the receiving drive slider and the driven slider slide away from each other by the operating members 183 and 183, when the disc-shaped recording medium 200 contact the feed roller 9 and the feed member 10, the distance between the feed roller 9 and the feed member 10 is large and the contact angle θ (see FIG. 37) is small. Therefore, it is possible to reliably transport the disc-shaped recording medium 200 and to use the drive motor 110 providing a small drive force.

In the disc loading device 1, when the diameters of the mth feed roller 9 and the (m+1)th feed roller 9 are different, and the rotating speeds per unit time of the mth feed roller 9 and the (m+1)th feed roller 9 to be different, it is possible for the speed in the transportation direction to be constant when the disc-shaped recording medium 200 is being transferred from the mth feed roller 9 to the (m+1)th feed roller 9. In this case, it is possible to reduce the load on the feeding operation of the transferring feed roller 9 during the transfer and to increase the transportation efficiency with simple means. In addition, since the diameters of the feed rollers 9 are different, it is possible to increase the design freedom and to reduce the size of the disc loading device 1 by reducing the diameter of the feed roller 9.

In the disc loading device 1, as described above, when the sliding means 24, 29, 34, 43, and 48 slide during the transportation, portions of the springs 27, 32, 40, 46, and 51 expand or contact in the spaces of movement of the sliding means 24, 29, 34, 43, and 48. Therefore, spaces specially for expanding and contracting the springs 27, 32, 40, 46, and 51 are not required, so that it is possible to reduce the size of the disc loading device 1 by effectively using the space.

Since the springs 27, 32, 40, 46, and 51 are tightly stretched between the supporting chassis 14 and the respective sliders 25, 31, 35, 44, and 49, it is possible to reduce the stretching and contraction amounts of the springs 27, 32, 40, 46, and 51 compared to the case in which the springs 27, 32, 40, 46, and 51 are stretched tightly between the sliders 25 and 26, between the sliders 30 and 31, between the sliders 35 and 36, between the sliders 44 and 45, and between the sliders 49 and 50, respectively. Therefore, it is possible to increase the freedom with which springs are selected and to increase the design freedom.

Since the springs 27, 46, and 51 are supported at the drive sliders 25, 44, and 49 supporting the feed rollers 9a, 9g, 9i, and 9k, when the disc-shaped recording medium 200 contacts the feed rollers 9a, 9g, 9i, and 9k and the drive sliders 25, 44, and 49 slide, it is possible to reduce backlash between the pinions 28, 47, and 52 and the respective racks 25e, 44e, and 49f compared to the case in which the springs 27, 46, and 51 are supported at the driven sliders 26, 45, and 50.

In the second sliding means 29, the spring 32 may be supported at the drive slider 30 instead of at the driven slider 31.

In the disc loading device 1, four rotary mechanisms 129, 136, 148, and 156 are provided and made rotatable by the rotary member 130 and the rotary lever 131, the rotary member 137 and the rotary levers 138 and 140, the rotary member 149 and the rotary lever 15o, and the rotary member 157 and the rotary levers 158 and 160, respectively. Therefore, the feed rollers 9a, 9c, 9e, 9g, 9i, and 9k supported at the respective rotary mechanisms 129, 136, 148, and 156 can move in a direction substantially perpendicular to the transportation direction of the disc-shaped recording medium 200, so that the feed rollers 9 and the feed members 10 can nip the disc-shaped recording medium 200 from opposite sides at an angle of 180 degrees from each other.

In the rotary mechanisms 129, 136, 148, and 156, the drive force of the drive motor 110 is transmitted to the feed rollers 9a, 9c, 9e, 9g, 9i, and 9k via the transmission gears 133 and 134, the transmission gears 142, 143, 145, 145, and 145, the transmission gears 152 and 153, and the transmission gears 162, 162, 165, 165, and 165, respectively. Therefore, the drive force is transmitted to all of the feed rollers 9a, 9c, 9e, 9g, 9i, and 9k by using one drive motor 110, so that it is possible to simplify the mechanisms and to reduce the number of parts.

In the disc loading device 1, the four rotary mechanisms 129, 136, 148, and 156 are provided, and torques are generated in predetermined directions at the rotary levers 131, 138, 140, 150, 158, and 160 in accordance with the rotational directions of the fulcra gears 115, the transmission gears 133 and 134, the transmission gears 142, 143, 145, 145, and 145, the transmission gears 152 and 153, and the transmission gears 162, 163, 165, 165, and 165, and the relationship between the positions of the rotary member 130 and the rotary lever 131, the rotary member 137 and the rotary levers 138 and 140, the rotary member 149 and the rotary lever 150, and the rotary member 157 and the rotary levers 158 and 160.

In the state in which the disc-shaped recording medium 200 is transported towards the stocker 4 from the disc insertion slot 2a, when the outer peripheral surface of the disc-shaped recording medium 200 that is being transported contacts the feed rollers 9, the contact of the disc-shaped recording medium 200 is a load on the rotations of the feed rollers 9, so that the following torques are generated. The direction of torque is clockwise at the rotary lever 131 of the first rotary mechanism 129 in plan view, is clockwise at the first rotary lever 138 and the second rotary lever 140 of the second rotary mechanism 136 in plan view, is counterclockwise at the rotary lever 150 of the third rotary mechanism 148 in plan view, and is counterclockwise at the first rotary lever 158 and the second rotary lever 160 of the fourth rotary mechanism 156 in plan view. Therefore, when the disc-shaped recording medium 200 is being transported towards the stocker 4 from the disc-shaped insertion slot 2a by the torques, moving forces are applied to the first feed roller 9a, the second feed roller 9c, and the third feed roller 9e in a direction in which they move away from the outer peripheral surface of the disc-shaped recording medium 200, and moving forces are applied to the fourth feed roller 9g, the fifth feed roller 9i, and the sixth feed roller 9k in a direction in which they move towards the outer peripheral surface of the disc-shaped recording medium 200.

In the state in which the disc-shaped recording medium 200 is transported towards the disc insertion slot 2a from the stocker 4, when the outer peripheral surface of the disc-shaped recording medium 200 that is being transported contacts the feed rollers 9, the contact of the disc-shaped recording medium 200 is a load on the rotations of the feed rollers 9, so that the following torques are generated. The directions of the torques are opposite to those mentioned above. By the torques, moving forces are applied to the first feed roller 9a, the second feed roller 9c, and the third feed roller 9e in a direction in which they move towards the outer peripheral surface of the disc-shaped recording medium 200, and moving forces are applied to the fourth feed roller 9g, the fifth feed roller 9i, and the sixth feed roller 9k in a direction in which they move away from the outer peripheral surface of the disc-shaped recording medium 200.

In the disc loading device 1, as described above, torques of predetermined directions are generated at the rotary levers 131, 138, 140, 150, 158, and 160 in accordance with the transportation direction of the disc-shaped recording medium 200, so that moving forces are applied to the feed rollers 9 in the direction in which they move away from the outer peripheral surface of the disc-shaped recording medium 200. When the moving forces applied to the feed rollers 9 in a direction in which they move away from the outer peripheral surface of the disc-shaped recording medium 200 is large, a predetermined friction force cannot be generated between the feed rollers 9 and the disc-shaped recording medium 200. This may hinder the transportation. Therefore, in the disc loading device 1, two means for producing predetermined friction forces, such as those described below, are used.

First means is used to reduce the rotational speeds of the feed rollers 9 by the first transmission gears 133, 142, 152, and 162 serving as reduction gears in the respective rotary mechanisms 129, 136, 148, and 156. By reducing the rotational speeds of the feed rollers 9, the torques generated when the disc-shaped recording medium 200 contacts the feed rollers 9 become small, so that the moving forces applied to the feed rollers 9 in a direction in which they move away from the outer peripheral surface of the disc-shaped recording medium 200 become small, thereby making it possible to generate predetermined friction forces between the feed rollers 9 and the disc-shaped recording medium 200.

Second means uses the biasing springs 147, 155, and 167 to push the feed rollers 9 at the rotary mechanisms 136, 148, and 156 against the outer peripheral surface of the disc-shaped recording medium 200 that is being transported. In this way, by pushing the feed rollers 9 against the outer peripheral surface of the disc-shaped recording medium 200 by the biasing springs 147, 155, and 167, it is possible to generate predetermined friction forces between the feed rollers 9 and the disc-shaped recording medium 200.

In the disc loading device 1, although a biasing spring is not disposed to push the feed roller 9a of the first rotary mechanism 129 against the outer peripheral surface of the disc-shaped recording medium 200, a biasing spring may be disposed to push the feed roller 9a against the outer peripheral surface of the disc-shaped recording medium 200.

(e) Reproducing Operation (Large-diameter Disc-shaped Recording Medium)

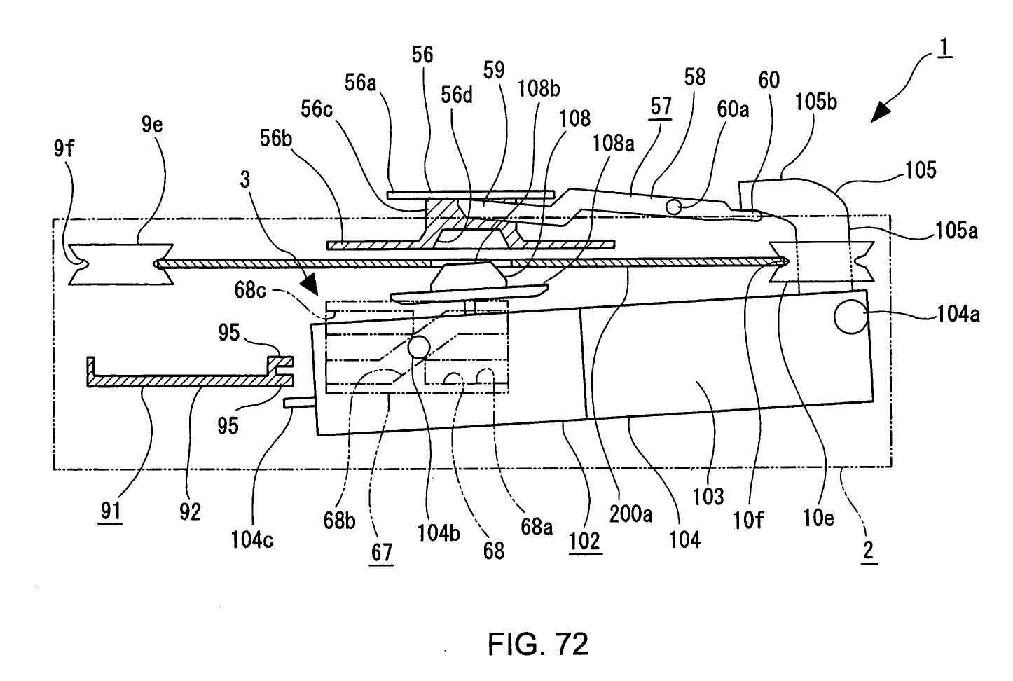

Next, the reproducing operation carried out by the reproducing unit 3 on a disc-shaped recording medium 200a inserted from the disc insertion slot 2a will be described (see FIGS. 72 to 80).

When an information signal recorded on the disc-shaped recording medium 200a is to be reproduced, a reproduction knob (not shown) is operated. When the reproduction knob is operated, the aforementioned transportation mode is set. In the transportation mode, when the disc-shaped recording medium 200a is inserted from the disc insertion slot 2a, the disc-shaped recording medium 200a is transported to the reproducing unit 3 by the same operation as that carried out for transporting the disc-shaped recording medium 200a from the disc insertion slot 2a to the stocker 4 (see FIGS. 47 to 53).

When the disc-shaped recording medium 200a is transported to the reproducing unit 3, the rotation of the drive motor 110 is stopped. When the disc-shaped recording medium 200a has been transported to the reproducing unit 3, the third feed roller 9e, the fourth feed roller 9g, the first restricting roller 37, the third feed member 10e, the fourth feed member log, and the second restricting roller 41 contact the outer peripheral surface of the disc-shaped recording medium 200a, and the center hole of the disc-shaped recording medium 200a is disposed substantially directly above the disc table 108 and is held at a location where it can be mounted to the disc table 108 (see FIG. 53).

When the rotation of the drive motor 110 is stopped, the mode motor 61 is rotated. The mode motor 61 is rotated in the direction causing the cam 67 to rotate in the rotational direction R2 shown in FIG. 39.

When the cam 67 rotates by the rotation of the mode motor 61, one of the operating pins 67b is inserted into the operation groove 70d of the Geneva driven gear 69, and the Geneva driven gear 69 rotates through an angle of 90 degrees, so that the mode slider 91 moves forward through the coupling gear 72 (see FIG. 56).

The mode motor 61 continues rotating. When the mode motor 61 continues rotating, the disc-shaped recording medium 200a that has been transported to the reproducing unit 3 is set in the chucking mode in which chucking or unchucking is carried out. The rotation of the cam 67 causes the cam protruding pin 104b of the base unit 102 to move upwards towards the upper horizontal portion 68c from the lower horizontal portion 68a defining the cam groove 68 via the inside of the oblique portion 68b (see FIG. 72). Since the cam protruding pin 104b moves upward towards the upper horizontal portion 68c from the inside of the oblique portion 68b, the base unit 102 rotates in the direction of upward movement of the disc table 108.

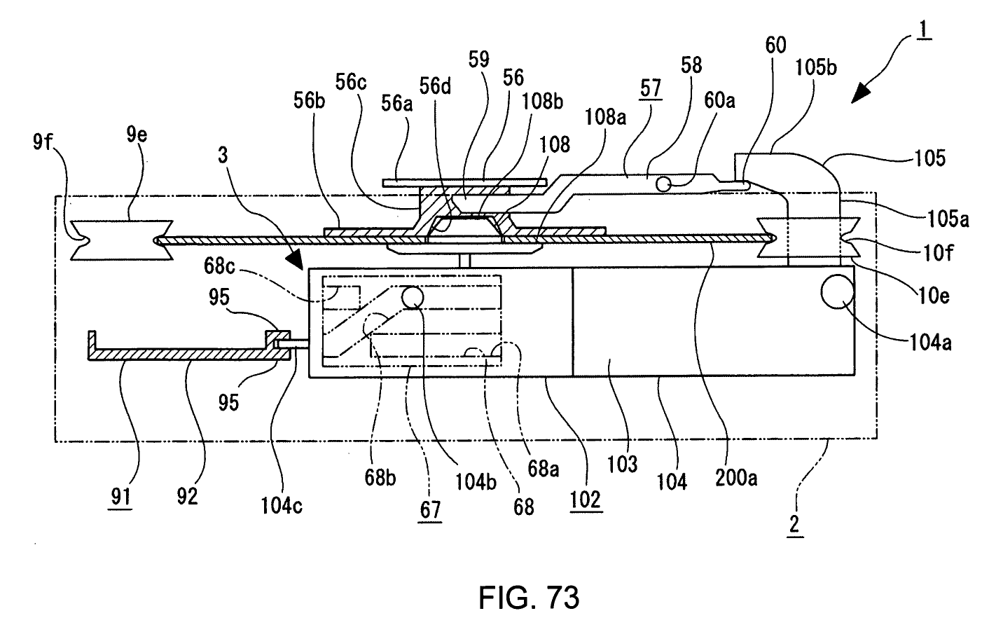

The cam 67 continues rotating by the rotation of the mode motor 61, causing the cam protruding pin 104b to move to the upper horizontal portion 68c defining the cam groove 68 (see FIG. 73). When the cam protruding pin 104b moves to the upper horizontal portion 68c defining the cam groove 68, the centering protrusion 108b of the disc table 108 is inserted into the center hole of the disc-shaped recording medium 200a and the insertion recess 56d of the chucking pulley 56. When the centering protrusion 108b of the disc table 108 is inserted in the insertion recess 56d of the chucking pulley 56, a magnetic metallic plate of the chucking pulley 56 is pulled by a magnet of the disc table 108, so that the disc-shaped recording medium 200a is clamped between the table body 108a of the disc table 108 and the stabilizer 56b of the chucking pulley 56, and is chucked (see FIG. 73). At this time, with the operation portion 60 being engaged with the engaging lever 105 of the base unit 102, the lifting portions 59 and 59 of the detaching member 57 supported at the supporting chassis 14 are disposed below the flange 56a of the chucking pulley 56.

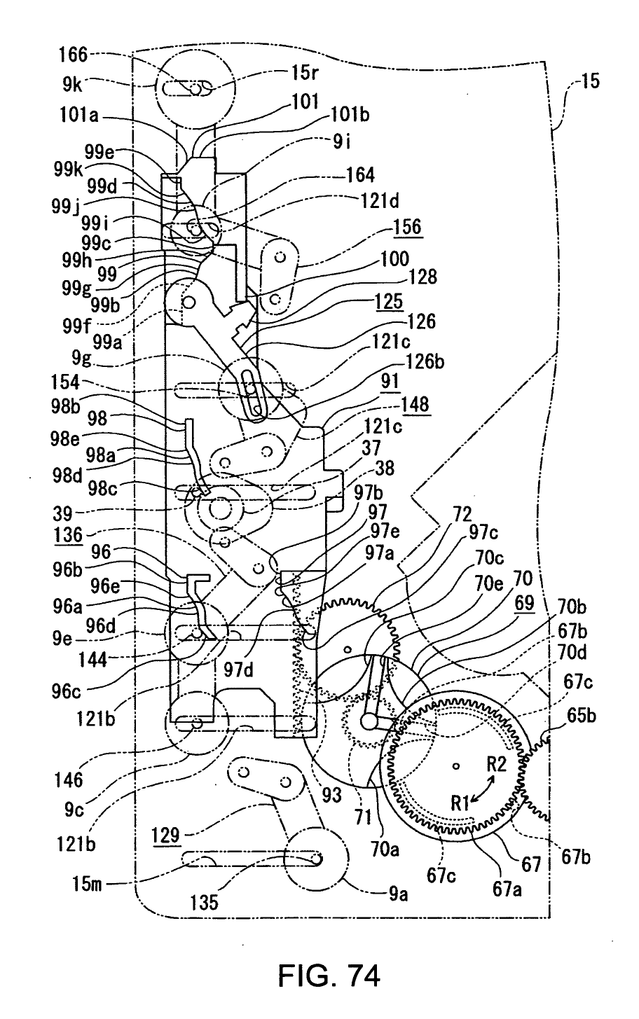

The mode motor 61 continues rotating, so that the cam protruding pin 104b moves in the upper horizontal portion 68c defining the groove 68 of the cam 67. When the mode motor 61 continues rotating, the other operating pin 67b is inserted into the operation groove 70e of the Geneva driven gear 69, and the Geneva driven gear 69 rotates again, so that the mode slider 91 moves further forward via the coupling gear 72 (see FIG. 74).

When the mode slider 91 moves forward, the supporting shaft 144 supporting the third feed roller 9e comes into sliding contact with the first cam wall 96, the guide shaft 39 passing through the receiving member 38 disposed under the first restricting roller 37 comes into sliding contact with the third cam wall 98, and the supporting shaft 164 supporting the fifth feed roller 9i comes into sliding contact with the fourth cam wall 99. At the same time, the operation portion 128 of the operating lever 125 supported by the subchassis 120 is pushed forwards by the pushing rib 100 (see FIG. 74).

At an initial stage in which the other operating pin 67b is inserted in the operation groove 70e of the Geneva driven gear 69, the operating pin 67b moves in the operation groove 70e towards the central portion of the Geneva driven gear 69 from the open end of the operation groove 70e. At this time, the supporting shaft 144 is in sliding contact with the sharply inclining front portion 96c of the first cam wall 96, the guide shaft 39 is in sliding contact with the sharply inclining front portion 98c of the third cam wall 98, and the supporting shaft 164 is in sliding contact with the sharply inclining front portion 99i of the fourth cam wall 99 (see FIG. 74).

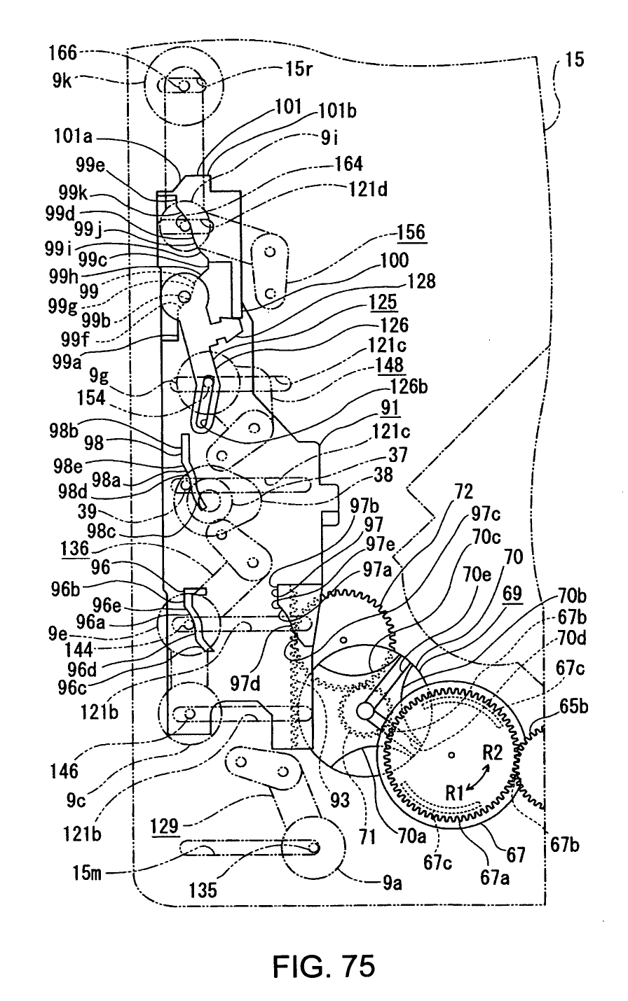

Next, at an intermediate stage in which the other operating pin 67b is inserted in the operation groove 70e of the Geneva driven gear 69, the operating pin 67b reciprocates at the central portion side of the Geneva driven gear 69 in the operation groove 70e. At this time, the supporting shaft 144 is in sliding contact with the gently inclining intermediate portion 96d of the first cam wall 96, the guide shaft 39 is in sliding contact with the gently inclining intermediate portion 98d of the third cam wall 98, and the supporting shaft 164 is in sliding contact with the gently inclining intermediate portion 99j of the fourth cam wall 99 (see FIG. 75).

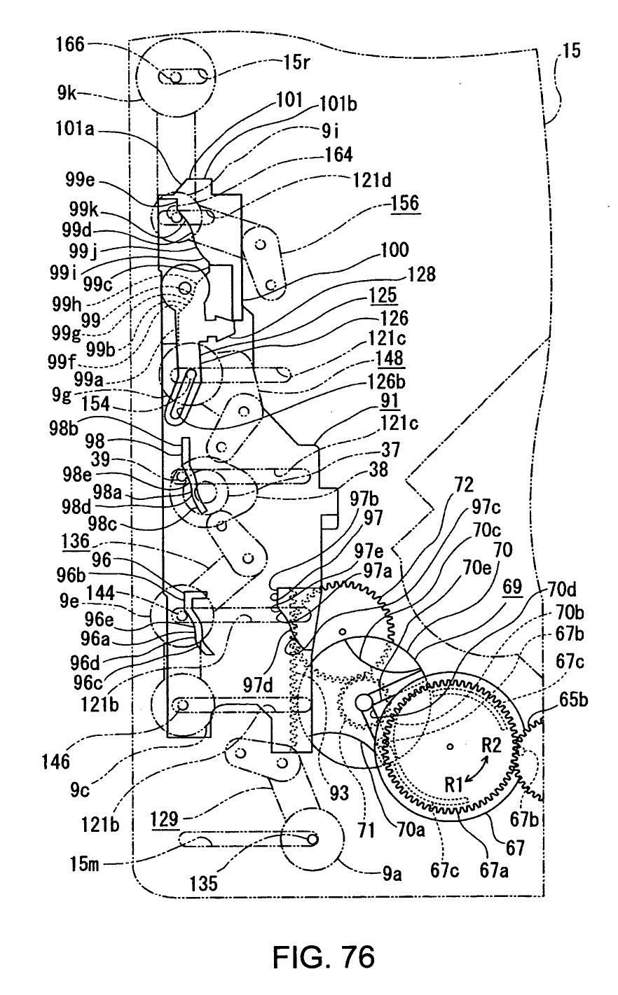

Next, in a final stage in which the other operating pin 67b is inserted in the operation groove 70e of the Geneva driven gear 69, the operating pin 67b moves towards the open end from the central portion side of the Geneva driven gear 69 in the operation groove 70e. At this time, the supporting shaft 144 is in sliding contact with the sharply inclining back portion 96e of the first cam wall 96, the guide shaft 39 is in sliding contact with the sharply inclining back portion 98e of the third cam wall 98, and the supporting shaft 164 is in sliding contact with the sharply inclining back portion 99k of the fourth cam wall 99 (see FIG. 76).

As described above, when the supporting shaft 144, the guide shaft 39, and the supporting shaft 164 come into sliding contact with the respective first cam wall 96, third cam wall 98, and fourth cam wall 99, the supporting shaft 144, the guide shaft 39, and the supporting shaft 164 are guided by the guide slits 121b, 121c, and 121d of the subchassis 120, respectively, and move leftwards. By moving the supporting shaft 144, the guide shaft 39, and the supporting shaft 164 leftwards, the drive slider 30 of the second sliding means 29, the first slider 35 of the third sliding means 34, and the drive slider 49 of the fifth sliding means 48 move leftwards, and the driven slider 31 of the second sliding means 29, the second slider 36 of the third sliding means 34, and the driven slider 50 of the fifth sliding means 48 move rightwards in synchronism. Therefore, the second feed roller 9c, the third feed roller 9e, the first restricting roller 37, the fifth feed roller 9i, and the sixth feed roller 9k move leftwards, and the second feed member 10c, the third feed member 10e, the second restricting roller 41, the fifth feed member 10i, and the sixth feed member 10k move rightwards.

When the mode slider 91 moves forward, at the same time, as described above, the operation portion 128 of the operating lever 125 supported at the subchassis 120 is pushed forward by the pushing rib 100. When the operation portion 128 of the operating lever 125 is pushed by the pushing rib 100, the operating lever 125 is rotated in the direction of a substantially forward movement of the operation portion 128, so that the supporting shaft 154 inserted and supported in the supporting hole 126b is guided by the guide slit 121c of the subchassis 120 and moves leftwards (see FIGS. 74 to 76). By moving the supporting shaft 154 leftwards, the drive slider 44 of the fourth sliding means 43 moves leftwards, and the driven slider 45 moves rightwards in synchronism. Therefore, the fourth feed roller 9g moves leftwards and the fourth feed member 10e moves rightwards.

As described above, the supporting shaft 154 moves leftwards by the rotation of the operating lever 125 caused by the operation portion 128 being pushed by the pushing rib 100. By moving the supporting shaft 154 by the operating lever 125 that is rotated on the rotary supporting portion 126a as a fulcrum as a result of pushing the operation portion 128 in this way, it is possible to separate the fulcrum (rotational supporting portion 126a) and a point where force is applied (operation portion 128) by a predetermined distance, so that the supporting shaft 154 can be moved with a small force, thereby making it possible to reduce the drive force of the mode motor 61 for moving the mode slider 91.

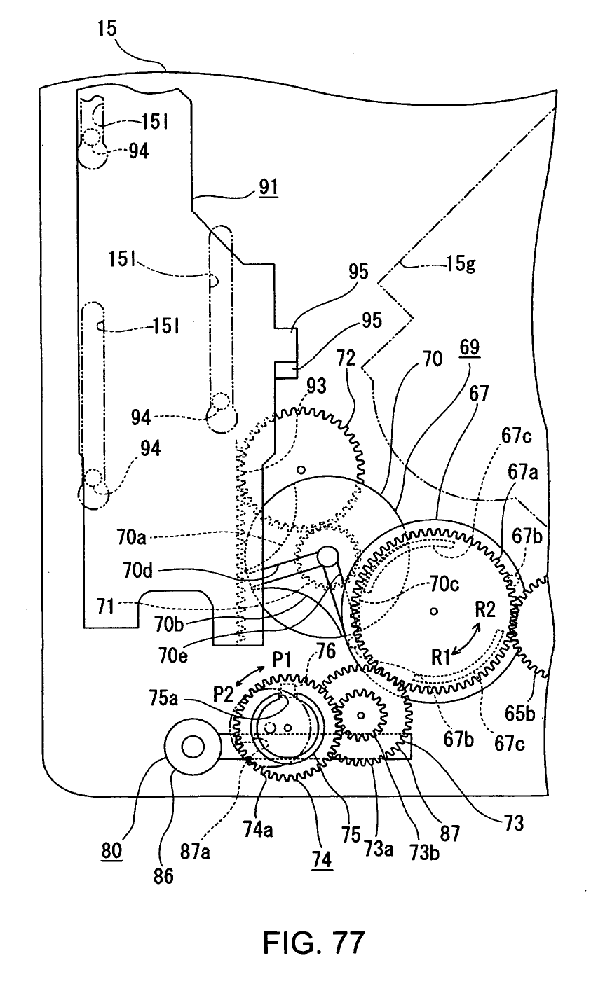

When the other operating pin 67b of the cam 67 is moved out of the operation groove 70e of the Geneva driven gear 69, the Geneva driven gear 69 is rotated through an angle of 90 degrees, so that the mode slider 91 is moved to the forward movement end (see FIG. 77). By moving the mode slider 91 to the forward movement end, the disc holding canceling mode in .which the holding of the chucked disc-shaped recording medium 200a by the feed rollers 9 and the feed members 10 is cancelled is set.

When the mode slider 91 is moved to the forward movement end, the supporting protrusions 95 and 95 of the mode slider 91 clamp the support portion 104c of the base unit 102 in the vertical direction (see FIG. 73). Therefore, the base unit 102 is stably held at the upper rotational end. Consequently, in reproducing an information signal from the disc-shaped recording medium 200a (the operation is described later), it is possible to prevent movement of the surface of the disc-shaped recording medium, and thus to increase the reliability of the reproducing operation.

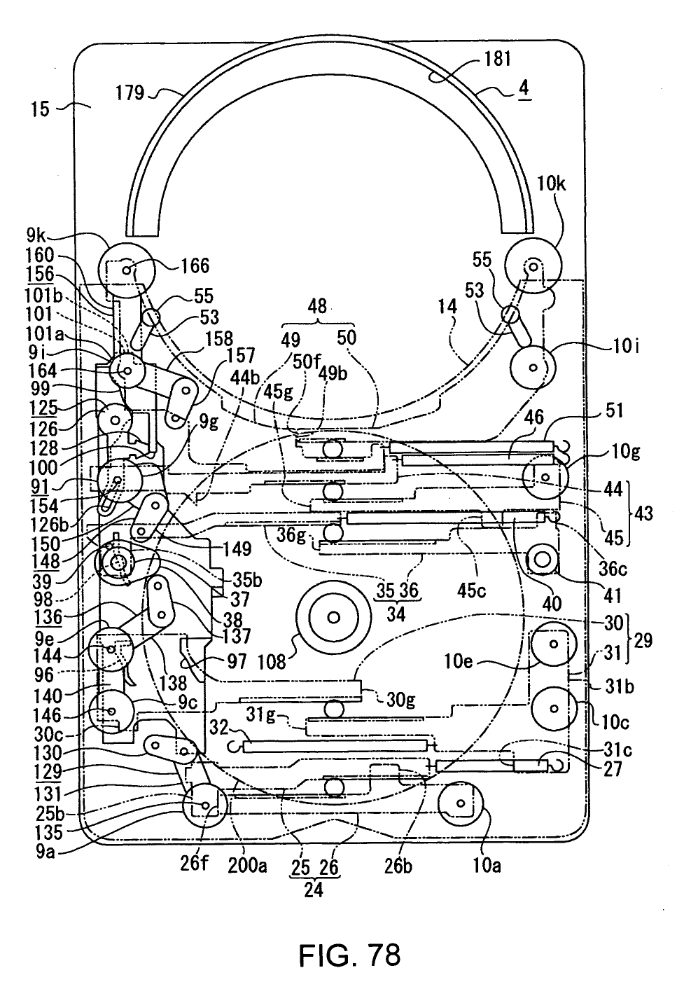

In the disc holding canceling mode, the supporting shaft 144 engages the linear portion 96b of the first cam wall 96, the guide shaft 39 engages the linear portion 98b of the third cam wall 98, the supporting shaft 164 engages the back linear portion 99e of the fourth cam wall 99, and the supporting shafts 154 and 166 are disposed at the leftward movement ends (see FIG. 78). Therefore, the third feed roller 9e, the fourth feed roller 9g, and the first restricting roller 37 are disposed at the leftward movement ends. At this time, the third feed member 10e, the fourth feed member log, and the second restricting roller 41 are disposed at the right movement ends.

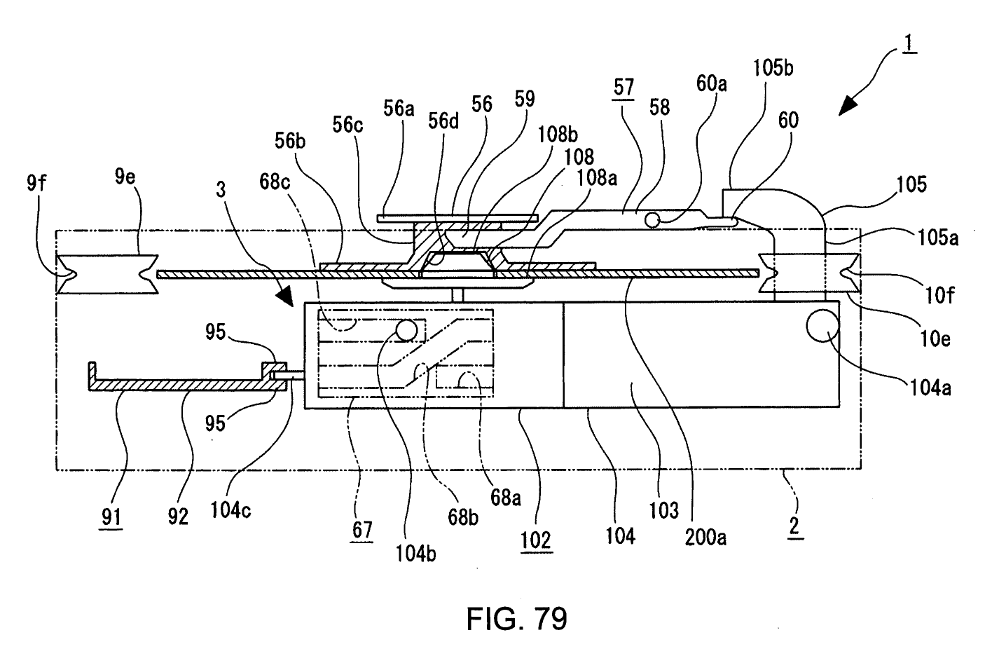

In this way, by disposing the third feed roller 9e, the fourth feed roller 9g, and the first restricting roller 37 at the leftward movement ends, they are separated from the outer peripheral surface of the disc-shaped recording medium 200a, and by disposing the third feed member 10e, the fourth feed member 10g, and the second restricting roller 41 at the right movement ends, they are separated from the outer peripheral surface of the disc-shaped recording medium 200a (see FIGS. 78 and 79). Therefore, the disc-shaped recording medium 200a is in a state in which it can smoothly rotate by the rotation of the disc table 108.

As described above, when the other operating pin 67b of the cam 67 is inserted in the operation groove 70e of the Geneva driven gear 69, in the initial and final stages, since the operating pin 67b is pushed by a portion disposed at the outer peripheral portion side of the Geneva driven gear 69 of the walls defining the operation groove 70e, the load exerted upon the operating pin 67b from the Geneva driven gear 69 is small; and, in the intermediate stage, since the operating pin 67b is pushed by a portion disposed at the central portion side of the Geneva driven gear 69 of the walls defining the operation groove 70e, the load exerted upon the operating pin 67b from the Geneva driven gear 69 is large.

Accordingly, in the disc loading device 1, in the initial and final stages, as described above, the supporting shaft 144, the guide shaft 39, and the supporting shaft 164 are brought into sliding contact with the sharply inclining front portion 96c or back portion 96e of the first cam wall 96, the sharply inclining front portion 98c or back portion 98e of the third cam wall 98, and the sharply inclining front portion 99i or back portion 99k of the fourth cam wall 99, respectively. In the intermediate stage, the supporting shaft 144, the guide shaft 39, and the supporting shaft 164 are brought into sliding contact with the gently inclining intermediate portion 96d of the first cam wall 96, the gently inclining intermediate portion 98d of the third cam wall 98, and the gently inclining intermediate portion 99j of the fourth cam wall 99, respectively. (See FIGS. 74 to 76.) Therefore, it is possible to reduce the load on the mode motor 61 by reducing the load on the operating pin 67b of the cam 67.

As described above, when the mode is switched to the accommodation/take-out mode from the transportation mode or the ascending/descending mode, one of the operating pins 67b of the cam 67 is inserted into the operation groove 70d of the Geneva driven gear 69 to rotate the Geneva driven gear 69 through an angle of 90 degrees. This causes the mode slider 91 to move, causing the supporting shaft 164 supporting the fifth feed roller 9i to come into sliding contact with the front inclined portion 99b of the fourth cam wall 99 of the mode slider 91. Even in this operation, in the initial and final stages in which the operating pin 67b is inserted in the operation groove 70e, the supporting shaft 164 is in sliding contact with the sharply inclining front portion 99f or back portion 99h. In the intermediate stage, the supporting shaft 164 is in sliding contact with the gently inclining intermediate portion 99g. Therefore, even in this operation, the load on the operating pin 67b of the cam 67 is reduced, so that it is possible to reduce the load on the mode motor 61.

In the disc loading device 1, as described above, when the operating pins 67b and 67b of the cam 67 are inserted in the respective operation grooves 70d and 70e of the Geneva driven gear 69, the Geneva driven gear 69 is rotated, causing the mode slider 91 to move in order to set each operation mode. Therefore, since each operation mode is set by stopping the mode slider 91 as a result of moving the operating pins 67b and 67b out of the operation grooves 70d and 70e, each operation mode is set if any one of the walls 70a, 70b, and 70c of the Geneva driven gear 69 is disposed in correspondence with either of the ribs 67c and 67c of the cam 67. Consequently, it is possible to increase the precision of the stopping position of the mode slider 91 because the stopping position of the mode slider 91 does not depend greatly upon the stopping position of the mode motor 61. In particular, when, as with the disc loading device 1, a device comprises a mechanism which transmits the drive force of the mode motor 61 to the mode slider 91 through a plurality of gears, such as the gear group 65, and which has a large backlash between the gears, controlling the movement of the mode slider 91 with the Geneva driven gear 69 is very effective in increasing the precision of the stopping position of the mode slider 91.

When the disc holding canceling mode is set, the disc table 108 is rotated by the rotation of a spindle motor and the optical pickup 107 is operated in order to perform a reproducing operation on the chucked disc-shaped recording medium 200a. In the reproducing operation, the disc-shaped recording medium 200a is irradiated with a laser beam emitted from a light-emitting device (not shown) of the optical pickup 107 through the objective lens 107a. The returning light impinges upon a light-receiving device (not shown) of the optical pickup 107 through the objective lens 107a in order to reproduce an information signal recorded on the disc-shaped recording medium 200a.

In the state in which the information signal has been reproduced from the aforementioned disc-shaped recording medium 200a, when the eject knob (not shown) is operated, the disc-shaped recording medium 200a is transported from the reproducing unit 3 to the disc insertion slot 2a in the following way. Since the operation for transporting the disc-shaped recording medium 200a from the reproducing unit 3 to the disc insertion slot 2a is similar to the operation for transporting it from the disc insertion slot 2a to the reproducing unit 3 described in “(d) Transporting Operation Between Disc Insertion Slot and Stocker,” the transporting operation will be simply described.

When the eject knob is operated, the mode motor 61 rotates in direction R1 shown in FIG. 77 and opposite to the aforementioned direction. When the cam 67 rotates in the direction R1 by the rotation of the mode motor 61, the mode slider 91 moves backwards, so that the supporting shaft 144 supporting the third feed roller 9e comes into sliding contact with the inclined portion 96a from the linear portion 96b of the first cam wall 96, the guide shaft 39 passing through the receiving member 38 disposed below the first restricting roller 37 comes into sliding contact with the inclined portion 98a from the linear portion 98b of the third cam wall 98, and the supporting shaft 164 supporting the fifth feed roller 9i comes into sliding contact with the intermediate linear portion 99c from the back linear portion 99e of the fourth cam wall 99. Here, at the same time, the pushing operation performed on the operation portion 128 of the operating lever 125 supported by the subchassis 120 by the pushing rib 100 is cancelled. Therefore, the second feed roller 9c, the third feed roller 9e, the fourth feed roller 9g, the fifth feed roller 9i, the sixth feed roller 9k, and the first restricting roller 37, and the respective second feed member 10c, third feed member 10e, fourth feed member 10g, fifth feed member 10i, sixth feed member 10k, and second restricting roller 41 are moved towards each other by the springs 32, 40, 46, and 51. Accordingly, the third feed roller 9e, the fourth feed roller 9g, the first restricting roller 37, the third feed member 10e, the fourth feed member 10g, and the second restricting roller 41 contact the outer peripheral surface of the disc-shaped recording medium 200a, and the disc-shaped recording medium 200a is held by the third feed roller 9e, the fourth feed roller 9g, the third feed member 10e, and the second feed member 10g (see FIG. 53).

At this time, the cam protruding pin 104b of the base unit 102 moves in the upper horizontal portion 68c defining the groove 68 of the cam 67 towards the inclined portion 68b.

The mode motor 61 continues rotating, so that the cam protruding pin 104b of the base unit 102 moves to the lower horizontal portion 68a from the upper horizontal portion 68c defining the groove 68 of the cam 67 through the inclined portion 68b. When the cam protruding pin 104b moves to the lower horizontal portion 68a from the upper horizontal portion 68c, the base unit 102 is rotated in the downward direction of movement of the disc table 108, so that the disc table 108 is disposed under the disc-shaped recording medium 200a.

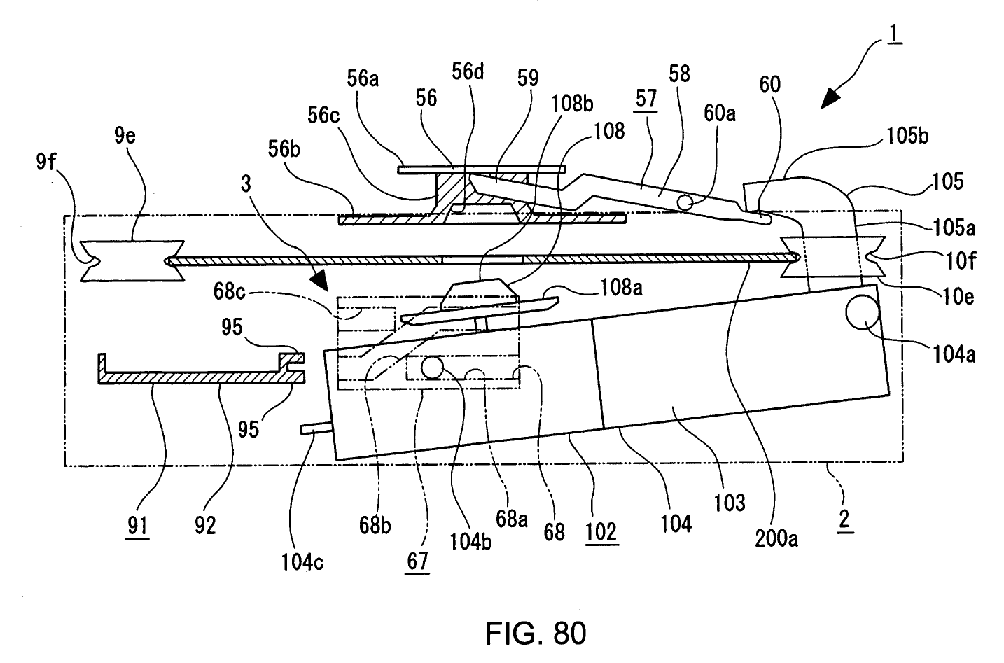

When the cam protruding pin 104b of the base unit 102 starts moving towards the inclined portion 68b from the upper horizontal portion 68c defining the groove 68 of the cam 67, the magnetic metallic plate of the chucking pulley 56 is attracted to the magnet of the disc table 108, so that the chucking pulley 56 tries to move downward by the rotation of the base unit 102. However, the engaging portion 105b of the engaging lever 105 pushes the operation portion 60 of the detaching member 57 by the rotation of the base unit 102 (see FIG. 80). Therefore, the detaching member 57 rotates on the support pins 60a and 60a as fulcra in the upward direction of movement of the lifting portions 59 and 59, so that the flange 56a of the chucking pulley 56 is lifted by the lifting portions 59 and 59.

By lifting the flange 56a by the lifting portions 59 and 59, the chucking pulley 56 is separated upward from the disc table 108 (see FIG. 80). In this way, since the chucking pulley 56 is forcefully separated upward from the disc table 108 by the detaching member 57 when the base unit 102 is rotating, it is possible to reliably unchuck the disc-shaped recording medium 200a.

The mode motor 61 continues rotating to move the mode slider 91 to the backward movement end, so that the transportation mode is set. When the transportation mode is set, as described above, the insertion cut portion 75a of the operating gear 74 is disposed to the left of the supporting shaft 135 supported at the drive slider 25 of the first sliding means 24, so that the unlocked state is set and the restricting pin 89 moves downward to set the unrestricted state (see FIGS. 39 and 40).

When the transportation mode is set, the rotation of the mode motor 61 is stopped, and the drive motor 110 rotates in the other direction in order to rotate the feed rollers 9a, 9c, 9e, 9g, 9i, and 9k again clockwise in plan view.

The disc-shaped recording medium 200a is transferred from the fourth feed roller 9g and the fourth feed member 10g to the first feed roller 9a and the first feed member 10a via the third feed roller 9e, the third feed member 10e, the second feed roller 9c, and the second feed member 10c, and protrudes forward from the disc insertion slot 2a. By holding and pulling out the protruding disc-shaped recording medium 200a, the disc-shaped recording medium 200a is taken out of the housing 2.

(f) Exchanging Operation

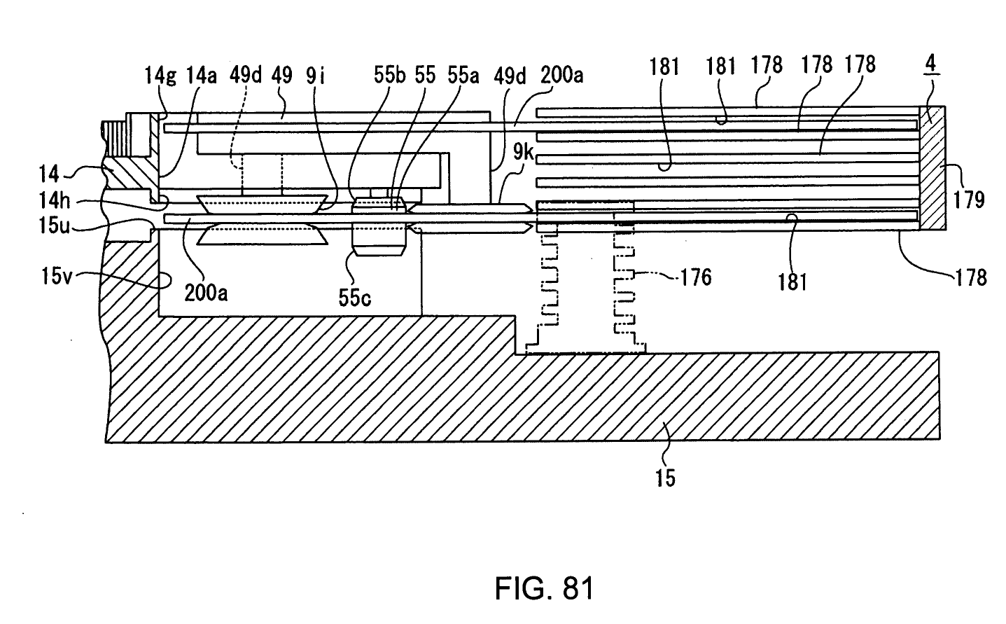

Next, the exchanging of a predetermined disc-shaped recording medium 200a accommodated in the stocker 4 and a disc-shaped recording medium 200a mounted to the disc table 108 of the reproducing unit 3 when at least one disc-shaped recording medium 200a is accommodated in the stocker 4 (see FIGS. 81 to 85) will be described.

As described above, when an information signal has been reproduced from the disc-shaped recording medium 200a in the reproducing unit 3, in order to carry out the exchanging operation, an exchange knob (not shown) is operated. At this time, the disc holding canceling mode is set. When the exchange knob is operated, the mode motor 61 is rotated in the direction causing the cam 67 to rotate in the direction R2 shown in FIG. 77. The chucking of the disc-shaped recording medium 200a by the disc table 108 and the chucking pulley 56 is cancelled by the same operation as that performed when the eject knob is operated (see FIG. 80).

In the disc loading device 1, when the disc-shaped recording medium 200a has been unchucked, the disc accommodating portion 181 that does not accommodate a disc-shaped recording medium 200a of the stocker 4 is positioned right behind the disc passage 182, that is, at the accommodation/take-out position. In the case in which a disc accommodating portion 181 that does not accommodate a disc-shaped recording medium 200a does not exist, it is possible to, for example, indicate that a disc accommodating portion 181 that does not accommodate a disc-shaped recording medium 200a does not exist on an indicator (not shown) of the disc loading device 1, so that the exchanging operation is not carried out, when the exchange knob is operated.

When the disc-shaped recording medium 200a is unchucked, the rotation of the mode motor 61 is temporarily stopped in order to stop the mode slider 91 at the substantially central portion of the movement range and to set the accommodation/take-out mode.

When the accommodation/take-out mode is set, the drive motor 110 is rotated, and, by an operation that is similar to that carried out when the accommodation knob is operated, the disc-shaped recording medium 200a is transported to the stocker 4 from the reproducing unit 3, and is accommodated in the disc accommodation portion 181 that is disposed at the accommodation/take-out position (see FIG. 81). When the disc-shaped recording medium 200a transported from the reproducing unit 3 is accommodated in the disc accommodating portion 181, the rotation of the drive motor 110 is stopped.

Since the disc-shaped recording media 200a accommodated in the respective disc accommodating portions 181 of the stocker 4 are placed on the shelves 178 of the stocker 4, they are movable in the direction in which they protrude from the disc accommodation portions 181 by, for example, vibration produced due to upward and downward movement of the stocker 4 and external disturbance.

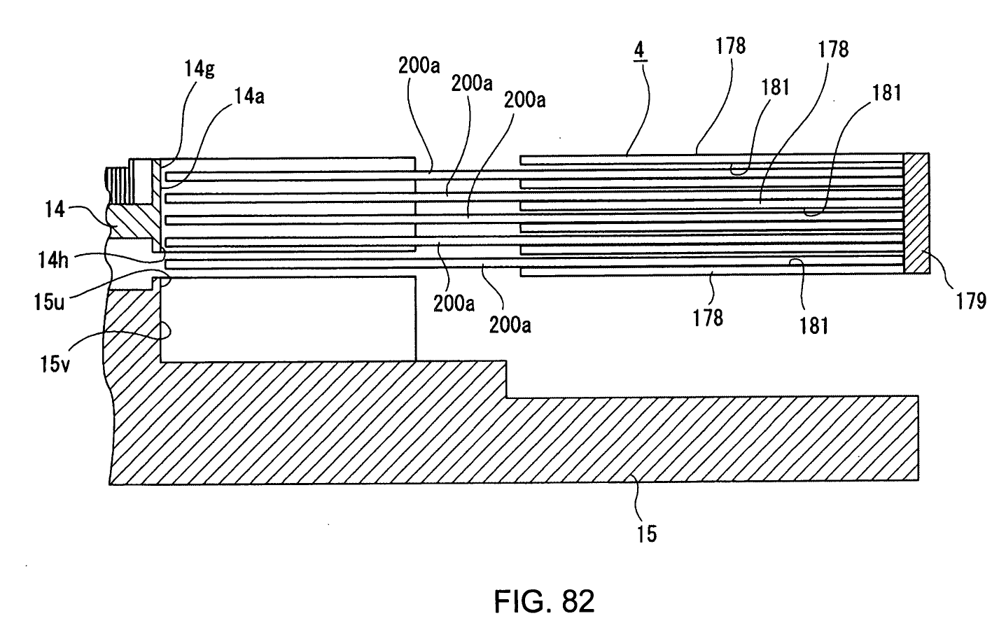

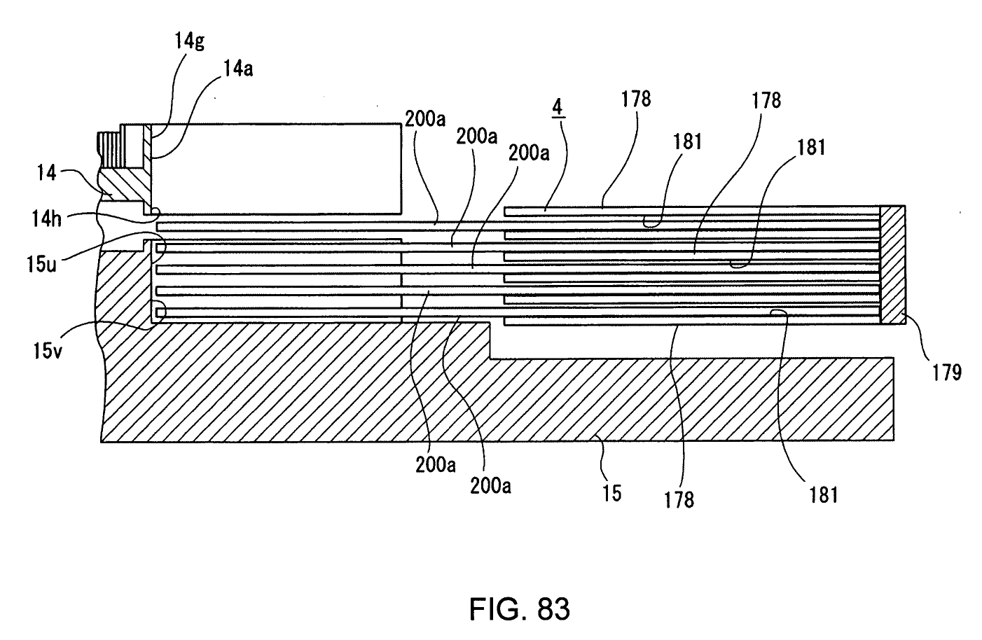

However, in the disc loading device 1, the dislodging preventing portions 14h and 14h at the supporting shaft 14 and the dislodging preventing portions 15u and 15v at the base chassis 15 are disposed close to the outer peripheral edges of the disc-shaped recording media 200a accommodated in the disc accommodating portions 181 and 181 in the range in which the stocker 4 moves upward and downward (see FIGS. 82 and 83). Therefore, the movement of the disc-shaped recording media 200a other than the disc-shaped recording medium 200a accommodated in the disc accommodating portion 181 at the accommodation/take-out position in the direction in which they protrude from the disc accommodating portions 181 is restricted. Consequently, the disc-shaped recording media 200a are prevented from being dislodged from the respective disc accommodating portions 181.

The movement of the disc-shaped recording medium 200a accommodated in the disc accommodating portion 181 at the accommodation/take-out position in the direction in which it protrudes from the disc accommodating portion 181 is restricted by the stoppers 55 and 55 supported by the movable levers 53 and 53. Therefore, it is possible to prevent the disc-shaped recording medium 200a from becoming dislodged from the disc accommodating portion 181.

Since the stoppers 55 and 55 are supported by the movable levers 53 and 53 rotatably supported at the supporting chassis 14, when the disc-shaped recording medium 200a is being transported between the reproducing unit 3 and the stocker 4, they come into sliding contact with the outer peripheral surface of the disc-shaped recording medium 200, and move away from each other. Thus, they do not hinder the transportation of the disc-shaped recording medium 200a. Therefore, the disc-shaped recording medium 200a can be properly transported.

When the rotation of the drive motor 110 is stopped, the ascending/descending motor 168 is rotated next. When the ascending/descending motor 168 is rotated, the rotary cams 176, 176, and 176 rotate in synchronism, so that the positions of the guide protrusions 179a, 179a, and 179a of the stocker 4 with respect to the cam groves 177, 177, and 177 change, thereby causing the stocker 4 to move upward or downward.

For example, when a predetermined disc-shaped recording medium 200a to be exchanged is accommodated in the uppermost disc accommodating portion 181, the stocker 4 is moved to the lower end of the movement range in order to position the disc-shaped recording medium 200a right behind the disc passage 182 (see FIG. 63).

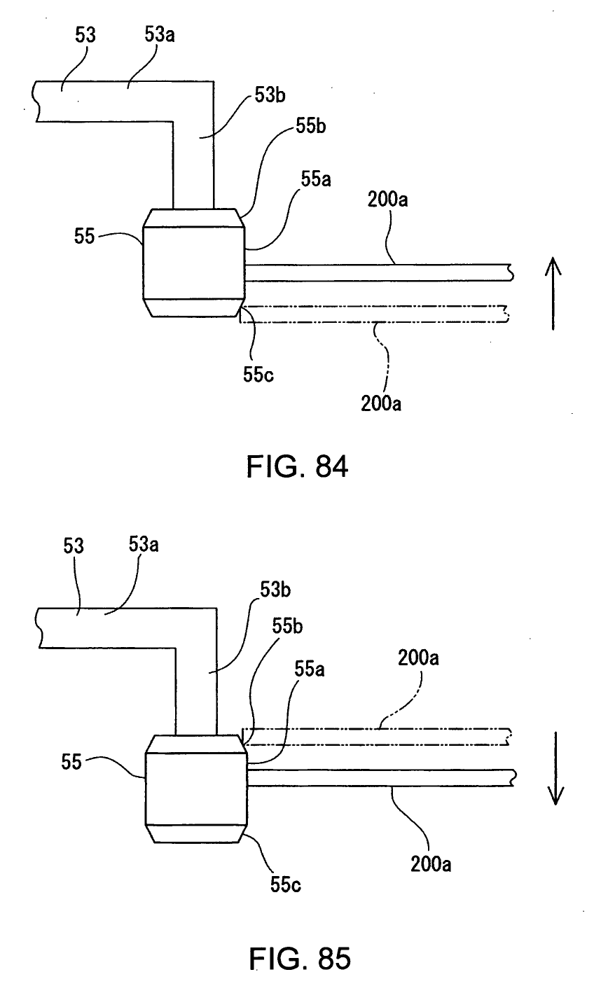

When the stocker 4 is moved upwards or downwards, the disc-shaped recording media 200a accommodated in the respective disc accommodating portions 181 are brought into sliding contact with the stoppers 55 and 55 supported by the movable levers 53 and 53, and are disposed as follows (see FIGS. 84 and 85).

When the stocker 4 is moved upwards or downwards, the outer peripheral edges of the disc-shaped recording media 200a disposed at the lower portions of the stoppers 55 and 55 come into sliding contact with the inclined guides 55c and 55c of the stoppers 55 and 55, and then with the peripheral surfaces 55a and 55a (see FIG. 84). In contrast, when the stocker 4 is moved downwards, the outer peripheral edges of the disc-shaped recording media 200a disposed at the upper portions of the stoppers 55 and 55 come into sliding contact with the inclined guide portions 55b and 55b of the stoppers 55 and 55, and then with the peripheral surfaces 55a and 55a (see FIG. 85). Therefore, the disc-shaped recording media 200a are aligned by the peripheral surfaces 55a and 55a of the stoppers 55 and 55.

Accordingly, in the disc loading device 1, when the stocker 4 is moved upward or downwards, the disc-shaped recording media 200a accommodated in the disc accommodating portions 181 are aligned by the stoppers 55 and 55. Therefore, at the accommodation/take-out position, the outer peripheral edge of the disc-shaped recording medium 200a can be disposed close to the holding groove 91 of the sixth feed roller 9k and the holding groove 10l of the sixth feed member 10k, so that the disc-shaped recording medium 200a can be properly and reliably taken out of the disc accommodating portion 181.

When the stocker 4 is moved upwards or downwards, the disc-shaped recording media 200a are in sliding contact with the stoppers 55 and 55. Therefore, the stoppers 55 and 55 do not hinder the upward and downward movements of the stocker 4.

In the disc loading device 1, the substantially cylindrical stoppers 55 and 55 are rotatably supported at the movable levers 53 and 53. Therefore, when the stoppers 55 and 55 contact the disc-shaped recording medium 200a that is being transported, the load on the transportation of the disc-shaped recording medium 200a is small, so that the disc-shaped recording medium 200a can be smoothly accommodated in and taken out of the disc accommodating portion 181.

When the stocker 4 is moved upwards or downwards to position a disc accommodating portion 181 accommodating a disc-shaped recording medium 200a to be exchanged at the accommodation/take-out position, the rotation of the ascending/descending motor 168 is stopped.

When the rotation of the ascending/descending motor 168 is stopped, the drive motor 110 is rotated again in order to transport the disc-shaped recording medium 200a to the reproducing unit 3 from the stocker 4 by the operation that is carried out when the eject knob is operated.

When the disc-shaped recording medium 200a is transported to the reproducing unit 3, the rotation of the drive motor 110 is stopped. Then, the mode motor 61 is rotated in order to chuck the disc-shaped recording medium 200a by the chucking pulley 56 and the disc table 108 by the same operation that is performed when the reproduction knob is operated (see FIG. 79).

When the disc-shaped recording medium 200a is chucked, the disc table 108 is rotated by the rotation of the spindle motor and the optical pickup 107 is operated in order to perform a reproducing operation on the chucked disc-shaped recording medium 200a.

(g) Reproducing Operation (Small-diameter Disc-shaped Recording Medium)

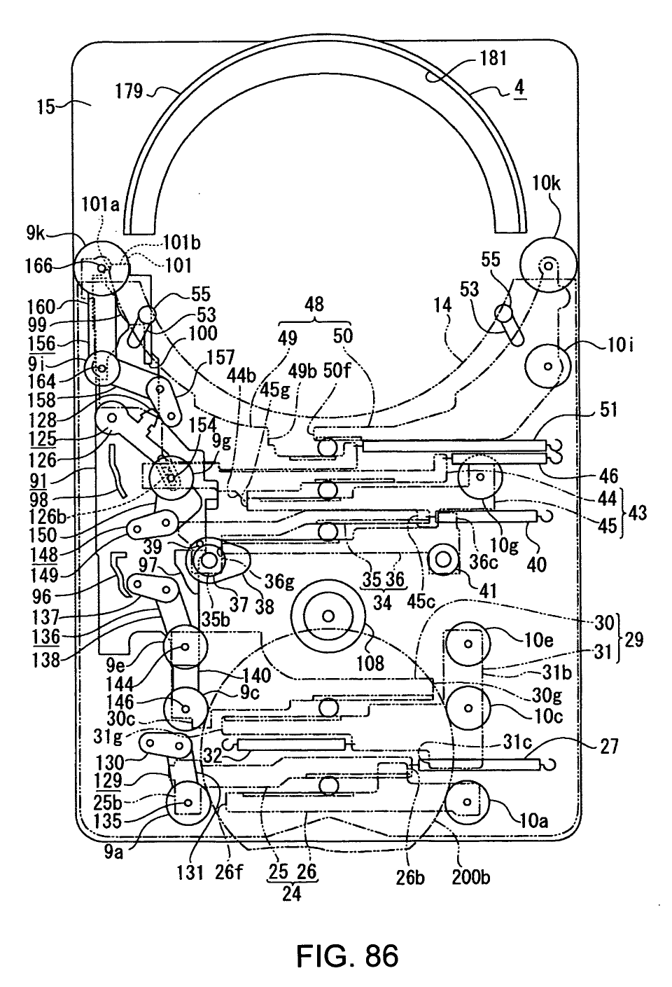

In the disc loading device 1, as described above, an information signal can be reproduced from a small-diameter disc-shaped recording medium 200b having a diameter of, for example, approximately 8 cm. Hereunder, the reproducing operation that is carried out on the disc-shaped recording medium 200b inserted from the disc insertion slot 2a by the reproducing unit 3 will be described (see FIGS. 86 to 90).

When an information signal recorded on the disc-shaped recording medium 200b is to be reproduced, the reproduction knob (not shown) is operated. When the reproduction knob is operated, the transportation mode is set. When the transportation mode is set, as described above, the insertion cut portion 75a of the operating gear 74 is positioned to the left of the supporting shaft 135 supported at the drive slider 25 of the first sliding means 24, so that the unlocked state is set, and the restricting pin 89 moves downward to set the unrestricted state (see FIGS. 39 and 40).

When the transportation mode is set, the drive motor 110 is rotated in one direction. When the drive motor 110 is rotated in one direction, as described above, the feed rollers 9a, 9c, 9e, 9g, 9i, and 9k rotate counterclockwise in plan view.

When the disc-shaped recording medium 200b is inserted from the disc insertion slot 2a, as with the case in which the disc-shaped recording medium 200a is inserted, the disc-shaped recording medium 200b is transported towards the reproducing unit 3 while it is transferred to the feed roller 9a and the feed member 10a, the feed roller 9b and the feed member 10b, and the feed roller 9c and the feed member 10c in that order. However, since the diameter of the disc-shaped recording medium 200b is smaller than that of the disc-shaped recording medium 200a, the sliding amounts of the feed rollers 9a, 9b, and 9c and the feed members 10a, 10b, and 10c towards the left and right are smaller than those for the disc-shaped recording medium 200a (see FIG. 86).

As the disc-shaped recording medium 200b is transported, the outer peripheral surface of the disc-shaped recording medium 200b comes into contact with the first restricting roller 37 and the second restricting roller 41 supported at the first slider 35 and the second slider 36 of the third sliding means 34, respectively, so that the first slider 35 and the second slider 36 slide away from each other.

When the disc-shaped recording medium 200b is transported to the reproducing unit 3 by the rotation of the second feed roller 9c, the drive motor 110 is stopped on the basis of, for example, a position detecting switch or a position detecting sensor (not shown) for detecting the position of the disc-shaped recording medium 200b in order to stop the disc-shaped recording medium 200b at the reproducing unit.

When the drive slider 30 and the driven slider 31 slide towards each other, the restricting protrusion 30c of the drive slider 30 and the restricting portion 31g of the driven slider 31 contact each other, and the restricting portion 30g of the drive slider 30 and the restricting protrusion 31b of the driven slider 31 contact each other in order to restrict the rightward movement of the drive slider 30 and the leftward movement of the driven slider 31. In this case, the disc-shaped recording medium 200b having a small diameter does not contact the fourth feed roller 9g and the fourth feed member log. Therefore, the disc-shaped recording medium 200b is not further pulled towards the stocker 4. Consequently, in the disc loading device 1, when transporting the disc-shaped recording medium 200b, the disc-shaped recording medium 200b is made to reach the reproducing unit 3 when the rightward movement of the drive slider 30 and the leftward movement of the driven slider 31 are restricted in order to stop the disc-shaped recording medium 200b at the reproducing unit 3.

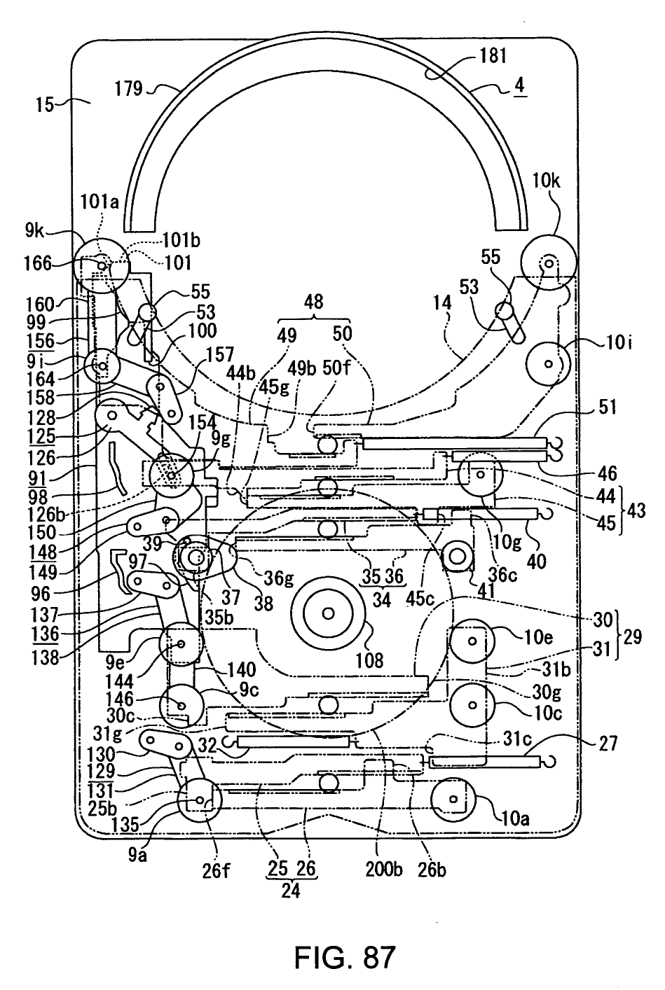

When the disc-shaped recording medium 200b is transported to the reproducing unit 3, the third feed roller 9e, the third feed member 10e, the first restricting roller 37, and the second restricting roller 41 are in contact with the outer peripheral surface of the disc-shaped recording medium 200b (see FIG. 87).

When the rotation of the drive motor 110 has been stopped, the mode motor 61 is rotated. The mode motor 61 is rotated in the direction causing the cam 67 to be rotated in the direction R2 shown in FIG. 39.

When the cam 67 is rotated by the rotation of the mode motor 61, the chucking mode is set as it is when the disc-shaped recording medium 200a is used in order to clamp and chuck the disc-shaped recording medium 200b by the table body 108a of the disc table 108 and the stabilizer 56b of the chucking pulley 56. At this time, while the operation portion 60 is being engaged with the engaging lever 105 of the base unit 102, the lifting portions 59 and 59 of the detaching member 57 supported by the supporting chassis 14 are disposed under the flange 56a of the chucking pulley 56.

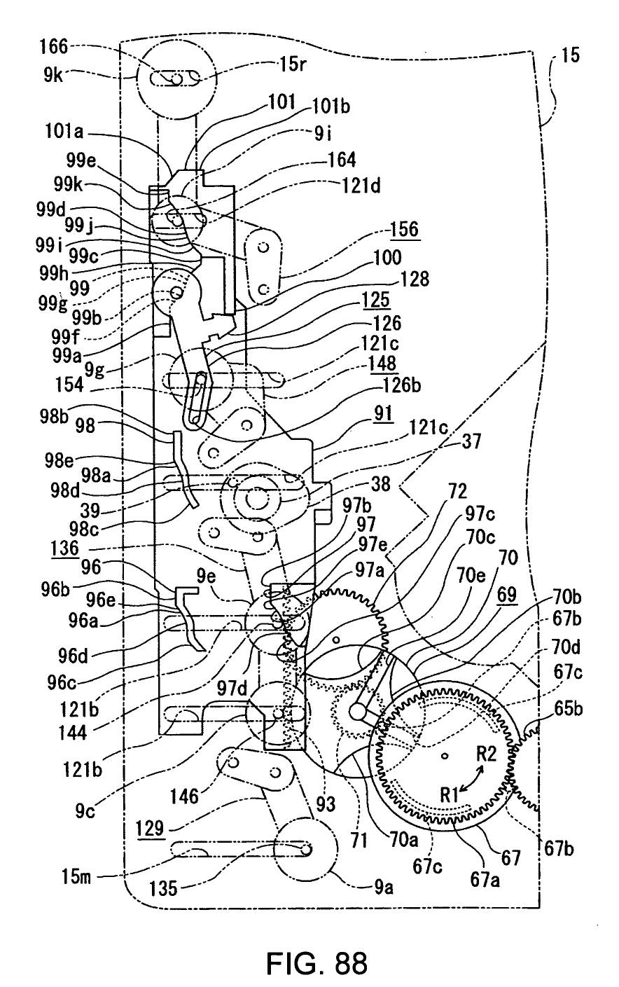

The mode slider 61 continues rotating to further move the mode slider 91 forward by the rotation of the cam 67 (see FIG. 88). As the mode slider 91 moves forward, the supporting shaft 144 supporting the third feed roller 9e comes into sliding contact with the second cam wall 97, and the supporting shaft 164 supporting the fifth feed roller 9i comes into sliding contact with the fourth cam wall 99. Here, at the same time, the operation portion 128 of the operating lever 125 supported by the subchassis 120 is pushed forward by the pushing rib 100.

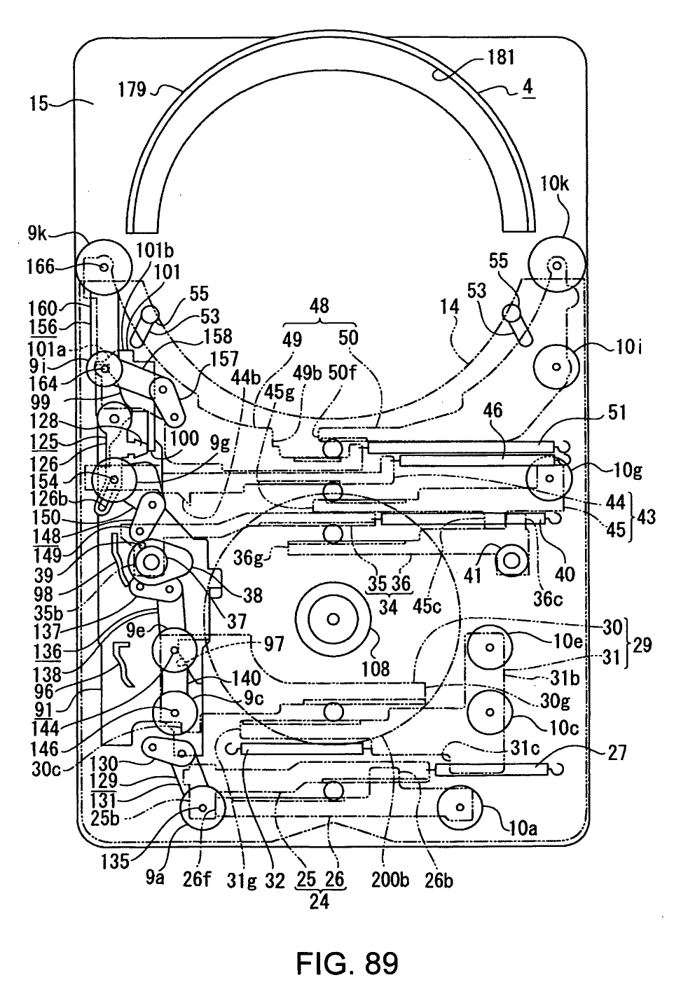

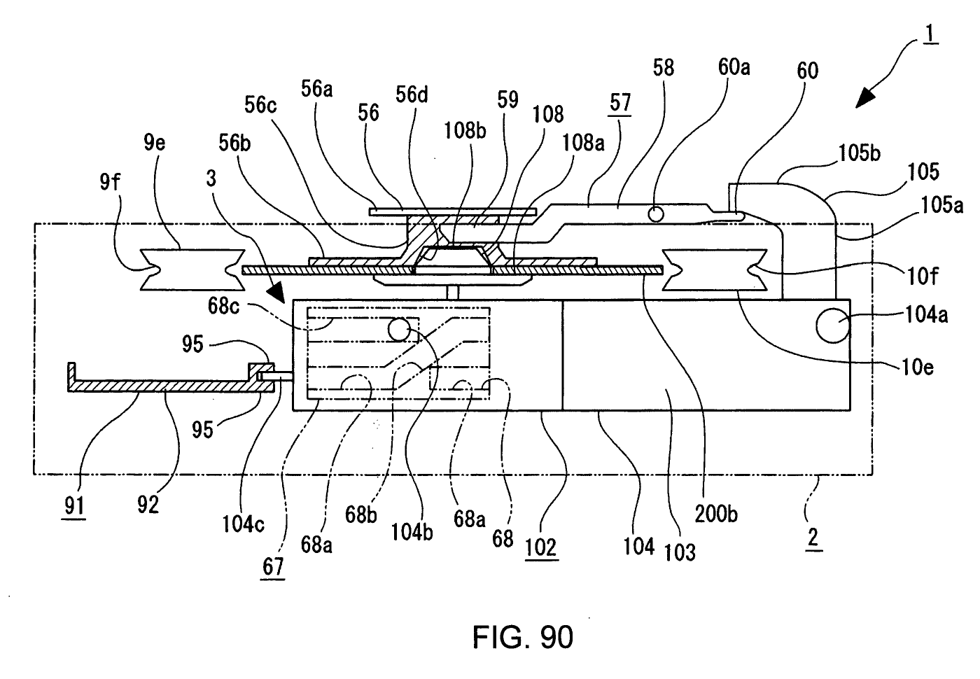

When the supporting shaft 144 comes into sliding contact with the second cam wall 97 as described above, the third feed roller 9e separates outwardly from the outer peripheral surface of the disc-shaped recording medium 200b (see FIGS. 89 and 90). When the operation portion 128 of the operating lever 125 is pushed by the pushing rib 100, the operating lever 125 is rotated in the direction in which the operation portion 128 moves substantially forward, and the supporting shaft 154 that is inserted and supported in the supporting hole 126b is guided and moves leftwards in the guide slit 121c. By the leftward movement of the supporting shaft 154, the drive slider 44 of the fourth sliding means 43 moves leftwards, and the driven slider 45 moves rightwards in synchronism.

When the driven slider 45 of the fourth sliding means 43 moves rightwards, the push protrusion 36c of the second slider 36 of the third sliding means 34 is pushed rightwards by the pushing protrusion 45c, so that the first slider 35 and the second slider 36 move away from each other in synchronism. Therefore, the first restricting roller 37 and the second restricting roller 41 move away from each other and separate outwardly from the outer peripheral surface of the disc-shaped recording medium 200b (see FIG. 89).

As described above, in moving the mode slider 91, as in the case in which the disc-shaped recording medium 200a is chucked, when the other operating pin 67b of the cam 67 is inserted in the operation groove 70e of the Geneva driven gear 69, at the initial and final stages, the supporting shafts 144 and 164 are in sliding contact with the sharply inclining front portion 97c of the second cam wall 97 and the sharply inclining front portion 99i of the fourth cam wall 99, respectively. At the intermediate stage, the supporting shafts 144 and 164 are in sliding contact with the gently inclining intermediate portion 97d of the second cam wall 97 and the gently inclining intermediate portion 99j of the fourth cam wall 99. Therefore, the load on the operating pin 67b of the cam 67 is reduced, thereby making it possible to reduce the load on the mode motor 61.

When the mode slider 91 is moved to the forward movement end, the disc holding canceling mode is set, and the supporting protrusions 95 and 95 of the mode slider 91 clamp the support portion 104c of the base unit 102 in the vertical direction as in the case in which a reproducing operation is performed on the disc-shaped recording medium 200a. Therefore, the base unit 102 is stably held at the upper rotational end in order to prevent movement of the surface of the disc-shaped recording medium 200b when an information signal is being reproduced from the disc-shaped recording medium 200b as described later. Consequently, it is possible to increase the reliability of the reproducing operation.

In the disc holding canceling mode, the third feed roller 9e, the first restricting roller 37, the third feed member 10e, and the second restricting roller 41 separate from the outer peripheral surface of the disc-shaped recording medium 200b (see FIG. 89), so that the disc-shaped recording medium 200b is in a state in which it can rotate smoothly by the rotation of the disc table 108.

When the disc holding canceling mode is set, the disc table 108 is rotated by the rotation of the spindle motor and the optical pickup 107 is operated in order to perform a reproducing operation on the chucked disc-shaped recording medium 200b. In the reproducing operation, the disc-shaped recording medium 200b is irradiated with a laser beam emitted from the light-emitting device (not shown) of the optical pickup 107 through the objective lens 107a. The returning light impinges upon the light-receiving device (not shown) of the optical pickup 107 through the objective lens 107a in order to reproduce an information signal recorded on the disc-shaped recording medium 200b.

In the state in which the information signal has been reproduced from the aforementioned disc-shaped recording medium 200b, when the eject knob (not shown) is operated, the disc-shaped recording medium 200b is transported from the reproducing unit 3 to the disc insertion slot 2a in the following way. Since the transporting operation of the disc-shaped recording medium 200b from the reproducing unit 3 to the disc insertion slot 2a is the reverse of the transporting operation from the disc insertion slot 2a to the reproducing unit 3, the transporting operation will be simply described.

When the eject knob is operated, the mode motor 61 rotates in a direction opposite to the aforementioned direction in order to rotate the cam 67 in the direction R1 shown in FIG. 77. When the cam 67 rotates in the direction R1 by the rotation of the mode motor 61, the mode slider 91 moves backwards, so that the supporting shaft 144 supporting the third feed roller 9e comes into sliding contact with the inclined portion 97a from the linear portion 97b of the second cam wall 97, and the supporting shaft 164 supporting the fifth feed roller 9i comes into sliding contact with the intermediate linear portion 99c from the back linear portion 99e of the fourth cam wall 99. Here, at the same time, the pushing operation performed on the operation portion 128 of the operating lever 125 supported by the subchassis 120 by the pushing rib 100 is cancelled, so that the drive slider 44 and the driven slider 45 of the fourth sliding means 43 move towards each other. By moving the drive slider 44 and the driven slider 45 towards each other, the pushing operation performed on the push protrusion 36c of the second slider 36 by the pushing protrusion 45c of the driven slider 45 is canceled. Therefore, the force of the spring 46 causes the first slider 35 and the second slider 36 of the third sliding means 34 to move towards each other and the first restricting roller 37 and the second restricting roller 41 to move towards each other. Therefore, the third feed roller 9e, the first restricting roller 37, the third feed member 10e, and the second restricting roller 41 contact the outer peripheral surface of the disc-shaped recording medium 200b, so that the disc-shaped recording medium 200b is held by the third feed roller 9e and the third feed member 10e.

At this time, the cam protruding pin 104b of the base unit 102 moves in the upper horizontal portion 68c defining the groove 68 of the cam 67 towards the inclined portion 68b.

When the mode motor 61 further rotates, the cam protruding pin 104b of the base unit 102 moves to the lower horizontal portion 68a from the upper horizontal portion 68c defining the groove 68 of the cam 67 through the inclined portion 68b. When the cam protruding pin 104b moves to the lower horizontal portion 68a from the upper horizontal portion 68c, the base unit 102 is rotated in the direction in which the disc table 108 moves downwards, so that the disc table 108 is disposed below the disc-shaped recording medium 200b.

As in the case in which the chucking of the disc-shaped recording medium 200a is canceled, the rotation of the base unit 102 causes the engaging portion 105b of the engaging lever 105 to push the operation portion 60 of the detaching member 57 downwards. Therefore, the detaching member 57 rotates on the support pins 60a and 60a as fulcra in the direction in which the lifting portions 59 and 59 move upwards, so that the flange 56a of the chucking pulley 56 is lifted by the lifting portions 59 and 59.

By lifting the flange 56a by the lifting portions 59 and 59, the chucking pulley 56 separates upwards from the disc table 108 in the upward direction. Accordingly, since the chucking pulley 56 forcefully separates from the disc table 108 by the detaching member 57 when the base unit 102 rotates, it is possible to reliably unchuck the disc-shaped recording medium 200b.

When the mode motor 61 continues rotating, the mode slider 91 moves to the rearward movement end and the transportation mode is set. When the transportation mode is set, as described above, the insertion cut portion 75a of the operating gear 74 is disposed to the left of the supporting shaft 135 supported at the drive slider 25 of the first sliding means 24 in order to set the unlocked state and to set the unrestricted state by the downward movement of the restricting pin 89 (see FIGS. 39 and 40).

When the transportation mode is set, the rotation of the mode motor 61 is stopped, and the drive motor 110 rotates in the other direction in order to rotate the feed rollers 9a, 9c, 9e, 9g, 9i, and 9k clockwise again in plan view.

The disc-shaped recording medium 200b is transferred from the third feed roller 9e and the third feed member 10e to the first feed roller 9a and the first feed member 10a via the second feed roller 9c and the second feed member 10c, and protrudes forward from the disc insertion slot 2a. By holding and pulling out the protruding disc-shaped recording medium 200b, the disc-shaped recording medium 200b is taken out of the housing 2.

In the state in which the disc-shaped recording medium 200b is transported towards the stocker 4 from the disc insertion slot 2a, when the outer peripheral surface of the disc-shaped recording medium 200b that is being transported contacts the feed rollers 9a, 9c, and 9e, the contact of the disc-shaped recording medium 200b is a load on the rotations of the feed rollers 9a, 9b, and 9c, so that the following torques are generated. The direction of the torques that are generated at the rotary lever 131 of the first rotary mechanism 129 and the first rotary lever 138 and the second rotary lever 140 of the second rotary mechanism 136 is counterclockwise in plan view. Therefore, by the torques, moving forces are applied to the first feed roller 9a, the second feed roller 9c, and the third feed roller 9e in a direction in which they move towards the outer peripheral surface of the disc-shaped recording medium 200b when the disc-shaped recording medium 200b is transported towards the stocker 4 from the disc insertion slot 2a.

In the state in which the disc-shaped recording medium 200b is transported towards the disc insertion slot 2a from the stocker 4, when the outer peripheral surface of the disc-shaped recording medium 200b that is being transported contacts the feed rollers 9a, 9c, and 9e, the contact of the disc-shaped recording medium 200b is a load on the rotations of the feed rollers 9a, 9c, and 9e, so that the following torques are generated. The direction of the torques is opposite to those mentioned above. Therefore, by the torques, moving forces are applied to the first feed roller 9a, the second feed roller 9c, and the third feed roller 9e in a direction in which they move away from the outer peripheral surface of the disc-shaped recording medium 200b.

In the disc loading device 1, as in the case in which the disc-shaped recording medium 200a is transported, the first transmission gears 133 and 142, operating as reduction gears, of the respective rotary mechanisms 129 and 136 are used to reduce the rotational speeds of the feed rollers 9a, 9c, and 9e in order to reduce the torques generated when the disc-shaped recording medium 200b contacts the feed rollers 9a, 9c, and 9e.

The biasing spring 147 for pushing the feed rollers 9c and 9e at the second rotary mechanism 136 against the outer peripheral surface of the disc-shaped recording medium 200b that is being transported is used to generate a predetermined friction force between the feed rollers 9c and 9e and the disc-shaped recording medium 200b.

(h) Transporting Operation When Disc Adapter Is Used

In the disc loading device 1, the small-diameter disc-shaped recording medium 200b mounted to a disc adapter 185 is transported to the reproducing unit 3 in order to allow an information signal to be reproduced from the disc-shaped recording medium 200b.

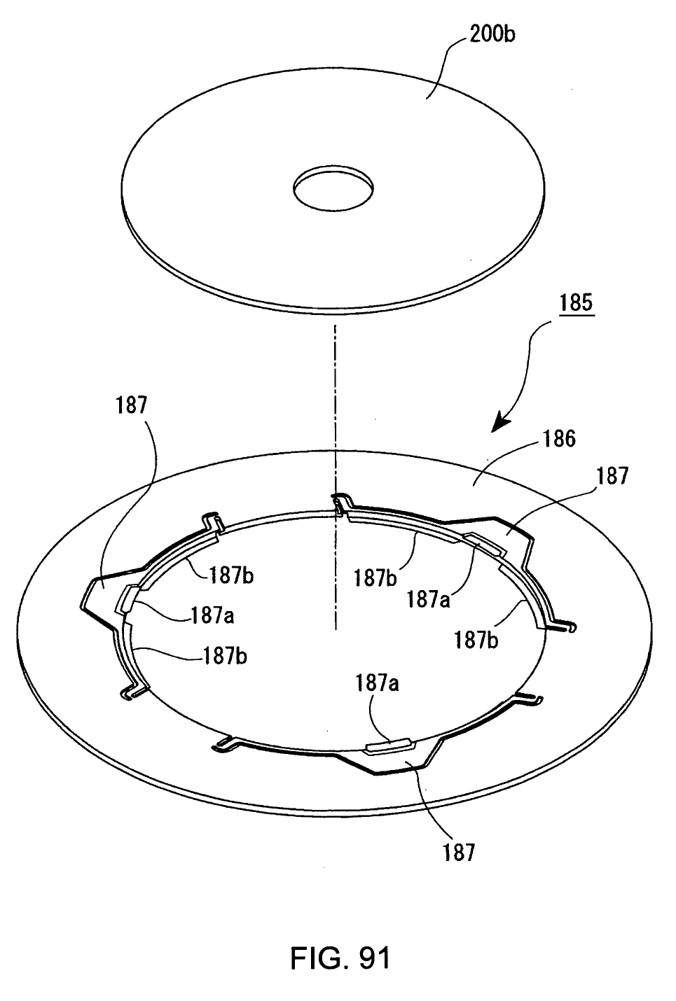

The disc adapter 185 comprises, for example, a flat substantially annular body 186 and holders 187, 187, and 187 that are spaced apart at an equal interval along the inner periphery of the body 186 and that can be elastically displaced in radial directions of the disc adapter 185 with respect to the body 186 (see FIG. 91). The holders 187, 187, and 187 are biased towards the center of the disc adapter 185 with respect to the body 186.

Inwardly protruding holding portions 187a, 187b, and 187b are disposed at each holder 187. The holding portion 187a and the holding portions 187b and 187b of each holder 187 are separated in the vertical direction. The holding portions 187b and 187b of each holder 187 are spaced apart in the peripheral direction of the disc adapter 185.

The disc adapter 185 has, for example, an outside diameter of 12 cm and an inside diameter of 8 cm.

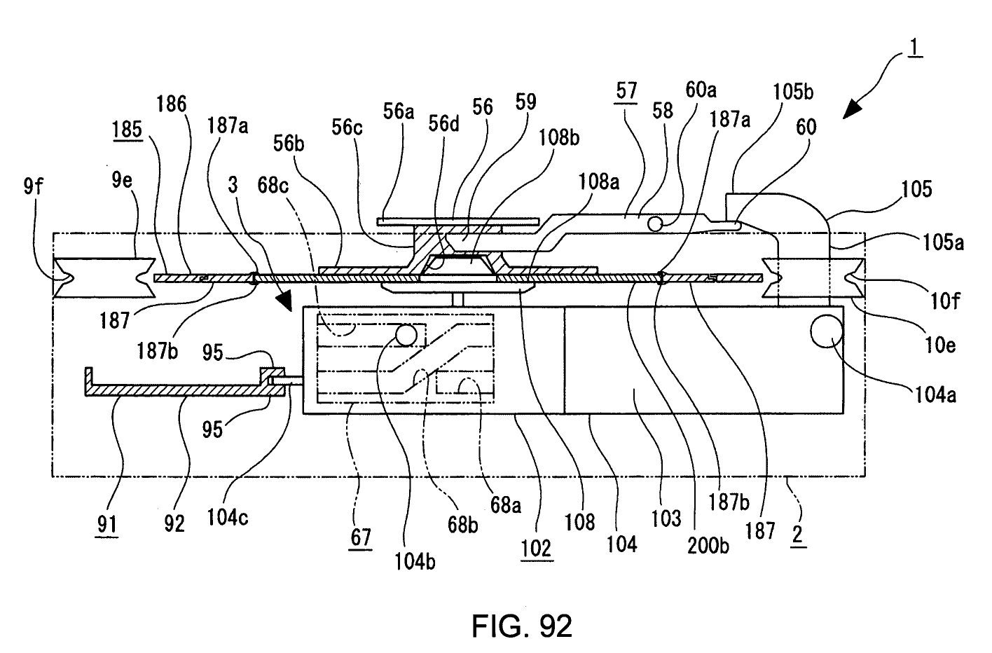

The disc-shaped recording medium 200b is mounted to the disc adapter 185 by being clamped between the holding portions 187a, 187a, and 187a and the holding portions 187b, and is inserted from the disc insertion slot 2a. When the disc adapter 185 to which the disc-shaped recording medium 200b is mounted is inserted from the disc insertion slot 2a, by performing the same operation as that performed when the disc-shaped recording medium 200a is transported to the reproducing unit 3 from the disc insertion slot 2a (see FIGS. 47 to 53 and FIGS. 72 to 78), the disc-shaped recording medium 200b is transported to the reproducing unit 3, and is chucked by the chucking pulley 56 and the disc table 108 while being mounted to the disc adapter 185 (see FIG. 92). When the disc adapter 185 to which the disc-shaped recording medium 200b is mounted is inserted from the disc insertion slot 2a, the outer peripheral surface of the disc adapter 185 pushes the feed rollers 9a, 9c, and 9e and the corresponding feed members 10a, 10c, and 10e in that order. By the rotation of the feed rollers 9a, 9c, and 9e, the disc adapter 185 to which the disc-shaped recording medium 200b is mounted is pulled into the housing 2.

When the disc-shaped recording medium 200b mounted to the disc adapter 185 is chucked, the disc table 108 rotates by the rotation of the spindle motor, and the optical pickup 107 operates, so that a reproducing operation is performed on the chucked disc-shaped recording medium 200b. The disc-shaped recording medium 200b rotates with the disc adapter 185.

In the state in which the reproduction of an information signal from the disc-shaped recording medium 200b is completed, when the eject knob (not shown) is operated, the disc adapter 185 to which the disc-shaped recording medium 200b is mounted is transported to the disc insertion slot 2a by the same operation as that performed when the disc-shaped recording medium 200a is transported to the disc insertion slot 2a from the reproducing unit 3.

In the state in which the disc adapter 185 to which the disc-shaped recording medium 200b is mounted protrudes forwardly from the disc insertion slot 2a, by holding and pulling out the disc adapter 185, the disc-shaped recording medium 200b can be taken out of the housing 2.

The transporting operation of the disc adapter 185 to which the disc-shaped recording medium 200b is mounted is described above. When the disc adapter 185 to which a disc-shaped recording medium 200b is not mounted is accidentally inserted from the disc insertion slot 2a, the following operations are carried out.

When the disc adapter 185 is transported to the reproducing unit 3, the rotation of the drive motor 110 is stopped, and then the mode motor 61 is rotated to rotate the base unit 102. Since the disc-shaped recording medium 200b is not mounted to the disc adapter 185, chucking is not carried out, so that the body 108a of the disc table 108 and the stabilizer 56b of the chucking pulley 56 are superimposed upon each other.

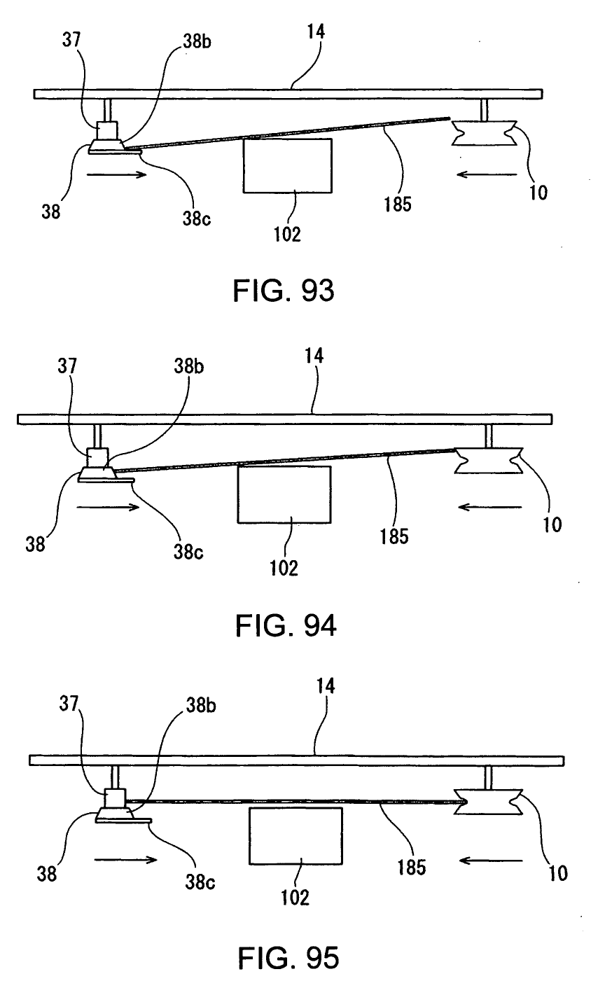

The mode motor 61 continues rotating, causing the third feed roller 9e, the fourth feed roller 9g, the first restricting roller 37, the third feed member 10e, the fourth feed member 10g, and the second restricting roller 41 to separate from the outer peripheral surface of the disc adapter 185. Therefore, since the holding operation on the disc adapter 185 is cancelled, the disc adapter 185 falls (see FIG. 93). At this time, the first restricting roller 37 is disposed at the leftward movement end, so that the inner peripheral portion of the disc adapter 185 that has fallen contacts the upper portion of the base unit 102, and the outer peripheral portion of the disc adapter 185 contacts the upper surface of the receiving portion 38c of the receiving member 38 disposed at the lower side of the first restricting roller 37. As a result, the disc adapter 185 is tilted (see FIG. 93).

Next, the driving of the optical pickup 107 is started. Since a disc-shaped recording medium 200b does not exist, an operation error is detected, so that the ejection operation is immediately started.

When the ejection operation is started, the rotation of the mode motor 61 causes the mode slider 91 to move backwards, so that the second feed roller 9c, the third feed roller 9e, the fourth feed roller 9g, the fifth feed roller 9i, the sixth feed roller 9k and the first restricting roller 37 and the respective second feed member 10c, third feed member 10e, fourth feed member 10g, fifth feed member 10i, sixth feed member 10k, and second restricting roller 41 move towards each other.

At this time, the outer peripheral edge of the disc adapter 185 comes into sliding contact with the inclined portion 38b from the receiving portion 38c of the receiving member 38 (see FIG. 94), and into sliding contact with the first restricting roller 37 from the inclined portion 38b (see FIG. 95). When the outer peripheral surface of the disc adapter 185 comes into sliding contact with the first restricting roller 37, the outer peripheral portion of the disc adapter 185 is inserted into the holding grooves 9f, 9h, 10f, and 10h of the respective third feed roller 9e, fourth feed roller 9g, third feed member 10e, and fourth feed member 10g, so that the disc adapter 185 is in a horizontal state and is held again by the third feed roller 9e, the fourth feed roller 9g, the third feed member 10e, and the fourth feed member 10g.

The mode motor 61 continues rotating, causing the chucking pulley 56 and the disc table 108 to separate from each other in the vertical direction and the mode slider 91 to move to the rearward movement end in order to set the transportation mode. When the transportation mode is set, as described above, the insertion cut portion 75a of the operation gear 74 is disposed to the left of the supporting shaft 135 supported at the drive slider 25 of the first sliding means 24 in order to set the unlocked state and to set the unrestricted state by the downward movement of the restricting pin 89 (see FIGS. 39 and 40).

When the transportation mode is set, the rotation of the mode motor 61 is stopped, and the drive motor 110 rotates in the other direction, so that the disc adapter 185 is transferred from the fourth feed roller 9g and the fourth feed member 10g to the first feed roller 9a and the first feed member 10a via the third feed roller 9e and the third feed member 10e, and the second feed roller 9c and the second feed member 10c, and protrudes forwardly from the disc insertion slot 2a. By holding and pulling out the protruding disc adapter 185, the disc adapter 185 can be taken out of the housing 2.

As described above, when the disc adapter 185 to which a disc-shaped recording medium 200b is not mounted is accidentally inserted from the disc insertion slot 2a, the disc adapter 185 that has fallen is received by the receiving member 38. By the ejection operation, the disc adapter 185 is held by the feed rollers 9 and 9 and the feed members 10 and 10. Therefore, the disc adapter 185 that has fallen as a result of being accidentally inserted can be reliably ejected.

Hereunder, the materials of the feed rollers 9 and feed members 10 will be described.

The feed rollers 9 and the feed members 10 are such that at least portions thereof that come into contact with the disc-shaped recording medium 200, for example, the holding grooves 9b, 9d, 9f, 9h, 9j, 9l, 10b, 10d, 10f, 10h, 10j, and 10l are formed of, for example butyl rubber.

Examples of usable materials other than butyl rubber for the feed rollers 9 and the feed members 10 are urethane rubber, silicon rubber, CR (Chloroprene Rubber), EPDM (Ethylene Propylene Diene Polymethylene) rubber, and elastomer.

In general, urethane rubber has the advantage that it does not easily lose its shape, but the disadvantage that it is expensive. Since, in general, urethane rubber has high affinity to polycarbonate, which is used as a material of the disc-shaped recording medium, it tends to adhere to the disc-shaped recording medium.

In general, silicon rubber has the advantage that it does not easily lose its shape, but the disadvantages that it is expensive and is easily cracked.

In general, CR rubber has the advantage that it is low in cost, but the disadvantages that it tends to wear and to deteriorate with age.

In general, EPDM rubber has the advantages that it is low in cost and tends to absorb oil adhered to a disc-shaped recording medium due to its high oil absorption capability, but the disadvantage that it tends to wear.

In general, elastomer has the advantage that it allows integral molding of the feed rollers or the feed members with shafts, and the disadvantage that it tends to wear.

On the other hand, in general, butyl rubber has the advantage that it is low in cost in addition to having the advantages that it does not easily adhere to a disc-shaped recording medium due to its low affinity to polycarbonate, which is a material of the disc-shaped recording medium, and that it provides high transporting force with respect to the disc-shaped recording medium due to its high viscosity and low resilience. Therefore, butyl rubber is the most desirable material for the feed rollers 9 and the feed members 10.

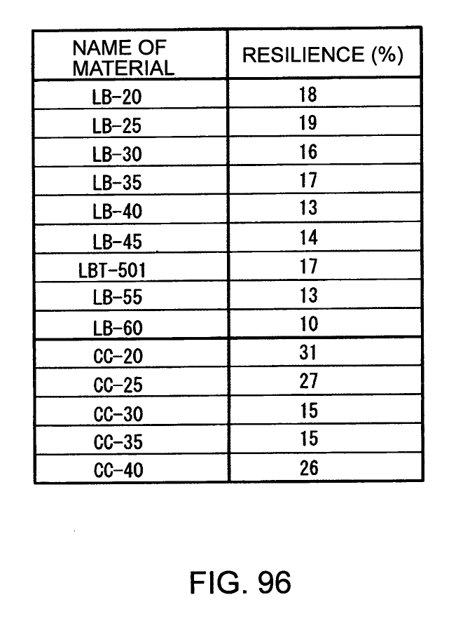

FIG. 96 is a table of the resiliences of various types of butyl rubber. In the figure, the term “material name” refers to the various types of butyl rubber, and each material name is a product name of Yamauchi Corporation. The resiliences of the butyl rubbers are equal to or less than approximately 30%. Excluding some of the butyl rubbers, the resiliences are low in the range of from 10% to 19%.

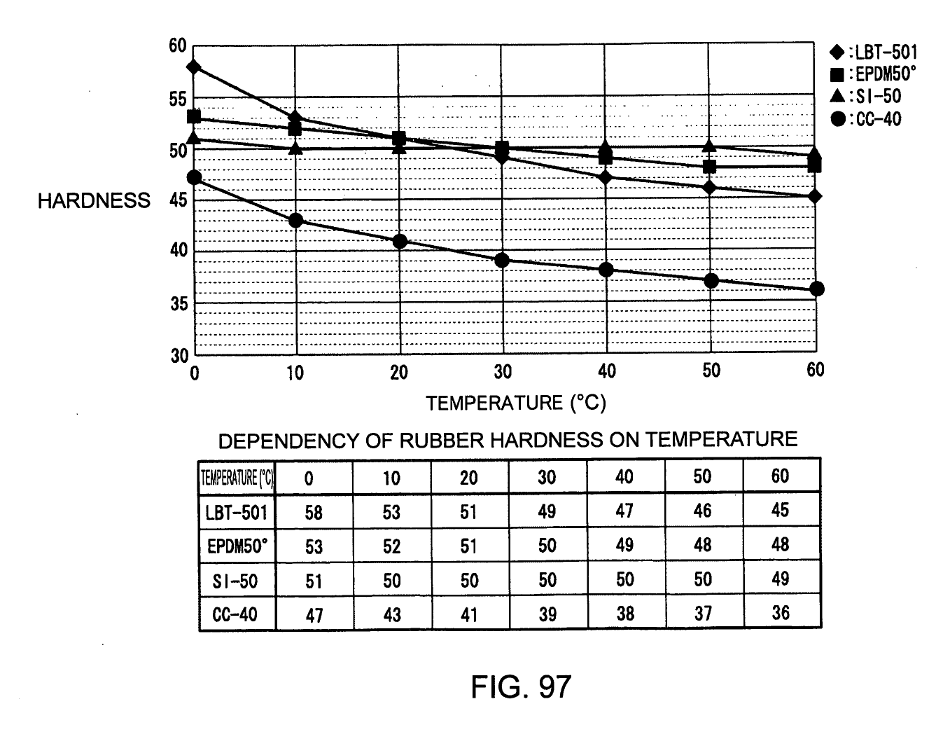

FIG. 97 shows a graph and a table of the dependency of the hardness of various materials on temperature. In the figure, “LBT-501” and “CC-40” refer to butyl rubbers, “EPDM 50°” refers to EPDM rubber, and “SI-50” refers to silicon rubber.

As shown in FIG. 97, the butyl rubbers have hardnesses that change with temperature, and tend to harden at low temperature. Therefore, when they are used at low temperature, the transportation force on a disc-shaped recording medium may be reduced.

Therefore, when the feed rollers 9 and the feed members 10 are formed of butyl rubber, a proper transportation force can be provided with respect to a disc-shaped recording medium 200, for example, by using various types of butyl rubber having a hardness equal to or less than a predetermined value even at low temperature, by forming the holding grooves of the feed rollers 9 and the feed members 10 with shapes having a large contact area with respect to the disc-shaped recording medium, and by using feed rollers 9 and the feed members 10 having a high spring force for pushing the disc-shaped recording medium 200.

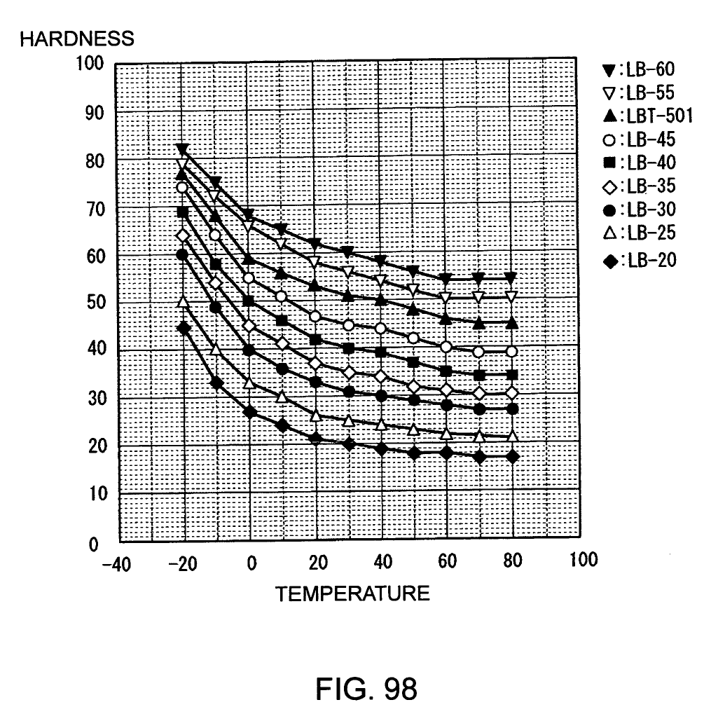

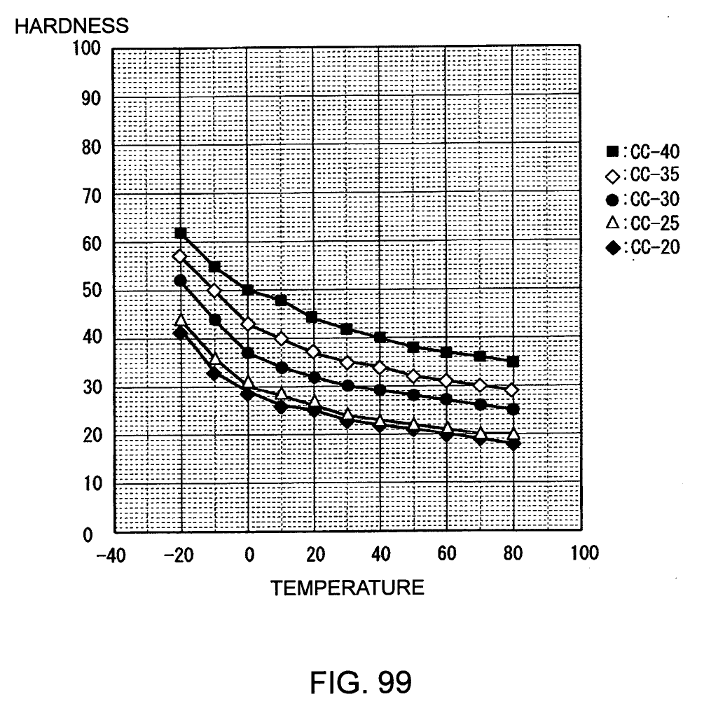

FIGS. 98 and 99 are graphs of the dependency of the hardness of various types of butyl rubber (all of them being products of Yamauchi Corporation) on temperature. As shown in FIGS. 98 and 99, the various types of butyl rubber have different hardnesses. Considering, for example, the temperature condition of use of the disc loading device 1, an optimal butyl rubber can be selected.

Although examples in which butyl rubber, urethane rubber, silicon rubber, CR rubber, EPDM rubber, and elastomer are used as material of the feed rollers 9 and the feed members 10 are given, the feed walls 11, 12, and 13 may be formed of any of these materials.

The specific forms and structures of the parts in the embodiment are only some of the embodied forms for carrying out the present invention, so that they are not to be interpreted as limiting the technical scope of the present invention.

As is clear from the foregoing description, the disc loading device of the present invention transports and loads a disc-shaped recording medium inserted from the disc insertion slot, and comprises first transporting means and second transporting means for transporting the disc-shaped recording medium by being disposed on opposite sides of the disc-shaped recording medium that is being transported and being pushed against the outer peripheral surface of the disc-shaped recording medium from opposite sides. The first transporting means comprises a plurality of feed rollers disposed apart from each other along a transportation path of the disc-shaped recording medium for transporting the disc-shaped recording medium while transferring it by rolling independently and successively on the outer peripheral surface of the disc-shaped recording medium.

Therefore, it is possible to transport the disc-shaped recording medium without using means, such as a disc tray, for placing and transporting the disc-shaped recording medium, so that the usability is increased.

By disposing the required number of feed rollers, it is possible to freely set the transportation stroke and to increase design freedom. In the disc loading device which comprises a stocker in addition to a reproducing unit and which functions as a disc changer, since it is necessary to transport the disc-shaped recording medium between the reproducing unit and the stocker and a long transportation stroke is required, the use of feed rollers is very effective in increasing design freedom.

Since the disc-shaped recording medium is transported by pushing the first transporting means and the second transporting means against the outer peripheral surface of the disc-shaped recording medium, it is possible to prevent damage to a recording surface of the disc-shaped recording medium.

In the present invention, the second transporting means may comprise a plurality of substantially cylindrical or columnar feed members which are disposed apart from each other in a transportation direction of the disc-shaped recording medium and which are successively pushed against the outer peripheral surface of the disc-shaped recording medium that is to be transported. The number of feed members and that of the feed rollers are the same. Since the feed rollers and feed members, disposed on opposite sides of the disc-shaped recording medium that is being transported, are movable in synchronism away from the outer peripheral surface of the disc-shaped recording medium that is being transported, the load exerted upon the disc-shaped recording medium by the feed rollers and the feed members is stabilized, and the transporting operation can be more easily controlled.

In the present invention, since the feed members may be rotatable in the direction in which their outer peripheral surfaces roll on the outer peripheral surface of the disc-shaped recording medium, it is possible to stably and reliably transport the disc-shaped recording medium.

In the present invention, since at least a portion of each feed roller that contacts the disc-shaped recording medium may be formed of butyl rubber, it is possible to provide proper transporting force with respect to the disc-shaped recording medium.

In the present invention, since at least a portion of each feed member that contacts the disc-shaped recording medium may be formed of butyl rubber, it is possible to provide proper transporting force with respect to the disc-shaped recording medium.

As is clear from the foregoing description, the disc loading device of the present invention transports the disc-shaped recording medium inserted from the disc insertion slot in a transportation mode among a plurality of operation modes and loads it. The disc loading device comprises first transporting means, second transporting means, and a supporting chassis. The first and second transporting means disposed on opposite sides of the disc-shaped recording medium that is being transported transport the disc-shaped recording medium by being pushed against the outer peripheral surface of the disc-shaped recording medium from the opposite sides. The supporting chassis is disposed so as to be separated in the thickness direction of the disc-shaped recording medium that is being transported. The first transporting means comprises a plurality of feed rollers which are disposed apart from each other along a transportation path of the disc-shaped recording medium and which transport the disc-shaped recording medium while transferring it by rolling independently and successively on the outer peripheral surface of the disc-shaped recording medium. In addition, a plurality of sliders and restricting means are provided. The sliders support the feed rollers, are movably supported at the supporting chassis, and move the feed rollers away from the outer peripheral surface of the disc-shaped recording medium that is being transported. In the operation modes other than the transportation mode, the restricting means restricts the movement of the slider supporting the feed roller that is disposed closest to the disc insertion slot.

Therefore, in the operation modes other than the transportation mode, it is possible to reliably prevent misinsertion of the disc-shaped recording medium from the disc insertion slot.

In the present invention, since a restricting pin for closing a portion of the disc insertion slot when the restricting means restricts the movement of the slider supporting the feed roller disposed closest to the disc insertion slot may be provided, insertion of the outer peripheral portion of a disc-shaped recording medium from the disc insertion slot is prevented, so that, even if the disc-shaped recording medium exists near the disc insertion slot, it is possible to prevent contact between the disc-shaped recording media.

1. A disc transporting device comprising:
first transporting means comprising a plurality of rollers disposed apart from each other along a transportation path of a disc-shaped recording medium for transporting the disc-shaped recording medium while transferring the disc-shaped recording medium by independently and successively rolling on the outer peripheral surface of the disc-shaped recording medium; and
second transporting means disposed along the transportation path for nipping, together with the first transporting means, the disc-shaped recording medium, the first transporting means and the second transporting means being disposed on opposite sides of the disc-shaped recording medium that is being transported.

2. The disc transporting device according to claim 1, wherein the second transporting means comprises the same number of a plurality of feed members as the rollers, the feed members being cylindrical or columnar, being disposed apart from each other in a transportation direction of the disc-shaped recording medium, and transporting the disc-shaped recording medium while being in synchronism with the rollers disposed opposite to the feed members with the disc-shaped recording medium that is being transported being disposed therebetween and while contacting the outer peripheral surface of the disc-shaped recording medium.

3. The disc transporting device according to claim 2, wherein the feed members are rotatable in a direction in which the feed members roll on the outer peripheral surface of the disc-shaped recording medium.

4. The disc transporting device according to claim 1, wherein at least a portion of each roller that comes into contact with the disc-shaped recording medium is formed of butyl rubber.

5. The disc transporting device according to claim 2, wherein at least a portion of each feed member that comes into contact with the disc-shaped recording medium is formed of butyl rubber.

6. The disc transporting device according to claim 1, further comprising a chassis, a plurality of sliders, and restricting means, the chassis being disposed so as to be separated in the thickness direction of the disc-shaped recording medium that is being transported, the plurality of sliders supporting the plurality of rollers, being movably supported by the chassis, and moving the rollers away from the transportation path of the disc-shaped recording medium, and the restricting means restricting the movement of the slider supporting the roller that is disposed closest to a disc insertion slot among the plurality of rollers.

7. The disc transporting device according to claim 6, wherein a plurality of operation modes including at least a transportation mode for transporting the disc-shaped recording medium is provided, and wherein, in the operation mode or modes other than the transportation mode, the restricting means restricts the movement of the slider supporting the roller disposed closest to the disc insertion slot among the plurality of rollers.

8. The disc transporting device according to claim 6, further comprising a restricting pin for closing a portion of the disc insertion slot when the restricting means restricts the movement of the slider supporting the roller disposed closest to the disc insertion slot among the plurality of rollers.

9. The disc transporting device according to claim 7, further comprising a restricting pin for closing a portion of the disc insertion slot when the restricting means restricts the movement of the slider supporting the roller disposed closest to the disc insertion slot among the plurality of rollers.
